(19) United States
(12) Patent Application Publication
(10) Pub. No.: US 2021/0319548 A1
(43) Pub. Date: Oct. 14, 2021

(54) METHOD AND SYSTEM FOR GRADING AND STACKING VENEER STRIPS USING NEAR INFRARED IMAGING

(71) Applicant: Boise Cascade Company, Boise, ID (US)

(72) Inventors: David Bolton, Lena, LA (US); Jude Richard Peek, Pineville, LA (US); Curtis Fennell, Boyce, LA (US)

(73) Assignee: Boise Cascade Company, Boise, ID (US)

(21) Appl. No.: 17/356,805

(22) Filed: Jun. 24, 2021

Related U.S. Application Data
(63) Continuation-in-part of application No. 16/697,458, filed on Nov. 27, 2019, now Pat. No. 11,090,833.
(60) Provisional application No. 62/773,992, filed on Nov. 30, 2018.

(51) Int. Cl. G06T 7/00; G06T 3/60; G01N 21/88

(52) U.S. Cl. CPC G06T 7/0004; G06T 3/60; G01N 21/8806; G01N 21/8851; G01N 2021/8887; G06T 2207/30161; G01N 2021/8816; G01N 2021/8861; G06T 2207/10048

(57) ABSTRACT

Near InfraRed NIR technology, including NIR cameras and detectors, is used to accurately identify surface irregularities on a veneer surface. A grade is then assigned to the veneer based, at least in part, on the detected irregularities. In one embodiment, the veneer is then provided to an improved veneer stacking system that produces more consistently graded veneer stacks and safer veneer stacks, is less expensive to operate, and is far safer than currently available methods and systems for full veneer sheet, veneer strip, and partial veneer sheet stacking.

### RELATED APPLICATIONS

This application is a continuation in part of Bolton et al., U.S. patent application Ser. No. 16/697,458 (attorney docket number BCC-004), filed Nov. 27, 2019, now allowed, entitled “METHOD AND SYSTEM FOR ENSURING THE QUALITY OF A WOOD PRODUCT BASED ON SURFACE IRREGULARITIES USING NEAR INFRARED IMAGING,” which claims the benefit of David Bolton, U.S. Provisional Patent Application No. 62/773,992, filed on Nov. 30, 2018, entitled “NEAR-INFRARED SURFACE TEXTURE DETECTION IN WOOD PRODUCTS,” which is hereby incorporated by reference in its entirety as if it were fully set forth herein.

This application is related to Bolton et al., U.S. patent application Ser. No. 16/205,027 (attorney docket number BCC-005), filed Nov. 29, 2018, now issued as U.S. Pat. No. 10,825,164 on Nov. 3, 2020, entitled “IMAGING SYSTEM FOR ANALYSIS OF WOOD PRODUCTS,” which claims the benefit of David Bolton, U.S. Provisional Patent Application No. 62/595,489, filed on Dec. 6, 2017, entitled “IMAGING SYSTEM FOR ANALYSIS OF WOOD PRODUCTS,” which is hereby incorporated by reference in its entirety as if it were fully set forth herein.

This application is related to Bolton et al., U.S. patent application Ser. No. 16/687,311 (attorney docket number BCC-003), filed Nov. 18, 2019, entitled “METHOD AND SYSTEM FOR DETECTING MOISTURE LEVELS IN WOOD PRODUCTS USING NEAR INFRARED IMAGING,” which claims the benefit of David Bolton, U.S. Provisional Patent Application No. 62/774,029, filed on Nov. 30, 2018, entitled “NEAR-INFRARED MOISTURE DETECTION IN WOOD PRODUCTS,” which is hereby incorporated by reference in its entirety as if it were fully set forth herein.

This application is related to Bolton et al., U.S. patent application Ser. No. 16/687,342 (attorney docket number BCC-006), filed on Nov. 18, 2019, entitled “METHOD AND SYSTEM FOR DETECTING MOISTURE LEVELS IN WOOD PRODUCTS USING NEAR INFRARED IMAGING AND MACHINE LEARNING,” which claims the benefit of David Bolton, U.S. Provisional Patent Application No. 62/774,029, filed on Nov. 30, 2018, entitled “NEAR-INFRARED MOISTURE DETECTION IN WOOD PRODUCTS,” which is hereby incorporated by reference in its entirety as if it were fully set forth herein.

This application is related to Bolton et al., U.S. patent application Ser. No. 16/687,369 (attorney docket number BCC-007), filed on Nov. 18, 2019, entitled “METHOD AND SYSTEM FOR MOISTURE GRADING WOOD PRODUCTS USING SUPERIMPOSED NEAR INFRARED AND VISUAL IMAGES,” which claims the benefit of David Bolton, U.S. Provisional Patent Application No. 62/774,029, filed on Nov. 30, 2018, entitled “NEAR-INFRARED MOISTURE DETECTION IN WOOD PRODUCTS,” which is hereby incorporated by reference in its entirety as if it were fully set forth herein.

This application is related to Bolton et al., U.S. patent application Ser. No. 16/697,461 (attorney docket number BCC-008), filed on Nov. 27, 2019, now issued as U.S. Pat. No. 10,933,556 on Mar. 2, 2021, entitled “METHOD AND SYSTEM FOR ENSURING THE QUALITY OF A WOOD PRODUCT BASED ON SURFACE IRREGULARITIES USING NEAR INFRARED IMAGING AND MACHINE LEARNING,” which claims the benefit of David Bolton, U.S. Provisional Patent Application No. 62/773,992, filed on Nov. 30, 2018, entitled “NEAR-INFRARED SURFACE TEXTURE DETECTION IN WOOD PRODUCTS,” which is hereby incorporated by reference in its entirety as if it were fully set forth herein.

This application is related to Bolton et al., U.S. patent application Ser. No. 16/697,466 (attorney docket number BCC-009), filed on Nov. 27, 2019, now issued as U.S. Pat. No. 10,933,557 on Mar. 2, 2021, entitled “METHOD AND SYSTEM FOR ADJUSTING THE PRODUCTION PROCESS OF A WOOD PRODUCT BASED ON A LEVEL OF IRREGULARITY OF A SURFACE OF THE WOOD PRODUCT USING NEAR INFRARED IMAGING,” which claims the benefit of David Bolton, U.S. Provisional Patent Application No. 62/773,992, filed on Nov. 30, 2018, entitled “NEAR-INFRARED SURFACE TEXTURE DETECTION IN WOOD PRODUCTS,” which is hereby incorporated by reference in its entirety as if it were fully set forth herein.

This application is related Bolton et al., U.S. patent application Ser. No. 17/230,470 (attorney docket number BCC-013), filed Apr. 14, 2021, entitled “METHOD AND SYSTEM FOR FULL VENEER SHEET GRADING AND STACKING,” which is hereby incorporated by reference in its entirety as if it were fully set forth herein.

This application is related Bolton et al., U.S. patent application Ser. No. 17/230,497 (attorney docket number BCC-017), filed Apr. 14, 2021, entitled “METHOD AND SYSTEM FOR VENEER STRIP GRADING AND STACKING,” which is hereby incorporated by reference in its entirety as if it were fully set forth herein.

### BACKGROUND

There are numerous classes and types of wood products for use in a virtually limitless variety of applications. Wood product types include but are not limited to raw wood products such as logs, debarked blocks, green or dry veneer, and dimensional lumber; intermediate wood components, such as wood I-beam flanges and webs; and layered wood products such as laminated beams, plywood panels, Engineered Wood Products (EWP), Parallel Laminated Veneer (PLV) products, and Laminated Veneer Lumber (LVL) products.

Layered wood products such as EWP, plywood, PLV, and LVL are composite products constructed in a factory from both natural wood and one or more chemically blended glues or resins. They are manufactured on a product assembly line and are typically fabricated from multiple layers of thin wood, e.g., full veneer sheets, partial veneer sheets, and veneer strips (as discussed below), assembled with one or more layers of adhesives bonding the layers together.

Herein the term “full veneer sheet” includes a continuous sheet of veneer of a defined width “Wf” and a defined length “Lf.” Width “WF” can be any width desired or needed for processing. As a specific illustrative example, in various embodiments, the defined width “Wf” can be 49 to 54 inches, with 54 inches being the ideal average value of width “Wf” In the wood products industry full veneer sheets, both green and dried, are commonly called 54's because 54 inches is an average width “Wf” of a full veneer sheet. Length “Lf” can be any length desired or needed for processing. In various embodiments, the defined length “Lf” can be 97 to 102 inches, with 102 inches being the preferred average value for “Lf.”

Full veneer sheets are typically used for outer layers and/or inner layers of a layered wood product and define the dimensions, i.e., length and width, of the layered wood product panels being created. Therefore, it is critical that the length “Lf” and width “Wf” of the full veneer sheets be consistent for each full veneer sheet.

In addition to full veneer sheets, many layered wood products include layers made up of veneer sheet portions that are not of consistent length “Lf” and/or width “Wf” These veneer sheet portions are typically used for inner cross plies of the layered wood products and are commonly referred to as “core material.” Core material is typically derived from veneer sheets that do not meet the full sheet criteria of the LF dimension.

Herein the term “veneer strip” includes a veneer portion that is of the defined length “Lf” of a full veneer sheet, but which has a width “Ws” that is less than the defined width “Wf” of a full veneer sheet. It should be noted that any veneer portion that has less than the defined length “Lf” of a full veneer sheet is considered a partial sheet.

Any veneer sheet narrower in width than the typical full sheet width of “49-54,” depending on company specifications, while retaining the length of a full sheet Lf, is referred to herein as a “veneer strip,” This is very important as veneer strips can be joined together by a variety of processes commonly called composing or stringing, that involves joining veneer strips with adhesives along the length “Lf” axis to produce a ribbon of continuous wood, that can then be cut into the desired full sheet width “Wf”, typically 54″.

Herein the terms “partial veneer sheet” “veneer short sheet,” and “veneer short strip” are used interchangeable and include a veneer sheet portion that has a length “Lp” that not of the defined length “Lf” of a full veneer sheet. In addition, as used herein, partial veneer sheets can also have any width “Wp” that is less than or equal to the defined full veneer sheet width “Wf” It should be noted that any veneer portion that has any length “Lp” that is not of the defined length “Lf” and a width “Wp” less than or equal to the width “Wf” of a full veneer sheet is considered a partial veneer sheet, even if each partial veneer sheet has a different length “Lp” and width “Wp” from other partial veneer sheets.

If a portion of a veneer sheet is less than full length, typically 102″, then it is not usable as a full veneer sheet, or veneer strip. In this case, these partial veneer sheets are typically stacked with a clean trimmed edge in vertical alignment in a stack as are full veneer sheets and/or veneer strips. However, these partial veneer sheet stacks are commonly sent to a large saw where they are sawn to the length dimension (typically 51″) to be used as the cross ply, or core, in plywood. This process can result in 49% waste of partial veneer sheets. While not an ideal efficiency, this 49% waste is better than 100% waste. These partial veneer sheets can also be composed to produce a continuous ribbon of core material that can then be cut into full size cross ply sheets. So instead of an individual feeding by hand, multiple individual strips, a 51″×51″ core sheet can be manually, or machine laid as a single piece of composed core. The 51″×51″ is common in the industry but may vary in dimension based on specific manufacturers criteria for core sizes.

Herein, the term “veneer” can be used to refer collectively, or individually, to veneer ribbon, and/or full veneer sheets, and/or veneer strips, and/or partial veneer sheets.

Layered wood products are sometimes referred to as “man-made” but are more commonly referred to as “Engineered Wood Products,” (EWP). Layered wood products made up of full veneer sheets, and/or veneer strips, and/or partial veneer sheets offer several advantages over typical milled lumber. For instance, since layered wood products are fabricated and assembled in a factory under controlled conditions to a set of specific product specifications, they can be made stronger, straighter, and more uniform than traditional sawn lumber. In addition, due to their composite nature, layered wood products are much less likely to warp, twist, bow, or shrink than traditional sawn lumber. Many layered wood products also benefit from the multiple grain orientations of the layers and typically can also have a higher allowable stress than a comparable milled lumber product. However, as discussed below, to achieve this potential it is often critical that the full veneer sheets, partial veneer sheets, and veneer strips, making up the layered wood products are inspected and graded in a consistent and accurate manner to have the correct physical characteristics such as physical dimensions, strength, consistent surface texture, and moisture content.

The use of veneer, and particularly veneer that has uniform qualities such as consistent surface texture and moisture content, allows layered wood products of various dimensions to be created without milling a board of the desired thickness or dimension from a single log or single piece of lumber. This, in turn, allows for much more efficient use of natural resources. Indeed, without the use of various layered wood technologies, the forests of the planet would have been depleted long ago simply to meet the construction needs of the ever-increasing world population. In addition, since layered wood products are fabricated in a factory under controlled specifications, layered wood products can be manufactured to virtually any dimensions desired, including dimensions such as length, width, and height well beyond dimensions that can be provided by milling from even the largest trees.

The use of veneer layers in some layered wood products can also allow for better structural integrity since any imperfections in a given veneer layer, such as a knot hole, can be mitigated by rotating and/or exchanging layers of veneer so that the imperfection is only one layer deep and is supported by layers of veneer below and above the imperfection in the layered wood product's structure. However, these advantages are again dependent on the veneer layers being accurately and consistently inspected for surface texture, strength, and moisture content and then being accurately and consistently graded and properly placed in the panel to provide consistent strength by separating defects sufficiently.

As noted, the versatility and potential increased structural integrity and uniformity of layered wood products has resulted in the wide use of these products and there is little question that layered wood products are a critical component of construction worldwide. However, the currently used methods and systems for veneer inspection, grading, and veneer stacking for use with layered wood products are antiquated and extremely inefficient in terms of the amount and type of equipment required, the amount of factory production space required, the amount of human interaction and coordination required, and the amount of wasted and/or inefficiently used material and human resources.

One important metric that must be taken into account when grading veneer for producing and utilizing wood products is the surface texture of the veneer and any irregularities or uneven surfaces of the veneer. This is critical because the texture of the surfaces of the veneer can be indicative of several parameters including, but not limited to: how effectively and efficiently the wood product has been preprocessed prior to cutting the veneer; whether cutting systems used to cut the veneer are correctly adjusted and the physical condition of the components of the cutting systems; any defects or foreign material in the veneer; the quality of the veneer, and the best use for the veneer. In addition, smoothness and texture of the surfaces of the veneer are representative not only of the surface of the veneer compared to a parallel surface, but also the underlying structural composition of the wood fibers composing the veneer.

Consequently, examining and monitoring the surface texture of the veneer can be critical to determining if the processing of the veneer is being conducted under optimal conditions, if the mechanisms used to process the veneer are in optimal condition and are operating correctly, and if the veneer itself is of the desired quality for the intended use of the veneer.

As one specific illustrative example, veneer is a primary component of numerous intermediate and finished wood products. However, like most wood products, veneer can have widely varying levels of strength, quality, and finish. Therefore, when working with veneer to produce intermediate or finished wood products, such as plywood or LVL, it is important to determine as accurately as possible the texture of the surfaces of the veneer.

Veneer is typically created by either stripping long ribbons of veneer from a wood source, such as a peeler log, using a rotary cutting process or using plain slicing methods on source logs or wood blocks when a more pronounced grain pattern is desired.

In a typical process, an entire tree (commonly called a log) is delivered to a mill for processing. The delivered logs are either used within a few days-weeks to prevent dry out or are sprinkled with water to prevent dry out during longer term storage before use. This prevents drying and splitting of the log.

Typically, the logs, i.e., the whole trees, are fed thru a debarker which strips the bark. Then the stripped logs are sent to a block saw that cuts the stripped logs to a desired length, typically 4′-12′. These 4′ to 12′ lengths of stripped log are often called blocks.

After being processed into blocks or peeler logs, preconditioning of the blocks is begun, typically almost immediately. As part of the preconditioning process, the blocks are sent to vats or “baths” of water that often include one or more caustic chemicals, such as sodium hydroxide, which tends to soften the wood chemically. In addition, the caustic water mixture is often heated and/or the blocks/peeler logs are stream treated to soften the component fibers and reduce splintering, cracking and breakage during and after processing.

This preconditioning process is critical to veneer production to ensure the peeling, or slicing, is successful, i.e., results in an unbroken ribbon or sheet of veneer of consistent texture. However, adjusting the preconditioning process has traditionally proven difficult. This is because finding the best combination of chemical composition of the caustic water mix, temperature of the caustic water mix, and soak time for the logs in the vats of caustic water mix is extremely challenging because the diameter of the parent logs, type of wood, density of the wood, and presence of foreign materials is not a constant in any natural resource, such as trees. Consequently, the optimal combination of specific chemical composition of the caustic water mix, specific temperature of the caustic water mix, and specific soak time for optimal preconditioning can vary not only from type of wood to type of wood, but from region to region, harvesting area to harvesting area, grove to grove, harvest to harvest, harvest time/season to harvest time/season, tree to tree, and even within the same tree.

However, if the optimal combination of preconditioning parameters is not found, then the resulting preconditioned logs can be over conditioned and “mushy” resulting in bubbled and overly soft veneer sheets, typically reduced in strength and that are more likely to break, or under conditioned, resulting in hard and roughly cut veneer sheets that are more likely to splinter, crack or break.

The situation described above is made even more complicated by the fact that outer surfaces of a parent log or other wood source are generally more conditioned than the inner surfaces. Consequently, a parent log whose outer diameter wood is correctly conditioned may have inner diameter wood that is under conditioned or not conditioned at all. Likewise, in order to ensure inner diameter wood is correctly conditioned, the outer diameter wood may become over conditioned.

The majority of veneer that is produced today, i.e., hardwood, decorative veneers, face and back veneers, inner plies for LVL veneer cores, and pine or fir veneers, are all typically rotary cut.

FIG. 1A shows a preconditioned wood source, in this example a peeler log 101, being processed into veneer ribbon using rotary cutting methods. When using the rotary cut method, the entire preconditioned peeler log 101 is held in place in a lathe system 100 with the help of a lathe chuck 105. Some lathes use one or more computerized methods to determine the true center of the log in order to optimize the yield (not shown). The rotation speed of the preconditioned peeler log 101 log is typically controlled and variable.

After optimally positioning the preconditioned peeler log 101, it is rotated in direction 103 against a carriage-mounted knife 110 on one side and a pressure bar 111 on the opposite side to cut veneer ribbons 120 of consistent thickness 121. The first few feet of veneer that are obtained when the preconditioned log is rotated may produce sheets of varying lengths. This is called “round-up”. They can be used for different applications or may even be discarded

Ideally, the rotating preconditioned peeler log 101 can start producing quality veneer ribbons 120 akin to cloth being pulled from a bolt. These veneer ribbons 120 are then fed into a clipping line (not shown) to obtain predetermined widths and to remove defects that include rotten areas, large knots, foreign objects, etc. Thereafter, the veneer sheets (not shown) are fed into a dryer (not shown) to reduce the moisture to a level acceptable for the purposed use of the veneer sheets.

In order to produce quality veneer ribbons 120, several processing parameters must be optimized in addition to the preconditioning parameters discussed above. These include but are not limited to ensuring the cutting knife 110 is relatively sharp and free from damage and defects; ensuring the knife is kept at the optimal angle 131 with respect to the preconditioned peeling log surface 107; ensuring the pressure applied by pressure bar 111 keeps the knife 110 in steady contact with the preconditioned peeling log surface 107.

As seen above, in order for high quality veneer to be successfully produced, it is important that the wood source, such as peeler logs, be properly preconditioned using optimally adjusted precondition parameters such as the chemical composition of the soaking water, the temperature of the soaking water, and the soak time. In addition, it is equally important that the processing parameters such as ensuring the cutting knife is relatively sharp and free from damage and defects, ensuring the knife is kept the optimal angle with respect to the preconditioned peeling log surface, ensuring the pressure applied by a pressure bar keeps the knife in steady contact with the preconditioned peeling log surface must be optimized as the veneer is being cut from the wood source. The preconditioning parameters and processing parameters discussed above are referred to collectively herein as production parameters.

FIG. 1B shows a table of example production parameters and the effect variance in the production parameters can have on the wood product, e.g., on the resulting veneer.

As is evident in FIG. 1B, and from the discussion above, in order to most efficiently process a wood source, such a peeler logs, into high quality wood product, such as quality veneer ribbon, numerous production variables/parameters must be optimized and adjusted. When dealing with natural materials that are often inconsistent in composition, such as preconditioned peeler logs, and processing mechanisms, such as lathes, knife blades, and pressure systems, this can be a very difficult and a dynamically changing environment.

It follows that monitoring the variables/parameters associated with log preconditioning and processing is critical to the veneer making process. However, traditionally, this has proven very difficult for several reasons. First, as discussed above, finding the best combination of chemical composition of the caustic water mix, temperature of the caustic water mix, and soak time for the logs in the vats of caustic water mix for preconditioning is extremely complicated and challenging, not only because of the varying physical parameters of the individual blocks/peeler logs, but ambient temperature and relative humidity fluctuations as well.

However, determining whether the preconditioning processing of parent logs is effective can, in theory be determined by analyzing the texture of the veneer produced from the log. Traditionally, this was accomplished by examining the surfaces of the veneer ribbons or sheets under magnification after a parent log, or multiple logs, were fully processed into veneer ribbon.

It is known that under magnification, veneer created from wood source preconditioned using different preconditioning parameters, e.g., from over conditioned logs, from optimally conditioned logs, and from under conditioned logs has a different surface texture that can be identified under magnified conditions using visible light.

FIG. 2A shows a side view of a magnified surface 203 of veneer 201 that was produced from an optimally preconditioned log. In the specific illustrative example of FIG. 2A, the veneer thickness 205 is approximately 0.166 inches and the magnification level is 10×

As seen in FIG. 2A, magnified surface 203 of veneer 201 is relatively consistent in grain and texture down the entire magnified surface 203 of veneer 201 and has no cracks, bulges or bubbles, or sections of significantly uneven grain or width.

FIG. 2B is a representation of a magnified surface 213 of a veneer 211 that was produced from an over preconditioned wood source.

As seen in FIG. 2B, due to the over conditioning of the wood source used to generate veneer 211, magnified surface 213 includes bubbles 215. Typically bubbles 215 result in veneer 211 having a “mushy” consistency. Bubbles 215 are typically formed of pulled wood fiber. When sheets of veneer are utilized that are cut from veneer ribbon from over conditioned wood sources, such as veneer 211, and the veneer sheets are stacked, the fibers making up bubbles 215 can be compressed back to relatively flat. However, the structural strength is not regained and this, in turn, results in a degraded strength and inferior texture for veneer 211 and any wood products created with veneer 211.

FIG. 2C shows the magnified surface 223 of a veneer 221 that was produced from an under preconditioned wood source.

As seen in FIG. 2C, due to the under conditioning of the wood source used to generate veneer 221, magnified surface 223 includes rips/tears 225. Rips/tears 225 are the result of the veneer 221 being cut from too dry and hard a wood source due to insufficient preconditioning of the wood source, such as a peeler log. This, in turn, results in degraded strength and inferior texture for veneer 221. The magnification level in FIG. 2C is approximately 10×.

Similarly, non-optimal processing parameters such as, uneven knife edges, a dull knife, and uneven knife pressure also results in visual imperfections that can be identified under magnified conditions using visible light.

FIG. 2D shows the magnified surface 233 of a veneer 231 that was produced using a damaged knife having one or more nicks or other knife edge damage.

As seen in FIG. 2D, due to the damaged knife edge used to generate veneer 231, magnified surface 233 includes repeating scratches 235. Scratches 235 are the result of the damage/imperfection in the edge of the knife used to produce veneer 231 This, in turn, results in inferior texture for surface 233 of veneer 231.

FIG. 2E is an illustrated representation the magnified surface 243 of a veneer 241, as seen from a side view, that was produced using a knife that was not kept at a constant pressure against the surface of the wood source, such as a preconditioned peeling log.

As seen in FIG. 2E, magnified surface 243 of a veneer 241 is uneven and “wavy” and includes curvatures 242 due the fact that veneer 241 was produced using a knife that was not kept at a constant pressure against the surface of the wood source. This wavy nature of the magnified surface 243 of a veneer 241 creates stress points at each curvature. It is these stress points that often cause a veneer ribbon such as veneer 241 to break as it is flexed in downstream processing.

FIG. 2F shows a magnified side view of a surface 253 of a veneer 251 that was produced using a knife that was dull, as seen in side view.

As seen in FIG. 2F, due to the dull knife edge used to generate veneer 251, magnified surface 253 is irregular and includes irregularities or bumps 255. Bumps 255 are the result of the fact that a dull knife tends to move away from or ride over the block/peeler log when hard spots, i.e., areas of high density in the peeler log, are encountered. This produces a veneer 251 that, as shown in FIG. 2F can vary in thickness and surface flatness. In contrast, a sharp knife would shear the hard wood smoothly without being pushed back.

As noted, traditionally the effects of improper conditioning and damaged or incorrectly adjusted cutting mechanisms were identified by magnifying the surface of the veneer and then examining the magnified surface. Given the processing and production line speeds, this visual examination of the magnified veneer surface was done offline, and typically after an entire log, group of logs, or multiple sheets of veneer had been processed. In addition, since the samples needed to be magnified using traditional visual light-based systems, the sample sizes had to be relatively small, on the order of a few inches by a few inches, and were taken relatively infrequently, such as every few feet or more of veneer.

Consequently, using traditional methods, a defect in the preconditioning or cutting mechanisms, i.e., non-optimized production parameters, was often only discovered after significant amounts of defective product were produced. The result was that large amounts of inferior or unusable product was often processed and produced before any problem was detected. This is neither an ideal situation for the producer of the wood products or the end customer who inevitably must pay a higher price to take into account these inefficiencies. It also represents an extremely unfortunate waste of natural and human resources.

As noted, traditionally the effects of improper conditioning and/or damaged or incorrectly adjusted cutting mechanisms using visual examination of the magnified veneer surface was done offline, and typically after an entire log, group of logs, or multiple ribbons of veneer had been processed. This is because the traditional methods rely on examination of the veneer surfaces using visible light and visible light is problematic for several reasons.

Frist, visible light represents the spectrum of frequencies extending from 430 to 7100 Terahertz (Thz) which equates relatively large wavelengths extending 380 to 740 nanometers (nm). Consequently, the detail that can be discerned at these relatively large wavelengths is less than that that could be discerned using electromagnetic energy of smaller wavelengths. Consequently, using visible light sources, only the most significant surface features can be detected with the naked eye.

Therefore, surface areas being examined using visible light methods must be magnified. Since the images must be magnified using traditional visible light techniques, the veneer surface must be analyzed in smaller sections and cannot be accomplished easily, or often at all, at the speeds of a typical production line. Therefore, the analysis must be conducted offline, or the production line would have to be slowed to an unacceptable speed.

In addition, visible light is subject to interference and dilution by the background light and ambient light sources that must be present on any production line to maintain a safe workplace. Consequently, the surface areas must be magnified, and the evaluation must be conducted offline and away from background ambient light sources present on the production line.

While veneer is discussed above as an illustrative example, accurately examining surface texture is important for any wood product, and especially for those wood products used as layers or that are composed of layers. This is because the presence of a rougher than optimal surfaces of veneer products can determine what uses the wood product can be put to and if the finished or intermediate wood product will remain structurally sound during and after processing. As a specific illustrative example, the texture of the surface of a wood product to be used as a layer in a finished or intermediate wood product can be critical in determining what type, and how much, adhesive should be used in processing the wood product and other processing parameters.

The use of veneer, and other layered wood products, allows wood products of various thickness and dimensions to be created without milling a board of the desired thickness or dimension from a single log or single piece of lumber. This, in turn, allows for much more efficient use of natural resources. Indeed, without the use of various layered wood technologies, such as veneer products, the forests of the planet would have been depleted long ago simply to meet the construction needs of the ever-increasing world population. However, the presence of irregular surfaces in layered sheets can create serious problems, such as cracks or other defects, in the layered wood product. This, of course, results in compromised structural integrity of the layered wood product and/or undesirable imperfections in the appearance of the layered wood product.

In addition, layered wood products, such as plywood, EWP, PLV, and LVL are made of thin layers of veneer. Typically, the veneer is obtained manually from stacks or bins of full veneer sheets, veneer strips, and/or partial veneer sheets. In theory, the veneer sheets making up each of the stacks or bins of veneer should be of consistent grade.

In the case of plywood, in addition to full veneer sheets, layers of “core material” composed of veneer strips and/or partial veneer sheets are placed such as to rotate the grain approximately 90 degrees from the full veneer sheets above and below. Once again, these veneer strips and/or partial veneer sheets are obtained from stacks or bins of veneer that, in theory, should have been inspected and consistently graded.

In the example of plywood, the alternating layers of oriented grain material increase the structural rigidity of the panel. Typically, a first full veneer sheet is obtained from a first full veneer sheet stack of the appropriate grade and one side (top) of the first full veneer sheet is coated with an adhesive, e.g., glue, and then a layer of core material made up of veneer strips and/or partial veneer sheets is manually obtained from a veneer stack/bin of veneer strips and/or partial veneer sheets of the appropriate grade and is placed on the first full veneer sheet. Glue is then applied to the layer of partial veneer sheets and a second full veneer sheet is obtained from a full veneer sheet stack of the appropriate grade and is applied to the layer of partial veneer sheets. The resulting three-ply structure made up of a first full veneer sheet (the first ply), glue, a layer of veneer strips and/or partial veneer sheets (the second ply), glue, and a second full veneer sheet (the third ply) is referred to as a three-ply “green” panel, with each individual layer of construction, e.g., full veneer sheets, or veneer strips and/or partial veneer sheets layer, within the panel commonly referred to as a “ply”. Typically, plywood panels are made up of multiple plys with three to eleven plys or more being common. Once the green panel is created, there remain additional processes that are required to transform the green panel into a cured, or finished, panel. Typically, the first process downstream is to “pre-press” the green panel product. This is typically performed on a stack of green panels with 12-40 panel stacks being common. The typical pre-press is a single opening press into which the entire stack of green panels is conveyed. The press closes, pressing the green panels between an upper and lower rigid surface. This pressing or “compaction” process is at ambient temperature and ensures all the air gaps between plys in each green panel are eliminated and a quality glue to wood contact is formed throughout the panel. After this pre-pressing action is completed, the resulting “pre-pressed panel” has increased rigidity and the stack of panels is ready for the next process, “Hot Pressing”.

The stack of pre-pressed green panels is then conveyed into an unstacking mechanism at the hot press. This mechanism sequentially loads a single pre-pressed green panel from the stack into individual separate heating chambers in the hot press. Essentially sandwiching each pre-pressed green panel between two heated metal plates, commonly referred to as heating platens. When each of the individual heating chambers “Platens” have a pre-pressed green panel loaded, the press closes applying pressure and heat to the pre-pressed green panel. The combination of heat and pressure cures the glue and creates a rigid “cured” panel. In this way a continuous material assembly and processing routine is created.

The production of PLV is similar to plywood production except that cross plies of core material made up of veneer strips and/or partial veneer sheets is typically not used so that each layer, e.g., ply, of PLV is a full veneer sheet. In this process, a first full veneer sheet is obtained from a first veneer stack of the appropriate grade and one side (top) of the first full veneer sheet is coated with an adhesive, e.g., glue. Then a second full veneer sheet is obtained from a second veneer stack of the appropriate grade and glue is applied to the second full veneer sheet. A third full veneer sheet is obtained from a third veneer stack of the appropriate grade and is applied to the second full veneer sheet. This process is repeated until the desired number of full veneer sheets, e.g., plys, is achieved. The resulting multiple full veneer sheet ply structure is called a PLV panel. As with plywood production, the resulting PLV panel is still a green panel, that must be “pre-pressed” to flatten out the veneer layer components and create the wood to glue bond, and then cured using a “hot press” where both pressure and heat are applied to cure the glue and create a cured panel. As with the plywood example discussed above, multiple green panels are produced, stacked, and sent to the pre-press. Then these pre-pressed panel stacks are sent to the hot press. In this way a continuous material assembly and processing routine is created.

Prior art layered wood product assembly methods and systems use a conveyor to move material progressively past multiple feeder stations where human workers obtain full veneer sheets and veneer strips/partial veneer sheets from veneer stacks. At the various feeder stations successive layers of full veneer sheets are obtained from full veneer sheet stacks, glue, and veneer strips/partial veneer sheets layers (if required) are obtained from veneer strip and/or partial veneer sheet stacks to build a panel of a desired number of plys. This system of conveyor, feeder stations, glue applicators, etc. is commonly referred to as a “Layup Line.” When the multi-ply panel reaches the end of the layup line, it is discharged to form “green panel stack.”

From the layup line the green panel stacks are conveyed, typically by a second conveying system, to a pressing area and pressing stations. Typical plants utilize multiple press lines with two press lines being commonly used for small plants and up to eight press lines in large plants.

As discussed above, in the pressing area, the green veneer panel stacks are conveyed to a single opening pre-press machine center typically utilizing upper and lower platens positioned by mechanical or hydraulic rams to compact the green panel stack, eliminating air between layers of wood, and promoting an even spread of the glue between layers of veneer. After pre-pressing, the now pre-pressed layered wood product stacks are conveyed into an unstacking mechanism which feeds one pre-pressed layered wood product panel at a time from the stack into a multi-opening hot press. Typically, hot presses contain between 12 and 40 individual openings, each of which can process one pre-pressed layered wood product panel. When the hot press is loaded with panels, mechanical or hydraulic systems close the press and heat is applied to cure the glue. It is this combination of heat and pressure that causes the full veneer sheets and/or partial veneer sheets to bond and become cured plywood, PLV, or LVL panels.

As shown above, the production of layered wood products is both material and manpower intensive. Consequently, it is critical to make sure the full veneer sheets and/or veneer strips and/or partial veneer sheets used to make the layered wood products are of the proper grade and are stacked so that they can be manipulated and processed without undue damage to the veneer, the machinery involved, and the human workers.

As also discussed above, virtually every form of layered wood product production would benefit greatly from properly and consistently graded full veneer sheets and/or veneer strips and/or partial veneer sheets which are uniformly stacked. Consequently, it is important that stacks of full veneer sheets, veneer strips, and/or partial veneer sheets should include full veneer sheets, veneer strips, and/or partial veneer sheets, respectfully, that are consistently of the same grade with respect to appearance, moisture levels, surface regularity, and strength. However, as discussed above, prior art visible light systems for identifying these surface irregularities to grade full veneer sheets, veneer strips, and/or partial veneer sheets are often ineffective and inefficient for use with stacking systems for at least the reasons discussed above. Consequently, as discussed above, even if prior art prior art visible light systems, were used, the results would be inconsistent and inaccurate and therefore the consistency of the veneer stacks would still be unacceptable.

As a result, using current methods, the stacks of full veneer sheets and/or veneer strips and/or partial veneer sheets are typically graded by human workers visually/manually and then stacked, in theory, according to grade by the same human workers. Indeed, using currently available methods and systems, not only are the veneer stacks created by manual operations, but the workers are also typically tasked with visually and manually grading the full veneer sheets and/or veneer strips and/or partial veneer sheets as the veneer stacks are created. As discussed in detail below, this use of human workers to simultaneously grade and stack veneer represents a weak link in the production chain that often results in virtually ungraded veneer, poorly stacked veneer, wasted, or inefficiently used materials, safety issues, repetitive motion injuries, and worker fatigue/burnout.

In operation, using prior art grading and stacking systems, as individual full veneer sheets, veneer strips, or partial veneer sheets move along a hand sort conveyor, human workers are tasked with quickly visually grading each full veneer sheet, veneer strip, or partial veneer sheet and then manually moving each full veneer sheet, veneer strip, or partial veneer sheet into an appropriate veneer stack based on the grade of the full veneer sheet, veneer strip, or partial veneer sheet. Which of the veneer stacks to which a given full veneer sheet, veneer strip, or partial veneer sheet is moved is, in theory, dependent on the grade the human workers assign to the full veneer sheet, veneer strip, or partial veneer sheet. For instance, there are, in one specific illustrative example, eight or more veneer stacks, and each of these veneer stacks could be associated with a different grade of full veneer sheet, veneer strip, or partial veneer sheet. Consequently, in theory, human workers must manually and visually examine each full veneer sheet, veneer strip, or partial veneer sheet as it moves along a hand sort conveyor, make a determination of the grade of the full veneer sheet, veneer strip, or partial veneer sheet, based at least in part on the surface of the full veneer sheet, veneer strip, or partial veneer sheet, then manually move the full veneer sheet, veneer strip, or partial veneer sheet from the hand sort conveyor to the appropriate veneer stack for that grade.

As might be anticipated, it is extremely difficult for human workers to perform this visual grading of full veneer sheet, veneer strip, or partial veneer sheet consistently and accurately for any reasonable amount of time, even under conditions where the speed of hand sort conveyor is very slow. However, since the speed of hand sort conveyor determines the amount of product made, hand sort conveyor is not ideally operating at a very slow speed, in fact, the faster the better from a production standpoint. Consequently, to make this process economically viable, hand sort conveyor typically moves at a speed that virtually ensures no effective or consistent grading of full veneer sheet, veneer strip, or partial veneer sheet is actually performed by human workers.

In addition, whenever the prior art hand sort conveyor is operating at an economically viable speed, it is very difficult for human workers to manually move the full veneer sheets, veneer strips, or partial veneer sheets from the hand sort conveyor to the appropriate veneer stack without damaging the relatively thin and fragile full veneer sheets, veneer strips, or partial veneer sheets by tearing, folding, or otherwise deforming the individual full veneer sheets, veneer strips, or partial veneer sheets. This, in turn, often results in damaged product and wasted, or at least non-optimal use of, full veneer sheets, veneer strips, or partial veneer sheets.

In addition to being given the virtually impossible task of grading and manually moving each full veneer sheet, veneer strip, or partial veneer sheet from the hand sort conveyor to the appropriate grade veneer stack without damaging the full veneer sheet, veneer strip, or partial veneer sheet, using prior art systems and methods the human workers are further tasked with adding full veneer sheets, veneer strips, or partial veneer sheets to the appropriate veneer stack in such a way that the dimensions of the veneer stacks are consistent and that the edges of each veneer stack are as even as possible. In other words, each individual full veneer sheet, veneer strip, or partial veneer sheet should be laid on the appropriate veneer stack carefully and precisely so that the edges of each full veneer sheet, veneer strip, or partial veneer sheet are aligned, and the resulting veneer stacks have relatively even sides with no jagged surfaces or individual full veneer sheet, veneer strip, or partial veneer sheet extending beyond the edge of the veneer stacks.

This is important for several reasons. First, jagged edges are a safety hazard to human workers who can readily be cut or receive splinters by handing or rubbing up against any jagged edges. In addition, transporting veneer stacks with jagged edges to the production site for the layered wood products, typically via forklift, is also prone to cause further edge damage by contact with the forklift mechanism or downstream production equipment. This handling damage on the misaligned sheets often results in breakage that reduces the dimensions from a full sheet to a strip or partial sheet. In addition, if the veneer stacks are not well aligned, e.g., they have jagged edges and or misaligned full veneer sheets, veneer strips, or partial veneer sheets, the veneer stacks can be unstable and/or unsuitable for use with automated or manual systems down the line, such as feeder stations or layup lines.

While, as noted, it is important and ideal that the edges of each full veneer sheet, veneer strip, or partial veneer sheet are aligned and the resulting veneer stacks have relatively even sides with no jagged surfaces or individual full veneer sheet, veneer strip, or partial veneer sheet edges extending beyond the edge of the veneer stacks, given the number of tasks assigned to human workers using prior art systems, it is most often the case that the resulting veneer stacks do include numerous full veneer sheet, veneer strip, or partial veneer sheet that are not aligned. Consequently, using prior art methods and systems, the resulting veneer stacks do not have even sides and therefore do have jagged edges. In addition, the time pressure and repetitive nature of the tasks placed on human workers represents a significant safety issue and a major source of repetitive motion injuries and worker burnout. This, in turn, results in high worker turnaround and often inexperienced human workers on the line.

As discussed above, using prior art full veneer sheet, veneer strip, or partial veneer sheet stacking methods and systems, human workers are assigned an unrealistic set of tasks to be performed in an unrealistic amount of time. These include performing visual grading of full veneer sheets, veneer strips, or partial veneer sheets as they move along the hand sort conveyor, manually moving full veneer sheets, veneer strips, or partial veneer sheets from hand sort conveyor to the appropriate veneer stack associated with the visual and manual grading of the full veneer sheets, veneer strips, or partial veneer sheets (without damaging the relatively fragile full veneer sheets, veneer strips, or partial veneer sheets), and then adding full veneer sheets, veneer strips, or partial veneer sheets to the appropriate veneer stack in such a way that the dimensions of the veneer stacks are consistent and that the edges of each veneer stack are as even as possible.

As also discussed above, this is not realistic and the result is that full veneer sheets, veneer strips, or partial veneer sheets are inconsistently and/or inaccurately graded, many full veneer sheets, veneer strips, or partial veneer sheets are damaged, and the resulting veneer stacks more often than not include numerous full veneer sheets, veneer strips, or partial veneer sheets that are not aligned. Consequently, the resulting veneer stacks do not have even sides and therefore have jagged edges. In addition, as noted above, the time pressure and repetitive nature of the tasks placed on human workers represents a significant safety issue and a major source of repetitive motion injuries and worker burnout. This, in turn, results in high worker turnaround and often inexperienced human workers on the line.

FIG. 2G shows an ideal full veneer sheet stack 267A and a typical full veneer sheet stack 267B created using prior art full veneer sheet stacking methods and systems. As seen in FIG. 2G ideal full veneer sheet stack 267A has edges 269A that are even and do not fall short of, or extend beyond, the dotted lines E. As noted above, edges 269A result when the veneer sheets 262A making up ideal full veneer sheet stack 237A are lined up evenly along lines E. The result is an ideal full veneer sheet stack 267A of a consistent length dimension equal to the full veneer sheet length “Lf” and a consistent width dimension equal to the full veneer sheet width “Wf,” i.e., the situation illustrated in FIG. 2G applies to both length and width dimensions. So, in addition to ideal full veneer sheet stack 267A having edges 269A that are even and do not fall short of, or extend beyond, the dotted lines E, it is also desirable that ideal full veneer sheet stack 267A has edges (not shown in FIG. 2G) at 90 degrees to edges 269A that are even and do not fall short of, or extend beyond, lines similar to dotted lines E (not shown) that are at 90 degrees dotted lines E.

In contrast, typical full veneer sheet stack 267B created using prior art full veneer sheet stacking methods and systems has edges 269B that are uneven and do fall short of, or extend beyond, the dotted lines E. Therefore, using prior art full veneer sheet stacking methods and systems, the result is a full veneer sheet stack 267B of an inconsistent length dimension, i.e., not equal to the full veneer sheet length “Lf” and an inconsistent width dimension, i.e., not equal to the full veneer sheet width “Wf.” As noted above, edges 269B result when the veneer sheets 262B making up typical full veneer sheet stack 267B created using prior art full veneer sheet stacking methods and systems are not lined up evenly along lines E. As discussed above, this non-alignment occurs for both length and width dimensions and edges. Consequently, typical full veneer sheet stack 267B created using prior art full veneer sheet stacking methods and systems has edges (not shown) perpendicular to edges 269B that are also often uneven and do fall short of, or extend beyond lines (not shown), perpendicular to the dotted lines E, as a result of the veneer sheets 262B making up typical full veneer sheet stack 267B being created using prior art full veneer sheet stacking methods and systems. As noted, full veneer sheet stack 267B of FIG. 2G is typical of the veneer stacks created using prior art full veneer sheet stacking methods and systems and therefore represents efficiency issues, effectiveness issues, and significant safety issues, as discussed above.

FIG. 2H shows an ideal veneer strip stack 273A and a typical veneer strip stack 273B created using prior art veneer strip stacking methods and systems. As seen in FIG. 2H ideal veneer strip stack 273A has edges 279A that are even and do not fall short of, or extend beyond, the dotted lines E. Consequently, in one embodiment, ideal veneer strip stack 273A has a length dimension approximately equal to full veneer sheet length Lf and a width dimension approximately equal to full veneer sheet width Wf. As noted above, edges 279A result when the layers of veneer sheets 272A making up ideal veneer strip stack 273A are lined up evenly along lines E to a stack width approximately equal the full veneer sheet width Wf and a stack length approximately equal the full veneer sheet length Lf. In addition, in ideal veneer strip stack 273A any gaps in the layers 272A alternate. When any gaps in the layers 272A alternate as in ideal veneer strip stack 273A, the result is a relatively even top surface 275A as evidenced by line T and no veneer stack bulges.

In contrast, typical veneer strip stack 273B created using prior art veneer strip stacking methods and systems has edges 279B that are uneven and do extend short of, and beyond the dotted lines E. Consequently, in one embodiment, typical veneer strip stack 273B does not have a consistent length dimension, e.g., not approximately equal to full veneer sheet length Lf, nor a consistent width dimension, e.g., not approximately equal to full veneer sheet width Wf. As noted above, edges 279B result when the veneer sheet layers 272B making up typical veneer strip stack 273B created using prior art veneer strip stacking methods and systems are not lined up evenly along lines E. In addition, in typical veneer strip stack 273B created using prior art veneer strip stacking methods and systems, gaps in the layers 272B do not alternate and there is a material buildup in the veneer stack creating a bulge. The result is a relatively uneven and bulged top surface 275B as evidenced by line T.

As also noted above, the issue of jagged edges and bulges applies to both a length and width dimension of veneer stack 273B. Consequently, typical veneer strip stack 273B created using prior art veneer strip stacking methods and systems typically has edges (not shown) perpendicular to edges 279B that are uneven and do extend short of, and beyond the lines (not shown) perpendicular to lines E. As noted, veneer stack 273B of FIG. 2H is typical of the veneer stacks created using prior art veneer strip stacking methods and systems and therefore represents efficiency issues, effectiveness issues, and significant safety issues as discussed above.

As discussed above, prior art full veneer sheet, veneer strip, and partial veneer sheet stacking methods and systems suffer from several serious drawbacks. For instance, using prior art methods and systems for producing layered wood products, the quality of veneer fed into process is often not efficiently and effectively inspected and graded during the veneer stacking operation. Therefore, undetected defects can cause products created using the veneer to be rejected downstream after significant time and energy has already been devoted to the panels, e.g., pressing is complete and panel quality is analyzed.

In addition, as noted above and discussed in more detail below, even if prior art inspection and grading systems, such as visible light-based systems, were employed, prior art inspection and grading systems can be error prone and lead to inaccurate images of veneer being taken, which can result in the system improperly grading veneer.

In addition, using prior art full veneer sheet stacking methods and systems, human workers are assigned an unrealistic set of tasks to be performed in an unrealistic amount of time. These include performing visual grading of the veneer as it is moved along the hand sort conveyor, manually moving veneer from hand sort conveyor to the veneer stack associated with the visual and manual grading of the veneer, without damaging the relatively fragile veneer, and then adding the veneer to the appropriate veneer stack in such a way that the dimensions of the veneer stacks are consistent and that the edges of each veneer stack are as even as possible.

This is not realistic, and the result is that full veneer sheets are inconsistently and/or inaccurately graded, many full veneer sheets are damaged, and the resulting veneer stacks, more often than not, do include numerous full veneer sheets that are not aligned so the veneer stacks do not have the desired dimensions, do not have even sides, and do have jagged edges. In addition, as noted above, the time pressure and repetitive nature of the tasks placed on human workers represents a significant safety issue and a major source of repetitive motion injuries and worker burnout. This, in turn, results in high worker turnaround and often inexperienced human workers on the line.

Similarly, using prior art veneer strip and partial veneer sheet stacking methods and systems, human workers are assigned an unrealistic set of tasks to be performed in an unrealistic amount of time. These include performing visual grading of veneer strips and/or partial veneer sheets as they move along the hand sort conveyor, manually moving veneer strips and/or partial veneer sheets from hand sort conveyor to the veneer stack associated with the visual and manual grading of the veneer strips and/or partial veneer sheets, without damaging the relatively fragile veneer strips and/or partial veneer sheets, and then adding veneer strips and/or partial veneer sheets to the appropriate veneer stack in layers in such a way that the dimensions of the veneer stacks are consistent, that the edges of each veneer stack are as even as possible, and that the veneer stack is bulge free.

This is also not realistic, and the result is that veneer strips and/or partial veneer sheets are inconsistently and/or inaccurately graded, many veneer strips and/or partial veneer sheets are damaged, and the resulting veneer stacks, more often than not, do include numerous veneer strips and/or partial veneer sheets that are not aligned, the veneer stacks do not have the desired dimensions or even sides, and do have jagged edges, and the veneer stacks have bulges of low and high spots. In addition, as noted above, the time pressure and repetitive nature of the tasks placed on human workers represents a significant safety issue and a major source of repetitive motion injuries and worker burnout. This, in turn, results in high worker turnaround and often inexperienced human workers on the line.

Consequently, prior art full veneer sheet, veneer strip, and partial veneer sheet grading and stacking methods and systems are inefficient, inconsistent, require significant human interaction with complicated machines, and significant human manipulation of veneer.

What is needed is a method and system for full veneer sheet, veneer strip, and partial veneer sheet grading and stacking that addresses the shortcoming of prior art methods and systems for full veneer sheet, veneer strip, and partial veneer sheet stacking.

### SUMMARY

Embodiments of the present disclosure provide an effective and efficient technical solution to the technical problem of accurately and efficiently grading and stacking full veneer sheets, veneer strips, and/or partial veneer sheets. In one embodiment, irregularities on the surfaces of full veneer sheets, veneer strips, and/or partial veneer sheets are detected using Near InfraRed (NIR) technology, including Near InfraRed/Short Wave InfraRed (NIR/SWIR) cameras and detectors. In one embodiment, a grade is then assigned to the full veneer sheets, veneer strips, and/or partial veneer sheets based, at least in part, on the detected irregularities. In one embodiment, the full veneer sheets, veneer strips, and/or partial veneer sheets are then provided to an improved veneer stacking system that produces more consistently graded veneer stacks and safer veneer stacks, is less expensive to operate, and is far safer than currently available methods and systems for full veneer sheet, veneer strip, and partial veneer sheet stacking.

To this end, embodiments of the present disclosure utilize NIR analysis systems including Near InfraRed (NIR) technology, such as Near InfraRed/Short Wave InfraRed (NIR/SWIR) cameras and detectors, to accurately identify surface irregularities and the specific locations of the irregularities in a wood product, such as a veneer ribbon, full veneer sheet, veneer strip, and/or partial veneer sheet. As discussed in more detail below, in some embodiments, an irregularity level to greyscale mapping database is generated that maps surface irregularities to NIR image greyscale values for one or more wood products, such as, but not limited to, full veneer sheets, veneer strips, and/or partial veneer sheets. In one embodiment, the surface irregularity level to greyscale mapping database includes mapping data obtained via controlled empirical methods.

In one embodiment, the NIR analysis system is provided as part of a veneer analysis system. In one embodiment, the NIR analysis system includes one or more sources of illumination positioned to illuminate at least one surface of a wood product, such as a veneer ribbon, full veneer sheet, veneer strip, and/or a partial veneer sheet. In one embodiment, the NIR analysis system includes one or more NIR/SWIR cameras, hereafter referred to as simply NIR cameras, positioned to capture one or more NIR images of the illuminated surface of the full veneer sheet, veneer strip, and/or a partial veneer sheet.

In one embodiment, a full veneer sheet, veneer strip, and/or a partial veneer sheet to be analyzed is positioned in, or passed through, the NIR analysis system such that a surface of the full veneer sheet, veneer strip, and/or a partial veneer sheet to be analyzed is illuminated by the one or more illumination sources. The one or more NIR cameras are then used to capture one or more NIR images of the illuminated surface of the full veneer sheet, veneer strip, and/or a partial veneer sheet.

In one embodiment, the one or more NIR images of the illuminated surface of the full veneer sheet, veneer strip, and/or a partial veneer sheet are converted to NIR greyscale images with different greyscale values indicating different irregularity sizes, heights, or levels in the illuminated surface of the full veneer sheet, veneer strip, and/or a partial veneer sheet.

In one embodiment, the greyscale values shown in the NIR greyscale images are processed using the surface irregularity level to greyscale mapping database to identify irregularity sizes, heights, or levels over the entire surface of the full veneer sheet, veneer strip, and/or a partial veneer sheet.

In one embodiment, the full veneer sheet, veneer strip, and/or a partial veneer sheet is then graded based on the identified irregularity levels and their positions/locations over the surface of the full veneer sheet, veneer strip, and/or a partial veneer sheet. In one embodiment, based, at least in part, on the grade assigned to the full veneer sheet, veneer strip, and/or a partial veneer sheet being analyzed, one or more actions are taken with respect to the full veneer sheet, veneer strip, and/or a partial veneer sheet including, but not limited to, assigning the full veneer sheet, veneer strip, and/or a partial veneer sheet to a specific veneer stack associated with the grade assigned to the full veneer sheet, veneer strip, and/or a partial veneer sheet.

As discussed in more detail below, in some embodiments, one or more machine learning based surface irregularity prediction models are trained using NIR image data for one or more full veneer sheets, veneer strips, and/or partial veneer sheets along with various other production parameters and corresponding empirically determined irregularity levels and product failures for the grade assigned to the full veneer sheet, veneer strip, and/or a partial veneer sheet.

In one embodiment, an NIR analysis system is provided that includes one or more sources of illumination positioned to illuminate a surface of the full veneer sheet, veneer strip, and/or a partial veneer sheet and one or more NIR cameras positioned to capture one or more NIR images of the illuminated surface of the full veneer sheet, veneer strip, and/or a partial veneer sheet.

In one embodiment, a full veneer sheet, veneer strip, and/or a partial veneer sheet to be analyzed is positioned, or passed through, the NIR analysis system such that a first surface of the full veneer sheet, veneer strip, and/or a partial veneer sheet to be analyzed is illuminated by the one or more illumination sources.

In one embodiment, one or more NIR images of the illuminated first surface of the full veneer sheet, veneer strip, and/or a partial veneer sheet are then captured using the one or more NIR cameras and the one or more NIR images of the illuminated first surface of the full veneer sheet, veneer strip, and/or a partial veneer sheet are processed to generate NIR image data for the illuminated first surface of the full veneer sheet, veneer strip, and/or a partial veneer sheet.

In one embodiment, the NIR image data for the illuminated first surface of the full veneer sheet, veneer strip, and/or a partial veneer sheet is then provided to the one or more trained machine learning based surface irregularity prediction models and surface irregularity prediction data for the full veneer sheet, veneer strip, and/or a partial veneer sheet is obtained from the one or more trained machine learning based surface irregularity prediction models.

In one embodiment, a grade is assigned to the full veneer sheet, veneer strip, and/or a partial veneer sheet based on the surface irregularity prediction data for the full veneer sheet, veneer strip, and/or a partial veneer sheet and, based at least in part, on the grade assigned to the full veneer sheet, veneer strip, and/or a partial veneer sheet, one or more actions are taken with respect to the full veneer sheet, veneer strip, and/or a partial veneer sheet including, but not limited to, assigning the full veneer sheet, veneer strip, and/or a partial veneer sheet to a specific veneer stack associated with the grade assigned to the full veneer sheet, veneer strip, and/or a partial veneer sheet.

In one embodiment, production parameters such as preconditioning or processing parameters, of a full veneer sheet, veneer strip, and/or a partial veneer sheet, such as a veneer ribbon, are dynamically adjusted based on a level of surface irregularity of a veneer ribbon surface.

In one embodiment, a surface irregularity level to greyscale mapping database is generated, that maps surface irregularities to Near InfraRed (NIR) image greyscale values for one or more full veneer sheets, veneer strips, and/or partial veneer sheets. In this embodiment, an NIR greyscale image to preconditioning level database is also generated mapping NIR greyscale images of a surface of a full veneer sheet, veneer strip, and/or a partial veneer sheet to a preconditioning level of wood source used to produce the full veneer sheet, veneer strip, and/or a partial veneer sheet.

In one embodiment, an NIR greyscale image to processing parameter database is generated mapping NIR greyscale images of a surface of a full veneer sheet, veneer strip, and/or a partial veneer sheet to processing parameter values used to produce the full veneer sheet, veneer strip, and/or a partial veneer sheet or one or more misadjusted processing parameters used to produce the one or more full veneer sheet, veneer strip, and/or partial veneer sheets.

In an alternative embodiment, one or more machine learning based production adjustment models are trained using Near InfraRed (NIR) image data for one or more full veneer sheet, veneer strip, and/or partial veneer sheets, and determined corresponding conditioning levels of wood source, such as logs, used to produce the one or more full veneer sheets, veneer strips, and/or partial veneer sheets or one or more misadjusted production parameters used to produce the one or more full veneer sheet, veneer strip, and/or partial veneer sheets.

In various embodiments, an NIR analysis system is provided that includes one or more sources of illumination positioned to illuminate a surface of a full veneer sheet, veneer strip, and/or a partial veneer sheet, such as a veneer ribbon, and one or more NIR cameras positioned to capture one or more NIR images of the illuminated surface of the full veneer sheet, veneer strip, and/or a partial veneer sheet.

In one embodiment, the full veneer sheet, veneer strip, and/or a partial veneer sheet, to be analyzed is positioned in the NIR analysis system such that a first surface of the full veneer sheet, veneer strip, and/or a partial veneer sheet to be analyzed is illuminated by the one or more illumination sources.

In one embodiment, one or more NIR images of the illuminated first surface of the full veneer sheet, veneer strip, and/or a partial veneer sheet are captured using the one or more NIR cameras and the one or more NIR images of the illuminated first surface of the full veneer sheet, veneer strip, and/or a partial veneer sheet are processed to generate NIR greyscale images indicating different irregularity levels in the illuminated first surface of the full veneer sheet, veneer strip, and/or a partial veneer sheet.

In one embodiment, the greyscale values shown in the NIR greyscale images are processed using the surface NIR greyscale image to preconditioning level database and/or the NIR greyscale image to processing parameter database to identify irregularity levels over the surface of the full veneer sheet, veneer strip, and/or a partial veneer sheet being analyzed.

In an alternative embodiment, the NIR image data for the illuminated first surface of the full veneer sheet, veneer strip, and/or a partial veneer sheet is provided to the one or more trained machine learning based production adjustment models and production or processing adjustment parameter prediction data for the full veneer sheet, veneer strip, and/or a partial veneer sheet is obtained from the one or more trained machine learning based surface irregularity prediction models.

Then, based on the determined preconditioning level or processing parameter maladjustment used to produce the full veneer sheet, veneer strip, and/or a partial veneer sheet, or the determined necessary processing parameter adjustment, and/or the production or processing adjustment parameter prediction data, one or more one or more production parameters for producing subsequent full veneer sheet, veneer strip, and/or a partial veneer sheet are adjusted.

In various embodiments, the one or more production parameters are preconditioning parameters for subsequent wood sources used to produce subsequent full veneer sheet, veneer strip, and/or partial veneer sheets and include: an amount of chemical used in a preconditioning liquid used to precondition the wood source; a type of chemical used in a preconditioning liquid used to precondition the wood source; a time the wood source soaks in a preconditioning liquid used to precondition wood source; and a temperature of a preconditioning liquid used to precondition the wood source.

In various embodiments, the one or more production parameters are processing parameters adjusted for producing subsequent full veneer sheet, veneer strip, and/or a partial veneer sheet from the wood source in relative real time and include: replacing a knife or other processing component; adjusting a rotation speed of a lath turning the wood source; adjusting an angle between a knife used to cut the full veneer sheet, veneer strip, and/or a partial veneer sheet from the wood source; and adjusting a pressure used to keep a knife used to cut full veneer sheet, veneer strip, and/or a partial veneer sheet from the wood source in contact with a surface of the wood source.

The disclosed embodiments utilize NIR cameras to scan the surface of a full veneer sheet, veneer strip, and/or a partial veneer sheet for irregularities and create an NIR image of the surface of the full veneer sheet, veneer strip, and/or a partial veneer sheet. Since essentially each pixel of camera image data is a sample point, the resolution and accuracy of the surface irregularity detection process is only limited by the number of pixels the camera has covering the field of view, e.g., the entire first surface of a full veneer sheet, veneer strip, and/or a partial veneer sheet. Consequently, in the case where a 1.3 mega pixel camera is used there are essentially 1,300,000 individual measurement points on the surface of the full veneer sheet, veneer strip, and/or a partial veneer sheet. In addition, NIR wavelengths are in the range of 750 nanometers (nm) to 3500 nm which are much smaller that the visible wavelengths of 380 to 740 nm. Consequently, the use of NIR cameras as disclosed herein results in resolutions and accuracy that simply cannot be achieved using traditional visual irregularity detection systems.

In addition, when, as disclosed herein, NIR cameras are used as the surface irregularity detection mechanism, if greater or less resolution is deemed necessary, a higher or lower mega-pixel camera can be selected to achieve the desired resolution for the process. This can be accomplished in a relatively simple and quick camera switch out procedure. In addition, NIR camera placement with respect to the sample under analysis can be adjusted such that a quality image can be obtained as long as there is a clear field of view between the full veneer sheet, veneer strip, and/or a partial veneer sheet surface and NIR camera. Horizontal, vertical, or angled placements have no impact on the functionality of the NIR camera.

Therefore, the disclosed technical solution is capable of detecting irregularities in a wide range of samples sizes ranging from of a traditional 2″×2″ square, to a full 4′×8′ sheet or panel surface, and, by using a series of NIR images spliced together, up to an 80′-120′ ribbon of material. This, in turn, allows the disclosed embodiments to be implemented without significantly slowing down the production process or increasing the cost of the finished full veneer sheet, veneer strip, and/or a partial veneer sheet.

The use of NIR cameras, as disclosed herein, eliminates the need for any offline magnification of the full veneer sheet, veneer strip, and/or a partial veneer sheet or the need for the surface irregularity detection device, i.e., the NIR camera, to be close to the surface of a full veneer sheet, veneer strip, and/or a partial veneer sheet. This allows for more flexible placement of the sample taking device, i.e., the NIR camera.

In addition, unlike visual based detection methods NIR cameras are virtually immune to ambient visible light and interference. Consequently, use of NIR cameras as disclosed herein is far more suitable for a physical production line environment.

Further, NIR technology has been determined to be safe, i.e., representing no hazards to workers or other devices, by several testing and safety agencies. Consequently, the use of the disclosed NIR based surface irregularity detection systems results in a safe, comfortable, and efficient workplace and production floor.

Using the disclosed embodiments, surface irregularities on the surface of full veneer sheet, veneer strip, and/or partial veneer sheets can be identified efficiently, effectively, and quickly, while the production line continues operation at normal speeds, consequently, implementation of the disclosed embodiments, does not slow down production speed or change product processing time.

Using the information available from the disclosed embodiments, preconditioning parameters for subsequent wood sources used to produce subsequent full veneer sheet, veneer strip, and/or partial veneer sheets can be evaluated and adjusted without slowing down the production line. These preconditioning parameters include the amount of chemical used in a preconditioning liquid used to precondition the wood source; the type of chemical used in a preconditioning liquid used to precondition the wood source; the time the wood source soaks in a preconditioning liquid used to precondition wood source; and the temperature of a preconditioning liquid used to precondition the wood source. Consequently, the disclosed embodiments provide a technical solution to the long-standing technical problem of how to identify the interaction of these preconditioning parameters and adjust the preconditioning process for optimal results before significant amounts of defective full veneer sheet, veneer strip, and/or a partial veneer sheet have been produced.

In addition, using the information available from the disclosed embodiments, one or more processing parameters can be adjusted and applied to a single wood source as it is being processed into full veneer sheet, veneer strip, and/or a partial veneer sheet in relative real time. These processing parameters include replacing a knife or other processing component; adjusting a rotation speed of a lath turning the wood source; adjusting an angle between a knife used to cut the full veneer sheet, veneer strip, and/or a partial veneer sheet from the wood source; and adjusting a pressure used to keep a knife used to cut full veneer sheet, veneer strip, and/or a partial veneer sheet from the wood source in contact with a surface of the wood source. Consequently, the disclosed embodiments provide a technical solution to the long-standing technical problem of adjusting processing parameters for optimal results from a single wood source before significant amounts of defective full veneer sheet, veneer strip, and/or a partial veneer sheet have been produced.

In addition, in one embodiment, the NIR technology, including Near InfraRed/Short Wave InfraRed (NIR/SWIR) cameras and detectors, is used to accurately identify surface irregularities and the specific locations of the irregularities in a full veneer sheet, veneer strip, and/or a partial veneer sheet. In one embodiment, a grade is then assigned to the full veneer sheets, veneer strips, and/or partial veneer sheets based at least in part on the detected irregularities. In one embodiment, the full veneer sheets, veneer strips, and/or partial veneer sheets are then provided to an improved veneer stacking system that produces more consistently graded veneer stacks and safer veneer stacks, is less expensive to operate, and is far safer than currently available methods and systems for full veneer sheet, veneer strip, and partial veneer sheet stacking.

In one embodiment, individual full veneer sheets and/or veneer strips and/or partial veneer sheets are provided to one or more veneer analysis systems. In one embodiment, the veneer analysis systems include the disclosed the NIR analysis systems. The one or more veneer analysis systems are then used to generate images of the individual full veneer sheets and/or veneer strips and/or partial veneer sheets and precisely determine the dimensions of each individual full veneer sheet, veneer strip, and partial veneer sheet. In one embodiment, the NIR analysis systems of the one or more veneer analysis systems are also used to analyze the surface of each individual full veneer sheet, veneer strip, and partial veneer sheet, quickly and automatically, and then assign a grade to each individual full veneer sheet, veneer strip, and partial veneer sheet.

In accordance with the disclosed embodiments, the dimensions and assigned grade for each individual full veneer sheet, veneer strip, and partial veneer sheet are then used by one or more veneer selection and stacking robot control systems to control the operation of one or more veneer selection and stacking robots.

In one embodiment, the one or more veneer selection and stacking robots are then used to independently move individual full veneer sheets and/or veneer strips and/or partial veneer sheets from the veneer analysis and selection conveyor system to an appropriate veneer stack. In one embodiment, this is performed based, at least in part, on the grade assigned to the individual full veneer sheet, veneer strip, and partial veneer sheet by the one or more veneer analysis systems including one or more NIR analysis systems.

In one embodiment, the determined dimensions of each individual full veneer sheet, veneer strip, and partial veneer sheet are used by the one or more veneer selection and stacking robots to place the individual full veneer sheet, veneer strip, and partial veneer sheet on the appropriate veneer stack such that the resulting veneer stacks of defined dimension, have relatively uniform edges, top surfaces, and are virtually free of jagged edges and/or bulges of low and/or high areas.

In particular, in one embodiment, full veneer sheets and/or veneer strips and/or partial veneer sheets are passed from a dryer outfeed conveyor to a veneer analysis and selection conveyor. In one embodiment, the individual full veneer sheets and/or veneer strips and/or partial veneer sheets are provided to one or more veneer analysis systems at one or more veneer analysis system locations along the veneer analysis and selection conveyor. The one or more veneer analysis systems are then used to generate images of the individual full veneer sheets and/or veneer strips and/or partial veneer sheets and these images are processed to generate dimensions data for each individual full veneer sheet, veneer strip, and partial veneer sheet. In one embodiment, the dimensions data for each individual full veneer sheet, veneer strip, and partial veneer sheet includes data representing the relative location, center of mass, orientation, and physical dimensions of each individual full veneer sheet, veneer strip, and partial veneer sheet quickly and automatically.

In addition, in one embodiment, the one or more veneer analysis systems also include the disclosed the NIR analysis systems. In one embodiment, the NIR analysis systems of the one or more veneer analysis systems are used to analyze the surface of each individual full veneer sheet, veneer strip, and partial veneer sheet, quickly and automatically, and then assign a grade to each individual full veneer sheet, veneer strip, and partial veneer sheet. Grading data for each individual full veneer sheet, veneer strip, and partial veneer sheet is then generated representing a grade assigned to each individual full veneer sheet, veneer strip, and partial veneer sheet.

In accordance with the disclosed embodiments, the dimensions data and grading data for each individual full veneer sheet, veneer strip, and partial veneer sheet is provided to one or more veneer selection and stacking robot control systems associated with one or more local robotic veneer stacking cells. In one embodiment, the one or more veneer selection and stacking robot control systems generate veneer selection and stacking robot control signals based on analysis of the dimensions data and grading data for each individual full veneer sheet, veneer strip, and partial veneer sheet. The generated veneer selection and stacking robot control signals are then used to control the operation of one or more veneer selection and stacking robots included in the one or more local robotic veneer stacking cells.

In response to the received veneer selection and stacking robot control signals, the one or more veneer selection and stacking robots use robotic arms to locally and independently move each individual full veneer sheet, veneer strip, and partial veneer sheet from the veneer analysis and selection conveyor system to an appropriate veneer stack based on the grade assigned to the individual full veneer sheet, veneer strip, and partial veneer sheet by the one or more veneer analysis systems.

In one embodiment, the dimensions data is used to generate veneer selection and stacking robot control signals that direct the robotic arms of the one or more veneer selection and stacking robots to place the individual full veneer sheet, veneer strip, and partial veneer sheet on the appropriate veneer stack such that the resulting veneer stacks have the desired dimensions, have relatively uniform edges, relatively level top surfaces, and are virtually free of jagged edges and/or bulges of low and/or high areas.

In contrast to prior art full veneer sheet, veneer strip, and partial veneer sheet stacking methods and systems, the disclosed embodiments use a veneer analysis system, including NIR analysis systems, to accurately identify the dimensions of the full veneer sheets and/or veneer strips and/or partial veneer sheets and accurately and consistently assign a grade to the full veneer sheets and/or veneer strips and/or partial veneer sheets before the full veneer sheets and/or veneer strips and/or partial veneer sheets are placed in any veneer stack for further processing. Consequently, using the disclosed embodiments, the quality of veneer fed into downstream processes is efficiently and effectively determined during the veneer stacking operation. In this way defects that can cause products created using the veneer stacks to be rejected downstream are detected before significant time and energy has been devoted to the processing of the veneer. In addition, by consistently and accurately assigning a grade to the full veneer sheets and/or veneer strips and/or partial veneer sheets before the full veneer sheets and/or veneer strips and/or partial veneer sheets are placed in any veneer stack for further processing, individual full veneer sheets and/or veneer strips and/or partial veneer sheets can be used in the most effective and valuable way.

In addition, in contrast to prior art full veneer sheet, veneer strip, and partial veneer sheet stacking methods and systems, using the disclosed embodiments, human workers are no longer assigned an unrealistic set of tasks to be performed in an unrealistic amount of time. This is because the disclosed embodiments perform the visual grading of full veneer sheets and/or veneer strips and/or partial veneer sheets automatically and then use veneer selection and stacking robots to move the full veneer sheets and/or veneer strips and/or partial veneer sheets from the conveyor to the appropriate veneer stack. In one embodiment, the veneer selection and stacking robots use robotic arms that include selectively activated vacuum heads that are faster than humans and are far less likely to damage the relatively fragile full veneer sheets and/or veneer strips and/or partial veneer sheets.

In addition, the disclosed embodiments perform analysis of the dimensions data of each full veneer sheet, veneer strip, and partial veneer sheet and use this analysis to ensure the full veneer sheets and/or veneer strips and/or partial veneer sheets are added to the appropriate veneer stack in such a way that the dimensions of the veneer stacks are consistent, that the edges of each veneer stack are as even as possible, and that the veneer stacks are relatively bulge free.

In addition, in contrast to prior art full veneer sheet, veneer strip, and partial veneer sheet stacking methods and systems, since the disclosed embodiments do not require significant human interaction with complicated machines and significant human manual manipulation of veneer the numerous injuries associated with prior art full veneer sheet, veneer strip, and partial veneer sheet stacking methods and systems, including significant splinter injuries, machine injuries, repetitive motion injuries, worker fatigue, and worker burnout, are minimized and/or avoided completely.

Consequently, the disclosed embodiments provide an effective and efficient technical solution to the long-standing technical problem of providing a method and system for full veneer sheet, veneer strip, and partial veneer sheet grading and stacking that includes improved full veneer sheet, veneer strip, and/or a partial veneer sheet scanning and grading methods, produces more consistently graded veneer stacks and safer veneer stacks, is less expensive to operate, and is far safer than currently available methods and systems for full veneer sheet, veneer strip, and partial veneer sheet stacking.

As a result of these and other disclosed features, which are discussed in more detail below, the disclosed embodiments address the short comings of the prior art veneer grading and stacking systems.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A shows a preconditioned wood source, in this example a peeler log, being processed using rotary cutting methods.

FIG. 1B shows a table of example production parameters and the effect non-optimal production parameters can have on the full veneer sheet, veneer strip, and/or a partial veneer sheet, e.g., on a resulting veneer.

FIG. 2A is a representation of a magnified side view of a surface of veneer that was produced from an optimally preconditioned conditioned log.

FIG. 2B is a representation of a magnified surface of veneer that was produced from an over preconditioned log.

FIG. 2C is a representation of a magnified side view of a surface of veneer that was produced from an under preconditioned log.

FIG. 2D is a representation of a magnified view of a surface of veneer that was produced under conditions where the cutting knife edge was irregular, nicked, or otherwise damaged.

FIG. 2E is a representation of a magnified side view of a surface of veneer that was produced under conditions where the cutting knife edge was not held against the surface of the preconditioned log with a steady pressure.

FIG. 2F is a representation of a magnified side view of a surface of veneer that was produced under conditions where the cutting knife was dull.

FIG. 2G shows an ideal full veneer sheet stack and a typical full veneer sheet stack created using a prior art full veneer sheet stacking system.

FIG. 2H shows an ideal veneer strip stack and a typical veneer strip stack created using a prior art veneer strip stacking system.

FIG. 3A is simplified block diagram of a system for detecting surface irregularity levels in a full veneer sheet, veneer strip, and/or a partial veneer sheet using NIR technology in accordance with one embodiment.

FIG. 3B shows an end view of full veneer sheet, veneer strip, and/or a partial veneer sheet positioned in an NIR analysis station including three NIR cameras.

FIG. 4A is a representation of an NIR image of the surface of veneer that was produced from an optimally preconditioned conditioned log.

FIG. 4B is a representation of an NIR image of the surface of veneer that was produced from an over preconditioned log.

FIG. 4C is a representation of an NIR image of the surface of veneer that was produced from an under preconditioned log.

FIG. 4D is a representation of an NIR image of the surface of veneer that was produced under conditions where the cutting knife edge was irregular, nicked, or otherwise damaged.

FIG. 4E is a representation of an NIR image of the surface of veneer that was produced under conditions where the cutting knife edge was not held against the surface of the preconditioned log with a steady pressure.

FIG. 4F is a representation of an NIR image of the surface of veneer that was produced under conditions where the cutting knife was dull.

FIG. 5 is flow chart of a process for detecting surface irregularity levels in veneer using NIR technology in accordance with one embodiment.

FIG. 6 is simplified block diagram of a system for detecting surface irregularity levels in a veneer using NIR technology and machine learning methods in accordance with one embodiment.

FIG. 7 is flow chart of a process for detecting surface irregularity levels in veneer using NIR technology and machine learning methods in accordance with one embodiment.

FIG. 8 is simplified block diagram of a system for adjusting a preconditioning process of wood sources used to produce veneer based on a level of irregularity of a first surface of the veneer in accordance with one embodiment.

FIG. 9 is flow chart of a process for adjusting a preconditioning process of wood sources used to produce veneer based on a level of irregularity of a first surface of the veneer in accordance with one embodiment.

FIG. 10 is simplified block diagram of a system for adjusting processing parameters used to produce veneer from a wood source based on a level of irregularity of a first surface of the veneer in accordance with one embodiment.

FIG. 11 is flow chart of a process for adjusting processing parameters used to produce veneer from a wood source based on a level of irregularity of a first surface of the veneer in accordance with one embodiment.

FIG. 12 is a block diagram of a full veneer sheet grading and stacking system in accordance with one embodiment.

FIG. 13 is a block diagram of a veneer strip grading and stacking system in accordance with one embodiment.

FIGS. 14A, 14B, and 14C together are a process flow chart for a full veneer sheet, veneer strip, and partial veneer sheet grading and stacking system in accordance with one embodiment.

FIG. 15 is a timing diagram of a process for a full veneer sheet, veneer strip, and/or partial veneer sheet grading and stacking system in accordance with one embodiment.

FIG. 16 is an illustration of a selectively activated vacuum head in accordance with one embodiment.

FIG. 17 is local robotic veneer strip stacking cell in accordance with one embodiment.

FIGS. 18A through 18N show the use of the local robotic veneer strip stacking cell of FIG. 17 to create a layer of veneer strip in a veneer strip stack in accordance with one embodiment.

Common reference numerals are used throughout the figures and the detailed description to indicate like elements. One skilled in the art will readily recognize that the above figures are merely illustrative examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, or described below. Rather, these exemplary embodiments are provided to allow a complete disclosure that conveys the principles of the invention, as set forth in the claims, to those of skill in the art.

Embodiments of the present disclosure provide an effective and efficient technical solution to the technical problem of accurately and efficiently grading and stacking full veneer sheets, veneer strips, and/or partial veneer sheets. In one embodiment, irregularities on the surfaces of full veneer sheets, veneer strips, and/or partial veneer sheets are detected using Near InfraRed (NIR) technology, including Near InfraRed/Short Wave InfraRed (NIR/SWIR) cameras and detectors. In one embodiment, a grade is then assigned to the full veneer sheets, veneer strips, and/or partial veneer sheets based at least in part on the detected irregularities. In one embodiment, the full veneer sheets, veneer strips, and/or partial veneer sheets are then provided to an improved veneer stacking system that produces more consistently graded veneer stacks and safer veneer stacks, is less expensive to operate, and is far safer than currently available methods and systems for full veneer sheet, veneer strip, and partial veneer sheet stacking.

To this end, the disclosed embodiments utilize NIR analysis systems and NIR technology, including NIR cameras and detectors, to accurately identify surface irregularities and the specific locations of the irregularities in full veneer sheet, veneer strip, and/or a partial veneer sheet surface.

As discussed in more detail below, in one embodiment, this is accomplished by providing a NIR analysis system including one or more illumination sources and one or more NIR cameras. In addition, in some embodiments, visual cameras may be combined to further refine the NIR image based on physical features such as knots that impact veneer ribbon peel quality, or thermal cameras that show temperature variations in the material temperature that impacts veneer ribbon peel quality peel quality.

Once the irregularity levels over the first surface of the full veneer sheet, veneer strip, and/or a partial veneer sheet are identified, a grade is assigned to the full veneer sheet, veneer strip, and/or a partial veneer sheet based on the identified irregularity levels for the full veneer sheet, veneer strip, and/or a partial veneer sheet. In one embodiment, based, at least in part, on the grade assigned to the full veneer sheet, veneer strip, and/or a partial veneer sheet, one or more actions are taken with respect to the full veneer sheet, veneer strip, and/or a partial veneer sheet including, but not limited to, assigning the full veneer sheet, veneer strip, and/or a partial veneer sheet to a specific veneer stack associated with the grade assigned to the full veneer sheet, veneer strip, and/or a partial veneer sheet.

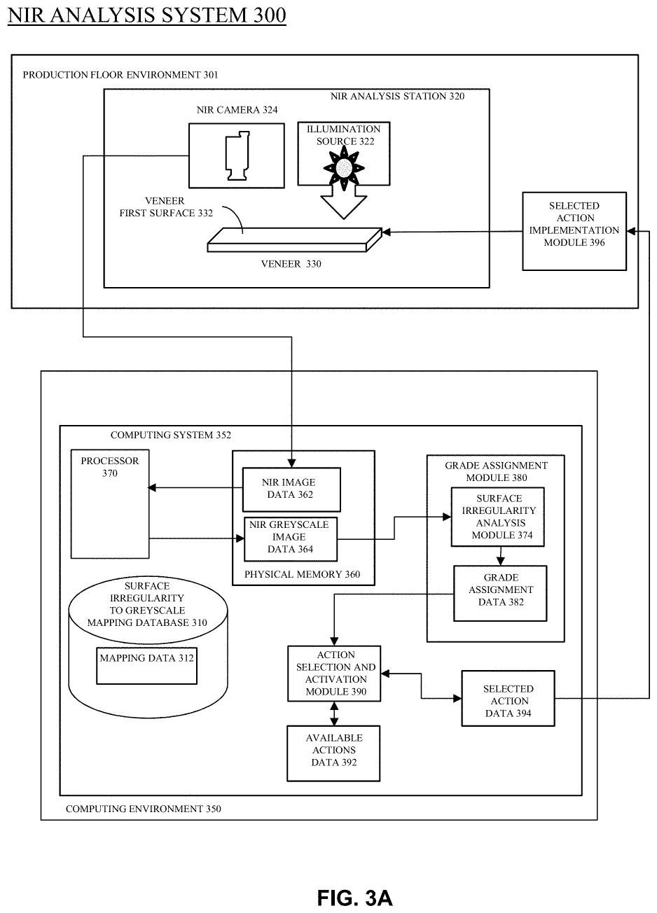

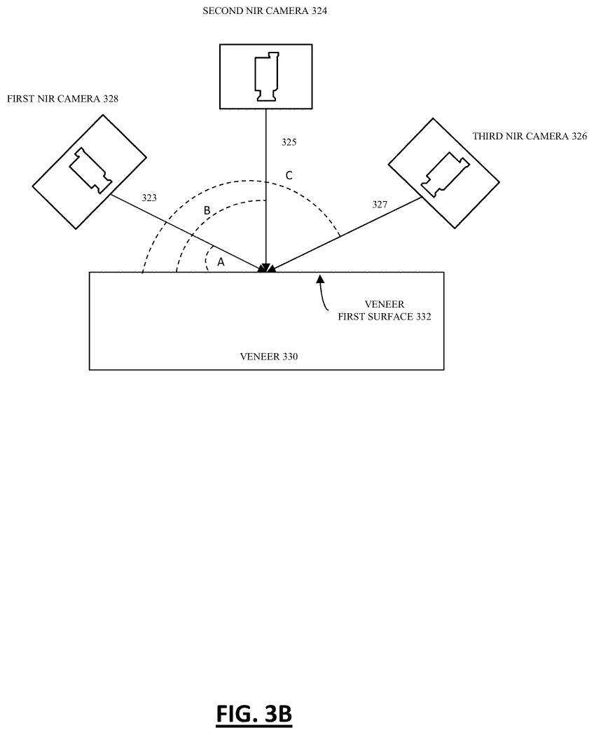

FIG. 3A is simplified block diagram of one embodiment of an NIR analysis system 300 for detecting surface irregularity levels in a full veneer sheet, veneer strip, and/or a partial veneer sheet using NIR technology in accordance with one embodiment.

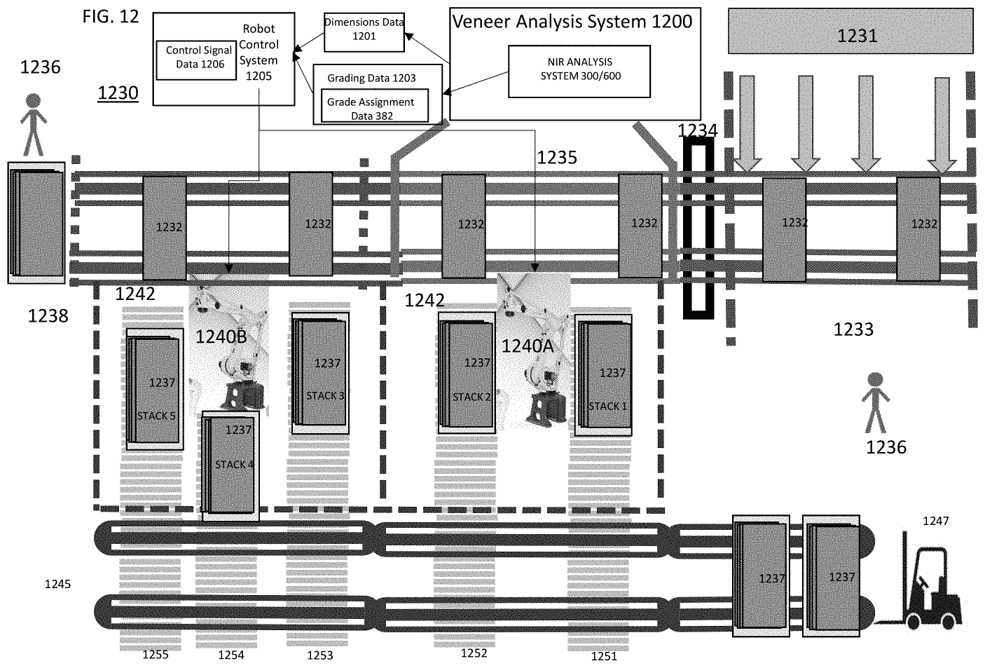

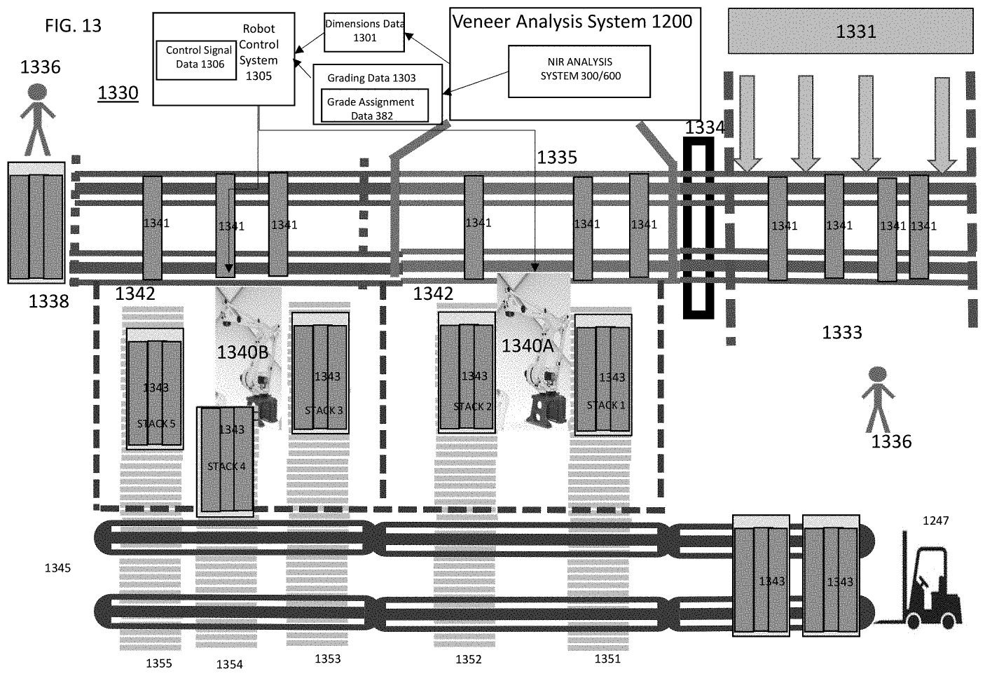

In one embodiment, NIR analysis system 300 includes a production floor environment 301, including an NIR analysis station 320 and a computing environment 350. As discussed in more detail below, in one embodiment, NIR analysis system 300 is part of a veneer analysis system, such as veneer analysis system 1200 of FIGS. 12 and 13

As seen in FIG. 3A, production floor environment 301 includes NIR analysis station 320 and selected action implementation module 396. As seen in FIG. 3A, NIR analysis station 320 includes one or more illumination sources, such as illumination source 322, positioned to illuminate a surface of a full veneer sheet, veneer strip, and/or a partial veneer sheet. In various embodiments, the one or more illumination sources, such as illumination source 322, can include one or more LED light sources. In other embodiments, the one or more illumination sources, such as illumination source 322, can include, but are not limited to, halogen, halogen and tungsten light sources, or any other light sources, as discussed herein, and/or as known in the art at the time of filing, and/or as developed after the time of filing.

As seen in FIG. 3A, NIR analysis station 320 also includes one or more NIR cameras, such as NIR camera 324, positioned to capture NIR image data 362 representing one or more NTR images of the illuminated surface of the full veneer sheet, veneer strip, and/or a partial veneer sheet. In one embodiment, the one or more NIR cameras, such as NIR camera 324, are adjustably positioned and adjustably focused to capture any desired one or more NIR images of the illuminated surface of the full veneer sheet, veneer strip, and/or a partial veneer sheet.

As used herein, the terms Near InfraRed (NIR) and Short-Wave InfraRed (SWIR) are used interchangeably to include wavelengths in the range of 750 nanometers (nm) to 3500 nm. In addition, all stated wave lengths herein are assumed to include values within 10% of the stated value. NIR wavelengths are in the range of 750 nanometers (nm) to 3500 nm which are much smaller that the visible wavelengths of 380 to 740 nm. Consequently, the use of NIR cameras as disclosed herein results in resolutions and accuracy that simply cannot be achieved using traditional visual irregularity detection systems.

As seen in FIG. 3A, and as discussed below, veneer 330, such as a full veneer sheet, veneer strip, and/or a partial veneer sheet, to be analyzed in the NIR analysis station 320 is positioned in NIR analysis station 320. In various embodiments, the veneer 330 can be any full veneer sheet, veneer strip, and/or a partial veneer sheet as discussed herein, and/or as known in the art at the time of filing and/or as becomes known after the time of filing.

In one embodiment, the veneer 330 to be analyzed is positioned such that a veneer first surface 332 of the veneer 330 to be analyzed is illuminated by the illumination source 322 and a sample portion of the veneer first surface 332 is within view and focus of NIR camera 324. In one embodiment, the veneer 330 is positioned in the NIR analysis station 320 by passing the veneer 330 through the NIR analysis station 320 on a conveyor system.

In various embodiments, the one or more NIR cameras, such as NIR camera 324, can be of any resolution desired. As noted above, when the one or more NIR cameras, such as NIR camera 324, are used to scan the veneer first surface 332 of veneer 330 for irregularities and create an NIR image data 362 of the veneer first surface 332, essentially each pixel generated by NIR camera 324 is a sample point. Consequently, the resolution and accuracy of the surface irregularity detection process is only limited by the number of pixels the NIR camera 324 has covering the field of view, e.g., the entire veneer first surface 332 of veneer 330. Consequently, in the case where NIR camera 324 is a 1.3 mega pixel camera, there are essentially 1,300,000 individual measurement points on the veneer first surface 332. In addition, NIR wavelengths are in the range of 750 nanometers (nm) to 3500 nm which are much smaller that the visible wavelengths of 380 to 740 nm. Consequently, using NIR cameras, such as NIR camera 324, results in resolutions and accuracy that simply cannot be achieved using traditional surface magnified visual image methods.

Therefore, using NIR cameras, such as NIR camera 324, NIR analysis system 300 is capable of detecting irregularities in a wide range of samples sizes ranging from of a traditional 2″×2″ square, to a full 4′×8′ sheet or panel surface, and, by using a series of NIR images spliced together, up to an 80′-120′ ribbon of material. This, in turn, allows the disclosed embodiments to be implemented without significantly slowing down the production process or increasing the cost of the finished full veneer sheet, veneer strip, and/or a partial veneer sheet.

As seen in FIG. 3A, computing environment 350 includes computing system 352. As seen in FIG. 3A, in one embodiment, computing system 352 includes surface irregularity to greyscale mapping database 310 containing mapping data 312 that maps surface irregularities to Near InfraRed (NIR) image greyscale values for one or more full veneer sheet, veneer strip, and/or partial veneer sheets.

Using NIR images, extremely granular differences in irregularity levels can be detected. In general, locations with different levels of irregularities absorb/reflect different amounts of NIR radiation at specific frequencies. In operation, when NIR radiation of a given frequency is applied to a veneer first surface 332 of veneer 330, more NIR energy is reflected from surfaces that are perpendicular the NIR camera lens. Consequently, locations having irregularities such that the surfaces are not perpendicular the NIR camera lens will appear darker, i.e., have a greater greyscale value.

When the NIR camera 324 takes an image of the veneer first surface 332, the NIR camera 324 picks up the NIR energy reflected off veneer first surface 332 at angles of about 90 degrees, i.e., that are reflected substantially perpendicular to veneer first surface 332. Consequently, when the NIR camera 324 takes an image of the veneer first surface 332, the areas of irregularities, which scatter NIR energy at various angles other than 90 degrees and therefore reflect less NIR energy at the desired angles of about 90 degrees, appear darker than less textured areas. In addition, the higher or more significant the irregularities that are present, the darker the area appears because less NIR energy is reflected at angles of about 90 degrees to be captured by the NIR camera 324.

Using this fact, NIR image data 362 captured by the NIR camera 324 can be processed into NIR greyscale image data 364. Greyscale images can be of varying resolution, or bit, types. A 16-bit integer grayscale image provides 65535 available tonal steps from 0 (black) to 65535 (white). A 32-bit integer grayscale image theoretically will provide 4,294,967,295 tonal steps from 0 (black) to 4294967295 (white). Converting an NIR image based on these numbers of greyscale tonal steps results in a margin of error of significantly less than 0.1%.

In some embodiments, two or more illumination sources, such as illumination source 322, are utilized, that are positioned a different angles with respect to veneer first surface 332. This allows different types and levels of irregularities to be detected. In addition, using two or more two or more illumination sources, such as illumination source 322, that are positioned at different angles means that different irregularities will have surfaces perpendicular to the camera lens and therefore will yield a 3-D effect when a composite NIR image is constructed.

Likewise, in some embodiments, two or more NIR cameras are utilized, such as NIR camera 324, that are operated at different NIR frequencies and/or that are positioned a different angles with respect to veneer first surface 332. This allows different types and levels of irregularities to be detected. In addition, using two or more NIR cameras, such as NIR camera 324, that are positioned at different angles means that different irregularities will have surfaces perpendicular to the camera lens and therefore will yield a 3-D effect when a composite NIR image is constructed.

FIG. 3B shows an end view of veneer 330 positioned in an NIR analysis station including three NIR cameras 328, 324, and 326. As seen in FIG. 3B, first NIR camera 328 is positioned such that line 323 from a lens of first NIR camera 328 is at an angle “A” with respect to veneer first surface 332. Similarly, second NIR camera 324 is positioned such that line 325 from a lens of second NIR camera 324 is at an angle “B” with respect to veneer first surface 332. Likewise, third NIR camera 326 is positioned such that line 327 from a lens of third NIR camera 326 is at an angle “C” with respect to veneer first surface 332.

In some embodiments, each of NIR cameras 328, 324, and 326 can be operated at different NIR frequencies and as seen in FIG. 3B, are positioned a different angles A, B, and C, respectively, with respect to veneer first surface 332. In one embodiment, angle A is 45 degrees, angle B is 90 degrees, and angle C is 135 degrees. As noted, the arrangement shown in FIG. 3B allows different types and levels of irregularities to be detected. In addition, using two or more NIR cameras, such as NIR cameras 328, 324, and 326, that are positioned a different angles means that different irregularities will have surfaces perpendicular to the camera lens and therefore will yield a 3-D-like effect when a composite NIR image is constructed.

As noted above, in some embodiments, two or more illumination sources, such as illumination source 322, are utilized, that are positioned a different angles with respect to veneer first surface 332. This allows different types and levels of irregularities to be detected. In addition, using two or more two or more illumination sources, such as illumination source 322, that are positioned at different angles means that different irregularities will have surfaces perpendicular to the camera lens and therefore will yield a 3-D effect when a composite NIR image is constructed.

Consequently, in some embodiments, in an arrangement similar to FIG. 3B, a first illumination source can positioned such that line from the first illumination source is at an angle “A” with respect to full veneer sheet, veneer strip, and/or a partial veneer sheet first surface, a second illumination source can positioned such that line from the second illumination source is at an angle “B” with respect to full veneer sheet, veneer strip, and/or a partial veneer sheet first surface, and a third illumination source can positioned such that line from the third illumination source is at an angle “C” with respect to full veneer sheet, veneer strip, and/or a partial veneer sheet first surface. As discussed above, in some embodiments, angles A, B, and C, respectively, with respect to full veneer sheet, veneer strip, and/or a partial veneer sheet first surface are all different and, in one very specific embodiment, angle A is 45 degrees, angle B is 90 degrees, and angle C is 135 degrees.

In addition, as discussed in the disclosed related applications, in some embodiments, visual cameras may be combined to further refine the NIR image based on physical features such as knots that impact veneer ribbon peel quality, or thermal cameras that show temperature variations in the material temperature that impacts veneer ribbon peel quality peel quality.

Returning to FIG. 3A, using the concepts discussed above, the mapping data 312 of surface irregularity to greyscale mapping database 310 is obtained through one or more empirical and/or manual processes.

For instance, in one embodiment, sample full veneer sheet, veneer strip, and/or partial veneer sheets that have been identified and associated with one or more production parameter values can be passed through NTR analysis station 320 and known production parameter NR images can be obtained for numerous sample full veneer sheet, veneer strip, and/or partial veneer sheets determined to be produced by known production parameters.

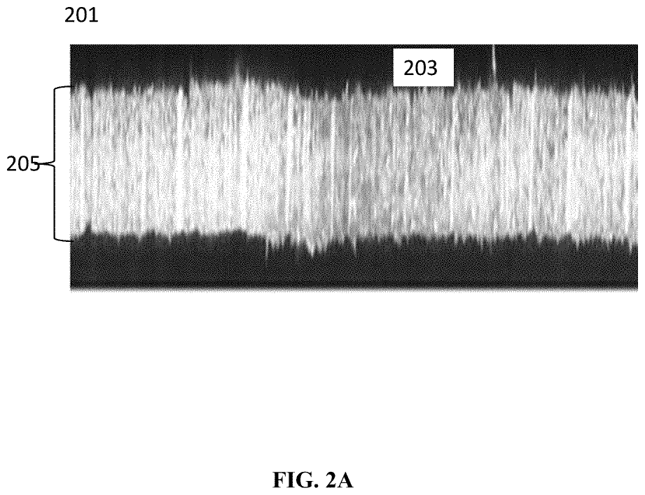

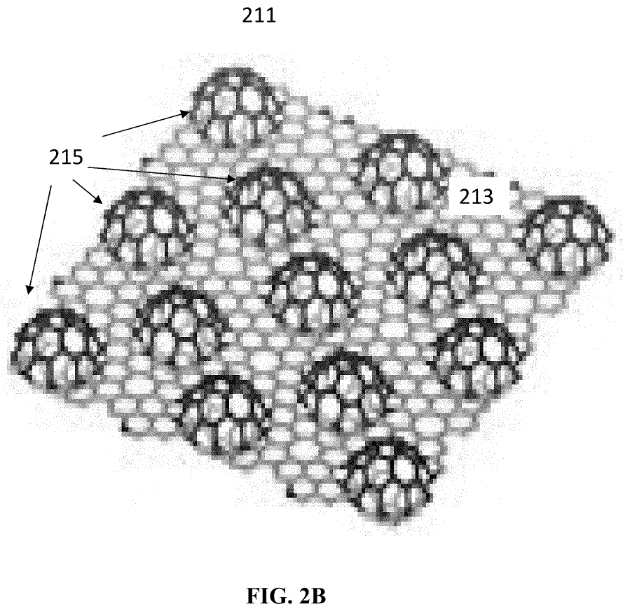

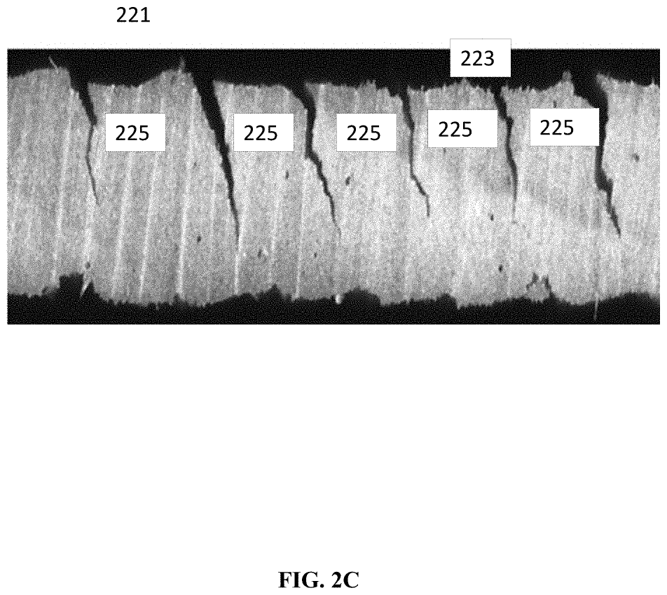

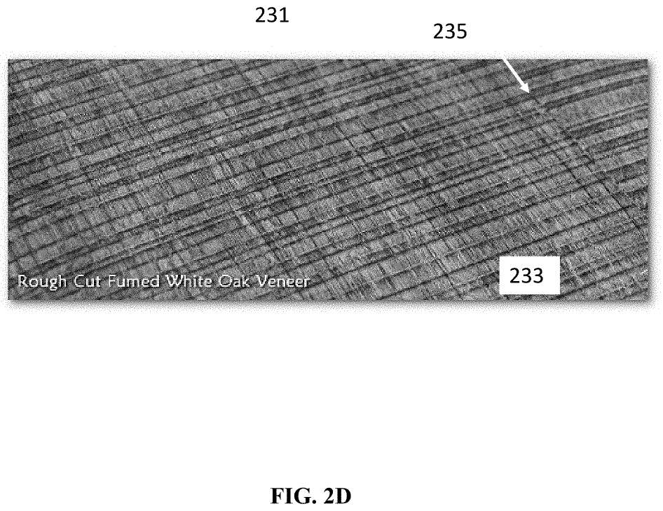

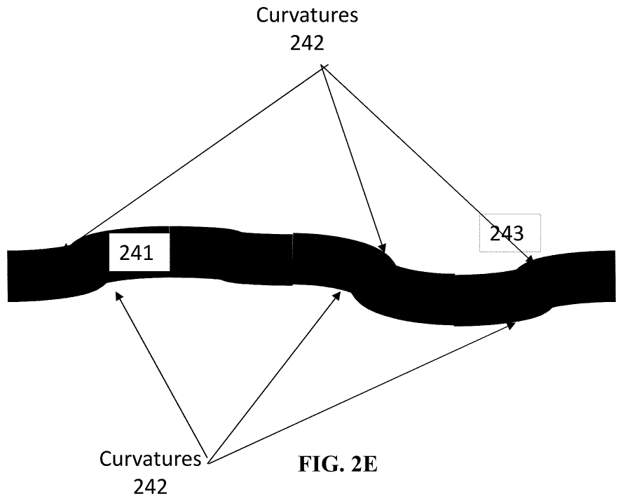

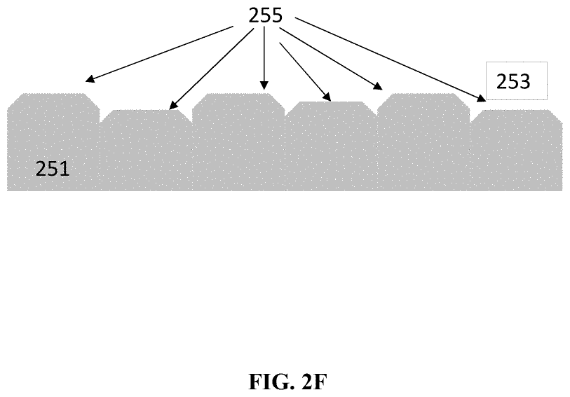

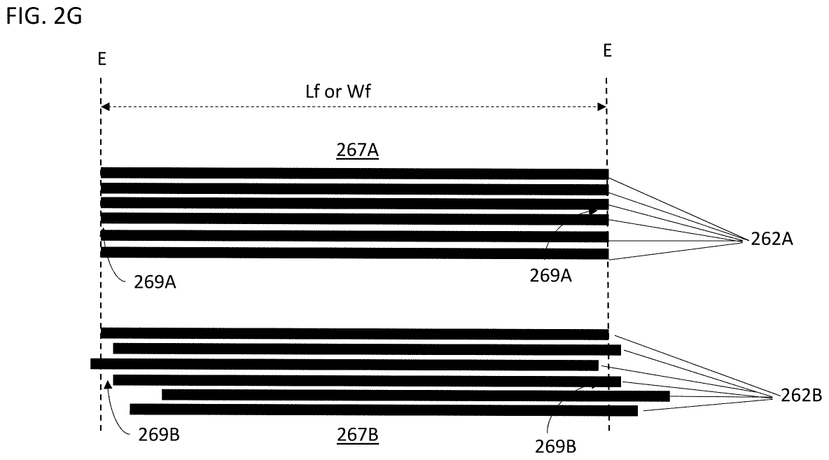

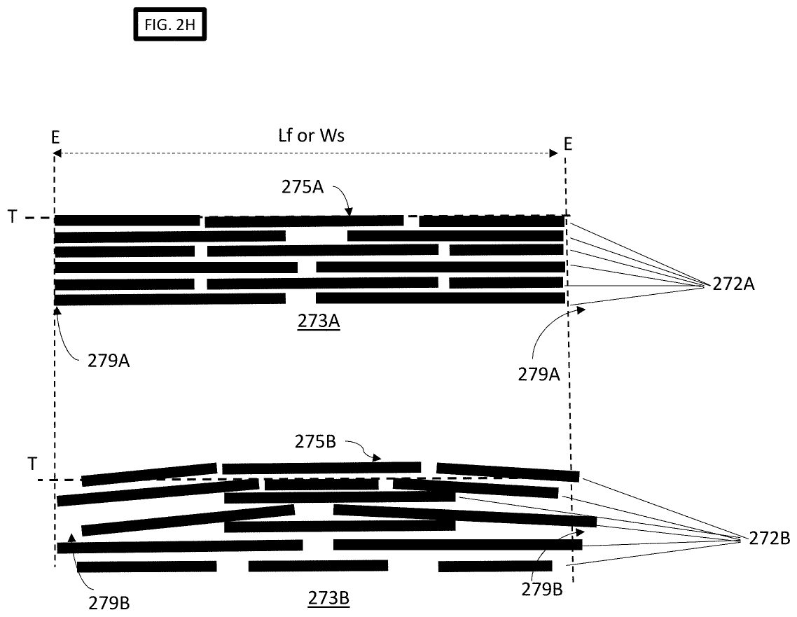

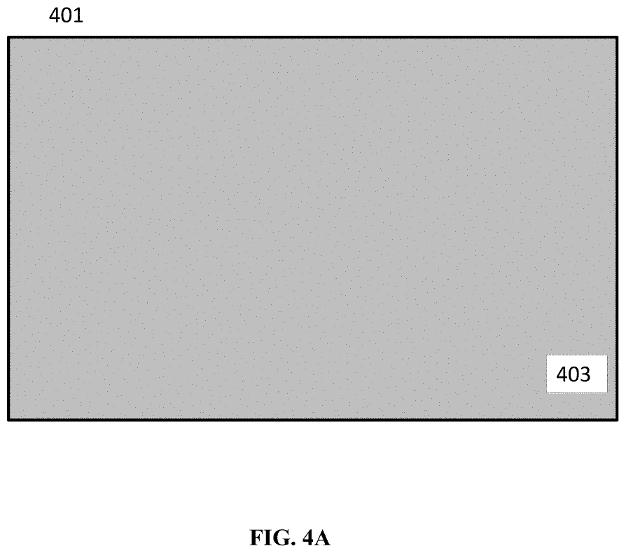

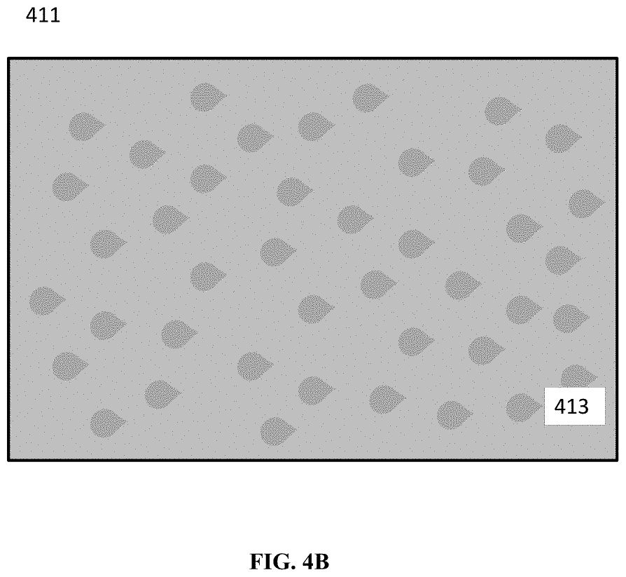

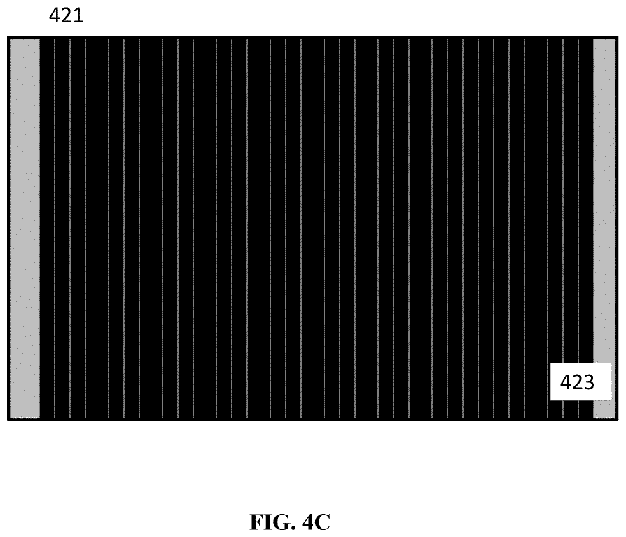

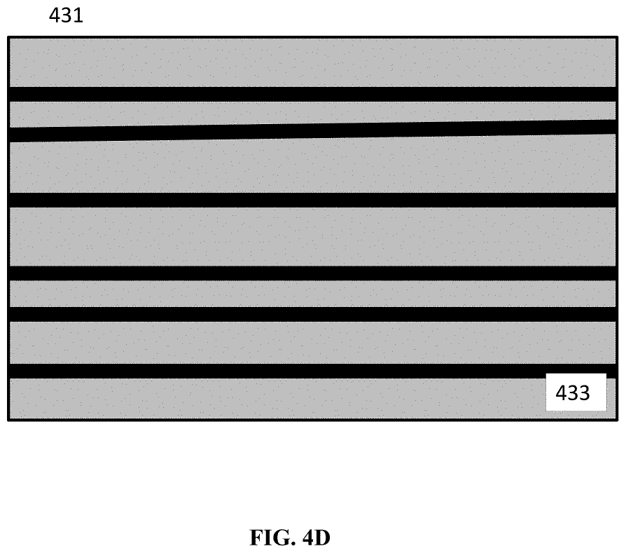

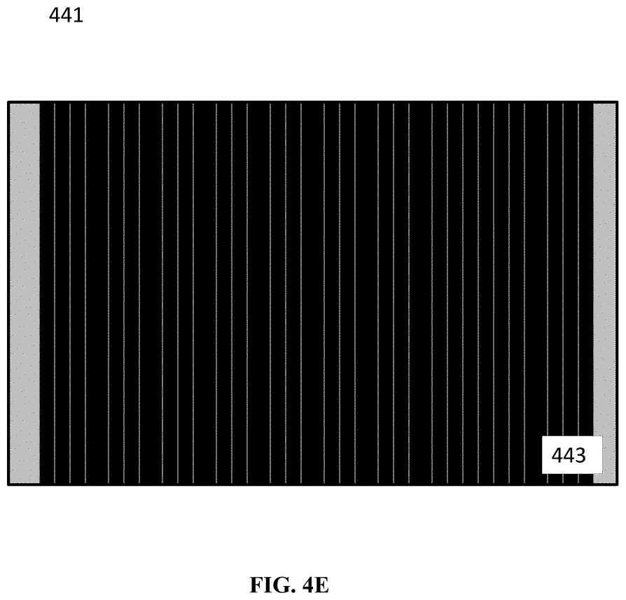

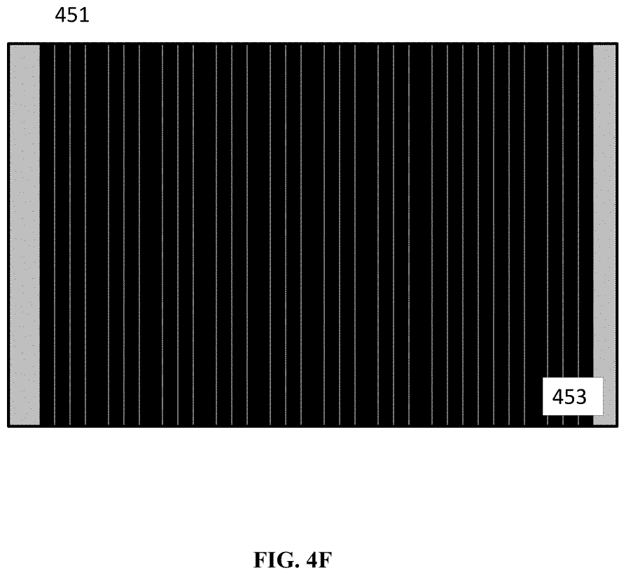

FIGS. 4A to 4F are illustrative examples of NIR images of surfaces of veneer produced under various optimal and non-optimal production parameters. In the specific examples of FIGS. 4A to 4F the NIR image illustrations of 4A, 4B, 4C, 4D, 4E and 4F, correlate to the magnified visual image illustrations of FIGS. 2A, 2B, 2C, 2D, 2E and 2F, respectively.

Consequently, FIG. 4A is a representation of an NIR image of the surface of a veneer ribbon, full veneer sheet, veneer strip, and/or a partial veneer sheet that was produced from an optimally preconditioned conditioned log, FIG. 4B is a representation of an NIR image of the surface of a veneer ribbon, full veneer sheet, veneer strip, and/or a partial veneer sheet that was produced from an over preconditioned log, FIG. 4C is a representation of an NIR image of the surface of a veneer ribbon, full veneer sheet, veneer strip, and/or a partial veneer sheet that was produced from an under preconditioned log, FIG. 4D is a representation of an NIR image of the surface of a veneer ribbon, full veneer sheet, veneer strip, and/or a partial veneer sheet that was produced under conditions where the cutting knife edge was irregular, nicked, or otherwise damaged, FIG. 4E is a representation of an NIR image of the surface of a veneer ribbon, full veneer sheet, veneer strip, and/or a partial veneer sheet that was produced under conditions where the cutting knife edge was not held against the surface of the preconditioned log with a steady pressure, and FIG. 4F is a representation of an NIR image of the surface of a veneer ribbon, full veneer sheet, veneer strip, and/or a partial veneer sheet that was produced under conditions where the cutting knife was dull.

Therefore, in the specific illustrative examples of FIGS. 2A and 4A, sample veneer ribbons, full veneer sheets, veneer strips, and/or partial veneer sheets determined empirically to be produced from optimally preconditioned wood sources, such as shown in FIG. 2A, can be passed through NIR analysis station 320 to generate known optimally preconditioned wood NIR images of surface 403 of veneer 401, as shown in FIG. 4A.

Similarly, in the specific illustrative examples of FIGS. 2B and 4B, sample veneer ribbon, full veneer sheet, veneer strip, and/or partial veneer sheets determined empirically to be produced from over preconditioned wood sources, such as shown in FIG. 2B, can be passed through NIR analysis station 320 to generate known over preconditioned wood NIR images of surface 413 of veneer 411, as shown in FIG. 4B.

Similarly, in the specific illustrative examples of FIGS. 2C and 4C, sample veneer ribbon, full veneer sheet, veneer strip, and/or partial veneer sheets determined empirically to be produced from under preconditioned wood sources, such as shown in FIG. 2C, can be passed through NIR analysis station 320 to generate known under preconditioned wood NIR images of surface 423 of veneer 421, as shown in FIG. 4C.

Likewise, in the specific illustrative examples of FIGS. 2D and 4D, sample veneer ribbon, full veneer sheet, veneer strip, and/or partial veneer sheets determined empirically to be produced under conditions where the cutting knife edge was irregular, nicked, or otherwise damaged, such as shown in FIG. 2D, can be passed through NIR analysis station 320 to generate known irregular cutting knife edge NIR images of surface 433 of veneer 431, as shown in FIG. 4D.

Likewise, in the specific illustrative examples of FIGS. 2E and 4E, sample veneer ribbon, full veneer sheet, veneer strip, and/or partial veneer sheets determined empirically to be produced under conditions where the cutting knife edge was not held against the surface of the preconditioned log with a steady pressure, such as shown in FIG. 2E, can be passed through NIR analysis station 320 to generate known irregular cutting knife pressure NIR images of surface 443 of veneer 441, as shown in FIG. 4E.

Similarly, in the specific illustrative examples of FIGS. 2F and 4F, sample veneer ribbon, full veneer sheet, veneer strip, and/or partial veneer sheets determined empirically to be produced under conditions where the cutting knife edge was dull, such as shown in FIG. 2F, can be passed through NIR analysis station 320 to generate known dull cutting knife NIR images of surface 453 of veneer 451, as shown in FIG. 4F.

This process is continued for multiple levels and types of surface irregularities and greyscale data for each irregularity increment is determined and correlated to the respective surface irregularities increment. In this way, mapping data 312 mapping each specific surface irregularities to specific greyscale values is generated for veneer ribbons, full veneer sheets, veneer strips, and/or partial veneer sheets. The process can then be repeated for different full veneer sheets, veneer strips, and/or partial veneer sheets, different types of wood, and under varying parameters and conditions. Consequently, the specific examples discussed herein are but illustrative examples and do not limit the scope of the invention as set forth in the claims below.

Returning the FIG. 3A, computing system 352 also includes physical memory 360. In one embodiment, the physical memory 360 includes NIR image data 362 representing one or more NIR images of the illuminated veneer first surface 332 of the veneer 330 captured using NIR camera 324.

As seen in FIG. 3A, in one embodiment, computing system 352 includes one or more processors 370 for processing the NIR image data representing one or more NIR images of the illuminated veneer first surface 332 of the veneer 330 to generate NIR greyscale image data 364 indicating different irregularity levels in the illuminated veneer first surface 332 of the veneer 330.

In one embodiment, processor 370 processes the NIR greyscale image data 364 using the mapping data 312 from surface irregularity to greyscale mapping database 310 to identify irregularity levels for the veneer first surface 332 of the veneer 330.

As seen in FIG. 3A, in one embodiment, computing system 352 includes a grade assignment module 380 for assigning a grade to the veneer 330 based on the identified irregularity levels for the veneer first surface 332. As seen in FIG. 3A, grade assignment module 380 includes surface irregularity analysis module 374 which, along with processor 370, processes the NIR greyscale image data 364 using the mapping data 312 from surface irregularity to greyscale mapping database 310 data to identify irregularity levels for the veneer first surface 332 of the veneer 330. As a result of the processing by surface irregularity analysis module 374 and processor 370, grade assignment data 382 is generated.

As seen in FIG. 3A, in one embodiment, grade assignment data 382 is provided to action selection and activation module 390 which selects an appropriate action of the actions represented in available actions data 392 based, at least in part on the grade indicated by grade assignment data 382. As seen in FIG. 3A, in one embodiment, the determined appropriate action is represented by selected action data 394.

As seen in FIG. 3A, in one embodiment, selected action data 394 is forwarded to an action activation module, such as selected action implementation module 396, in production floor environment 301 to initialize one or more actions with respect to the veneer 330 based, at least in part, on the grade represented by grade assignment data 382 and assigned to the veneer 330 by action selection and activation module 390. These actions can include assigning the veneer 330 to a specific veneer stack associated with the grade assigned to the veneer 330.

As discussed in more detail below, in some embodiments, the selected action indicated by selected action data 394 is to add veneer 330 to a specific veneer stack based, at least in part, on the grade represented by grade assignment data 382 and assigned to the veneer 330. In these embodiments, grade assignment data 382 is provided to action selection and activation module 390 which, in turn, forwards grade assignment data 382 to selected action implementation module 396. In one embodiment, selected action implementation module 396 then forwards grade assignment data 382 to a robot control system, such as robot control systems 1205 (FIG. 12) and/or 1305 (FIG. 13). As discussed in more detail below, in these embodiments, the robot control system then adds veneer 330 to a specific veneer stack based, at least in part, on the grade represented by grade assignment data 382 and assigned to the veneer 330.

In other embodiments, the one or more actions that can be taken represented in available actions data 392 can also include, but are not limited to: sorting veneer 330 into a bin or location based, at least in part, on the grade represented by grade assignment data 382 and assigned to the veneer 330; restricting the use of the veneer 330 based on the grade represented by grade assignment data 382 assigned to veneer 330; rejecting the veneer 330 based, at least in part, on the grade represented by grade assignment data 382 and assigned to the veneer 330; sending the veneer 330 back for further processing based, at least in part, on the grade represented by grade assignment data 382 and assigned to the veneer 330; adjusting one or more processing parameters of a production line based, at least in part, on the grade represented by grade assignment data 382 and assigned to the veneer 330 and one or more similarly graded similar full veneer sheet, veneer strip, and/or partial veneer sheets; adjusting one or more preconditioning parameters on a production line based, at least in part, on the grade represented by grade assignment data 382 and assigned to the veneer 330 and/or one or more similarly graded full veneer sheet, veneer strip, and/or partial veneer sheets; adjusting one or more full veneer sheet, veneer strip, and/or a partial veneer sheet cutting parameters on a production line based, at least in part, on the grade represented by grade assignment data 382 and assigned to the veneer 330 and/or one or more similarly graded full veneer sheet, veneer strip, and/or partial veneer sheets; and selecting a type and amount of glue used on a production line in production floor environment 301 based, at least in part, on the grade represented by grade assignment data 382 and assigned to the veneer 330 and/or the grades assigned other full veneer sheet, veneer strip, and/or partial veneer sheets.

Those of skill in the art will ready recognize that the specific illustrative examples of one embodiment of a production floor environment 301 and components shown in FIGS. 3A and 3B are but specific examples of numerous possible production environments and arrangement of physical components. Consequently, the specific illustrative example of embodiments of a production floor environment 301 and components shown in FIGS. 3A and 3B is not intended to limit the scope of the invention as set forth in the claims below.

Likewise, those of skill in the art will ready recognize that the specific illustrative examples of one embodiment of FIGS. 2A through 2F and corresponding FIGS. 4A through 4F are but specific examples of numerous possible images. Consequently, the specific illustrative examples of one embodiment shown in FIGS. 2A through 2F and corresponding FIGS. 4A through 4F are not intended to limit the scope of the invention as set forth in the claims below.

As a specific illustrative example of potential variations, in various embodiments, the NIR analysis station 320 can include one or more illumination sources 322 positioned to illuminate two or more surfaces of a full veneer sheet, veneer strip, and/or a partial veneer sheet and one or more NIR cameras 324 positioned to capture one or more NIR images of the two or more illuminated surfaces of the full veneer sheet, veneer strip, and/or a partial veneer sheet.

As a further specific illustrative example of variations possible, additional input data can be considered such as current ambient temperature and humidity. The combination of these parameters can be analyzed by an Artificial Intelligence/Machine Learning (AI/ML) algorithm to further refine the production parameters for overall process efficiency.

These and numerous other variations are possible and contemplated by the inventors to be within the scope of the invention as set forth in the claims below.

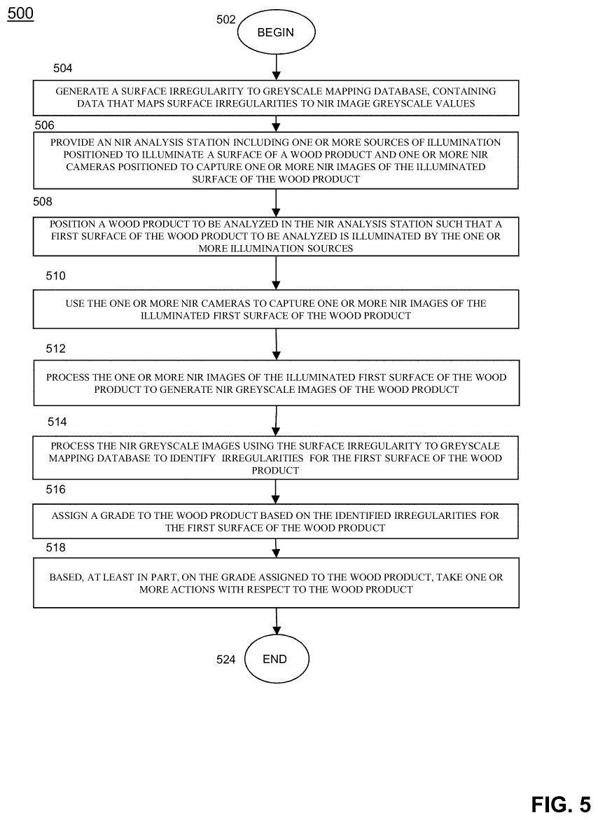

FIG. 5 is flow chart of a process 500 for detecting surface irregularity levels in a full veneer sheet, veneer strip, and/or a partial veneer sheet using NIR technology in accordance with one embodiment.

As seen in FIG. 5, process 500 begins at BEGIN operation 502 and then process proceeds to operation 504. In one embodiment, at operation 504 a surface irregularity level to greyscale mapping database is generated such as any database discussed above with respect to FIG. 3A, FIGS. 2A through 2F and corresponding FIGS. 4A through 4F. In one embodiment, the surface irregularity level to greyscale mapping database contains mapping data that maps surface irregularities level to Near InfraRed (NIR) image greyscale values for one or more full veneer sheet, veneer strip, and/or partial veneer sheets.

Once a surface irregularity level to greyscale mapping database is generated at operation 504, process flow proceeds to operation 506. At operation 506, an NIR analysis station is provided. In one embodiment, the NIR analysis station is substantially similar to any NIR analysis station discussed above with respect to FIGS. 3A and 3B. As discussed above, in one embodiment, the NIR analysis station includes one or more sources of illumination positioned to illuminate a surface of wood product such as a full veneer sheet, veneer strip, and/or a partial veneer sheet and one or more NIR cameras positioned to capture one or more NIR images of the illuminated surface of the full veneer sheet, veneer strip, and/or a partial veneer sheet.

Once an NIR analysis station is provided at operation 506, process flow proceeds to operation 508. In one embodiment, at operation 508, a wood product such as a full veneer sheet, veneer strip, and/or a partial veneer sheet to be analyzed is positioned in the NIR analysis station of operation 506 such that a first surface of the wood product such as a full veneer sheet, veneer strip, and/or a partial veneer sheet to be analyzed is illuminated by the one or more illumination sources using any of the methods and systems discussed above with respect to FIGS. 3A and 3B.

Once the wood product such as a full veneer sheet, veneer strip, and/or a partial veneer sheet to be analyzed is positioned in the NIR analysis station at 508, process flow proceeds to operation 510. In one embodiment, at operation 510 the one or more NIR cameras of NIR analysis station take one or more NIR images of the illuminated first surface of the wood product such as a full veneer sheet, veneer strip, and/or a partial veneer sheet using any of the methods and systems discussed above with respect to FIGS. 3A and 3B.

Once the one or more NIR cameras of NIR analysis station take one or more NIR images of the illuminated first surface of the wood product such as a full veneer sheet, veneer strip, and/or a partial veneer sheet at operation 510, process flow proceeds to operation 512.

In one embodiment, at operation 512, the one or more NIR images of the illuminated first surface of the wood product such as a full veneer sheet, veneer strip, and/or a partial veneer sheet of operation 510 are processed using any of the methods and systems discussed above with respect to FIGS. 3A and 3B, FIGS. 2A through 2F, and corresponding FIGS. 4A through 4F, to generate NIR greyscale images indicating irregularities in the illuminated first surface of the wood product such as a full veneer sheet, veneer strip, and/or a partial veneer sheet.

Once the one or more NIR images of the illuminated first surface of the wood product such as a full veneer sheet, veneer strip, and/or a partial veneer sheet are processed to generate NIR greyscale images indicating different irregularities in the illuminated first surface of the wood product such as a full veneer sheet, veneer strip, and/or a partial veneer sheet at operation 512, process flow proceeds to operation 514.

In one embodiment, at operation 514, the NIR greyscale images are processed using the surface irregularity level to greyscale mapping database to identify irregularity levels for the first surface of the wood product such as a full veneer sheet, veneer strip, and/or a partial veneer sheet by any of the methods and systems discussed above with respect to FIGS. 3A and 3B, FIGS. 2A through 2F, and corresponding FIGS. 4A through 4F.

Once the NIR greyscale images are processed using the surface irregularity level to greyscale mapping database to identify irregularity levels for the first surface of the wood product such as a full veneer sheet, veneer strip, and/or a partial veneer sheet at operation 514, process flow proceeds operation 516.

In one embodiment, at operation 516 a grade is assigned to the wood product such as a full veneer sheet, veneer strip, and/or a partial veneer sheet based on the identified irregularity levels for the wood product such as first surface of the full veneer sheet, veneer strip, and/or a partial veneer sheet using any of the methods and systems discussed above with respect to FIGS. 3A and 3B, FIGS. 2A through 2F, and corresponding FIGS. 4A through 4F.

Once a grade is assigned to the wood product such as a full veneer sheet, veneer strip, and/or a partial veneer sheet based on the identified irregularity levels for the first surface of the wood product such as a full veneer sheet, veneer strip, and/or a partial veneer sheet at operation 516, process flow proceeds to operation 518. In one embodiment, at operation 518, based at least in part, on the grade assigned to the wood product such as a full veneer sheet, veneer strip, and/or a partial veneer sheet, one or more actions are taken with respect to the wood product such as a full veneer sheet, veneer strip, and/or a partial veneer sheet including, but not limited to, assigning the full veneer sheet, veneer strip, and/or a partial veneer sheet to a specific veneer stack associated with the grade assigned to the full veneer sheet, veneer strip, and/or a partial veneer sheet and/or any of the actions discussed above with respect to the methods and systems discussed above with respect to FIGS. 3A and 3B.

As discussed in more detail below, in some embodiments, the selected action of operation 518 is to add the full veneer sheet, veneer strip, and/or a partial veneer sheet to a specific veneer stack based, at least in part, on the grade assigned to the full veneer sheet, veneer strip, and/or a partial veneer sheet. In these embodiments, grade assignment data is provided to a robot control system, such as robot control systems 1205 (FIG. 12) and/or 1305 (FIG. 13). As discussed in more detail below, in these embodiments, the robot control system then adds the full veneer sheet, veneer strip, and/or a partial veneer sheet veneer to a specific veneer stack based, at least in part, on the grade assigned to the full veneer sheet, veneer strip, and/or a partial veneer sheet.

Once one or more actions with respect to the wood product such as a full veneer sheet, veneer strip, and/or a partial veneer sheet at operation 518, process flow proceeds to END operation 524 where process 500 is exited to await new samples and/or data.

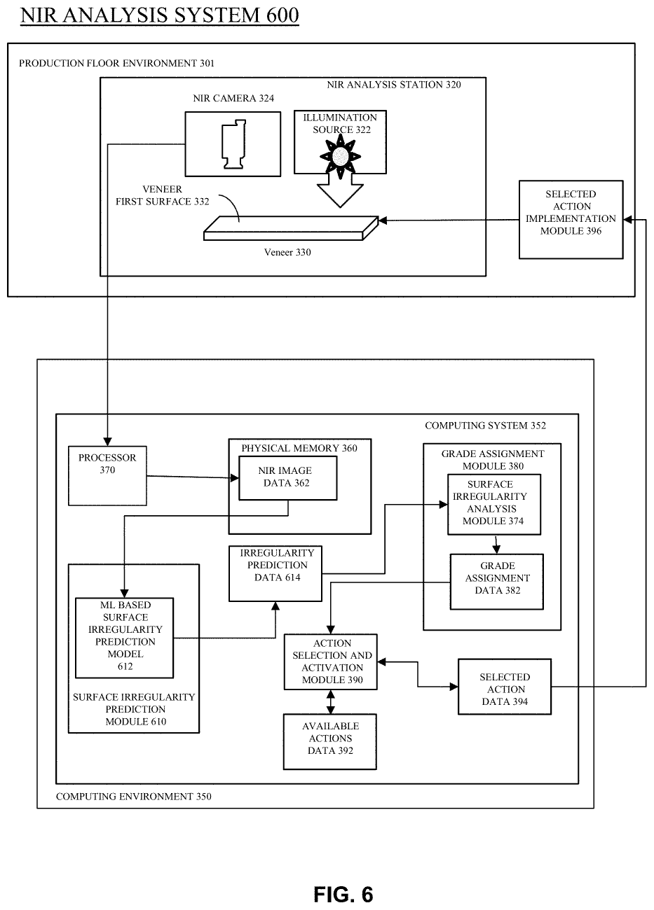

FIG. 6 is simplified block diagram of one embodiment of a NIR analysis system 600 for detecting surface irregularity levels in a full veneer sheet, veneer strip, and/or a partial veneer sheet using NIR technology and machine learning methods in accordance with one embodiment.

In one embodiment, system 600, like NIR analysis system 300 of FIGS. 3A and 3B, includes production floor environment 301 and a computing environment 350. As discussed in more detail below, in one embodiment, NIR analysis system 600 is part of a veneer analysis system, such as veneer analysis system 1200 of FIGS. 12 and 13

As seen in FIG. 6, like NIR analysis system 300 of FIGS. 3A and 3B, production floor environment 301 includes NIR analysis station 320 and selected action implementation module 396. As seen in FIG. 6, NIR analysis station 320 includes one or more illumination sources, such as illumination source 322, positioned to illuminate a veneer first surface 332 of veneer 330. In various embodiments, the one or more sources of illumination, such as illumination source 322, can include one or more LED light sources. In other embodiments, the one or more illumination sources, such as illumination source 322, can include, but are not limited to, halogen or halogen and tungsten light sources, or any other light sources, as discussed herein, and/or as known in the art at the time of filing, and/or as developed after the time of filing.

As seen in FIG. 6, NIR analysis station 320 also includes one or more NIR cameras, such as NIR camera 324, positioned to capture NIR image data 362 representing one or more NTR images of the illuminated veneer first surface 332 of the veneer 330. In one embodiment, one or more NIR cameras, such as NIR camera 324, are adjustably positioned and adjustably focused to capture one or more NTR images of the illuminated veneer first surface 332 of the veneer 330.

As seen in FIG. 6, the veneer 330 to be analyzed in the NIR analysis station 320 is positioned in NIR analysis station 320. In various embodiments, the veneer 330 can be any full veneer sheet, veneer strip, and/or a partial veneer sheet as discussed herein, and/or as known in the art at the time of filing, and/or as becomes known after the time of filing. In one embodiment, the veneer 330 to be analyzed is a veneer sheet.

In one embodiment, the veneer 330 to be analyzed is positioned such that the veneer first surface 332 of the veneer 330 to be analyzed is illuminated by the illumination source 322 and is within view and focus of NIR camera 324. In one embodiment, the veneer 330 is positioned in the NIR analysis station 320 by passing the veneer 330 through the NIR analysis station 320 on a conveyor system (not shown).

As seen in FIG. 6, like NIR analysis system 300 of FIGS. 3A and 3B, computing environment 350 includes computing system 352. However, unlike NIR analysis system 300 of FIGS. 3A and 3B, in one embodiment, computing system 352 of system 600 does not include surface irregularity to greyscale mapping database 310 but instead includes surface irregularity prediction module 610.

In one embodiment, surface irregularity prediction module 610 includes one or more trained Machine Learning (ML) based surface irregularity prediction models, such as Machine Learning (ML) based surface irregularity prediction model 612. In various embodiments the one or more trained machine learning based surface irregularity prediction models, such as machine learning based surface irregularity prediction model 612, are trained using NIR image data for one or more full veneer sheet, veneer strip, and/or partial veneer sheets and corresponding determined irregularity levels for the one or more full veneer sheet, veneer strip, and/or partial veneer sheets.

Various types of machine learning based models are well known in the art. Consequently, the one or more trained machine learning based surface irregularity prediction models, such as machine learning based surface irregularity prediction model 612, can be any machine learning based model type or use any machine learning based algorithm, as discussed herein, and/or as known in the art at the time of filing, and/or as becomes known or available after the time of filing.

Specific illustrative examples of machine learning based model types and machine learning based algorithms that can be used for, or with, the one or more trained machine learning based surface irregularity prediction models of surface irregularity prediction module 610, such as machine learning based surface irregularity prediction model 612, include, but are not limited to: supervised machine learning-based models; semi-supervised machine learning-based models; unsupervised machine learning-based models; classification machine learning-based models; logistical regression machine learning-based models; neural network machine learning-based models; and deep learning machine learning-based models.

In various embodiments, and largely depending on the machine-learning based models used, the NIR image data for one or more full veneer sheet, veneer strip, and/or partial veneer sheets, including in some cases various environmental and production parameters, and corresponding determined irregularity levels for the one or more full veneer sheet, veneer strip, and/or partial veneer sheets can be processed using various methods known in the machine learning arts to identify elements and vectorize the NIR image data and/or corresponding determined irregularity levels data. As a specific illustrative example, in a case where the machine learning based model is a supervised model, the NIR image data can be analyzed and processed into elements found to be indicative of a full veneer sheet, veneer strip, and/or a partial veneer sheet irregularity levels, product failures, and product performance. Then these elements are used to create vectors in multidimensional space which are, in turn, used as input data for one or more machine learning models. The correlated determined irregularity levels, product failures, and product performance data for each NIR image data vector is then used as a label for the resulting vector. This process is repeated for multiple, often millions, of correlated pairs of NIR image data vector and determined irregularity levels, product failures, and product performance data with the result being one or more trained machine learning based surface irregularity prediction models.

Then when new NIR image data is obtained, this new NIR image data is also vectorized and the new NIR image vector data is provided as input data to the one or more trained machine learning based surface irregularity prediction models. The new NIR image vector data is then processed to find a distance between the new NIR image vector and previously labeled NTR image vectors, whose associated irregularity level data is known. Based on a calculated distance between the new NIR image vector data and the previously labeled NTR image vector data, a probability that the new NTR image vector data correlates to an irregularity level, product failure, or product performance associated with the previously labeled NTR image vector data can be calculated. This results in a probability score for the full veneer sheet, veneer strip, and/or a partial veneer sheet being analyzed.

Those of skill in the art will readily recognize that there are many different types of machine learning based models known in the art. Consequently, the specific illustrative example of a specific supervised machine learning based model discussed above is not limiting.

As seen in FIG. 6, computing system 352 also includes physical memory 360. In one embodiment, the physical memory 360 includes NIR image data 362 representing one or more NIR images of the illuminated veneer first surface 332 of the veneer 330 captured using NIR camera 324.

As seen in FIG. 6, in one embodiment, computing system 352 includes one or more processors, such as processor 370, for generating the NIR image data 362 representing one or more NIR images of the illuminated veneer first surface 332 of the veneer 330 from NIR camera 324.

In one embodiment, NIR image data 362 is provided to surface irregularity prediction module 610 where it is processed/vectorized and provided to machine learning based irregularity level prediction model 612.

Machine learning based irregularity level prediction model 612 then processes the vectorized NIR image data 362 as discussed above and generates irregularity prediction data 614 for the veneer 330.

As seen in FIG. 6, irregularity prediction data 614 for the veneer 330 is then provided to grade assignment module 380. As discussed above, grade assignment module 380 then assigns a grade to the veneer 330 based on irregularity prediction data 614 for the veneer 330.

As seen in FIG. 6, grade assignment module 380 includes surface irregularity analysis module 374 which, along with processor 370, processes irregularity prediction data 614 for the veneer 330 and generates grade assignment data 382 based on this processing

As seen in FIG. 6, in one embodiment, grade assignment data 382 is provided to action selection and activation module 390 which selects an appropriate action of the actions represented in available actions data 392 based, at least in part on the grade indicated by grade assignment data 382. As seen in FIG. 6, in one embodiment, the determined appropriate action is represented by selected action data 394.

As seen in FIG. 6, in one embodiment, selected action data 394 is forwarded to an action activation module, such as selected action implementation module 396 in production floor environment 301, to initialize one or more actions with respect to the veneer 330 based, at least in part, on the grade represented by grade assignment data 382 and assigned to the veneer 330 by action selection and activation module 390 including, but not limited to, assigning the veneer 330 to a specific veneer stack associated with the grade assigned to the full veneer sheet, veneer strip, and/or a partial veneer sheet.

As discussed in more detail below, in some embodiments, the selected action indicated by selected action data 394 is to add veneer 330 to a specific veneer stack based, at least in part, on the grade represented by grade assignment data 382 and assigned to the veneer 330. In these embodiments, grade assignment data 382 is provided to action selection and activation module 390 which, in turn, forwards grade assignment data 382 to selected action implementation module 396. In one embodiment, selected action implementation module 396 then forwards grade assignment data 382 to a robot control system, such as robot control systems 1205 (FIG. 12) and/or 1305 (FIG. 13). As discussed in more detail below, in these embodiments, the robot control system then adds veneer 330 to a specific veneer stack based, at least in part, on the grade represented by grade assignment data 382 and assigned to the veneer 330.

In one embodiment, one or more actions that can be taken represented in available actions data 392 can also include, but are not limited to: sorting veneer 330 into a bin or location based, at least in part, on the grade represented by grade assignment data 382 and assigned to the veneer 330; restricting the use of the veneer 330 based, at least in part, on the grade represented by grade assignment data 382 and assigned to the veneer 330; rejecting the veneer 330 based, at least in part, on the grade represented by grade assignment data 382 and assigned to the veneer 330; sending the veneer 330 back for further processing based, at least in part, on the grade represented by grade assignment data 382 and assigned to the veneer 330; adjusting one or more processing parameters of a production line based, at least in part, on the grade represented by grade assignment data 382 and assigned to the veneer 330 and one or more similarly graded similar full veneer sheet, veneer strip, and/or partial veneer sheets; adjusting one or more preconditioning parameters on a production line based, at least in part, on the grade represented by grade assignment data 382 and assigned to the veneer 330 and/or one or more similarly graded full veneer sheet, veneer strip, and/or partial veneer sheets; adjusting one or more full veneer sheet, veneer strip, and/or a partial veneer sheet cutting parameters on a production line based, at least in part, on the grade represented by grade assignment data 382 and assigned to the veneer 330 and/or one or more similarly graded full veneer sheet, veneer strip, and/or partial veneer sheets; and selecting a type and amount of glue used on a production line in production floor environment 301 based, at least in part, on the grade represented by grade assignment data 382 and assigned to the veneer 330 and/or the grades assigned other full veneer sheet, veneer strip, and/or partial veneer sheets.

Those of skill in the art will ready recognize that the specific illustrative example of one embodiment of FIG. 6 is but one example of numerous possible production environments and arrangement of components. Consequently, the specific illustrative example of one embodiment shown in FIG. 6 is not intended to limit the scope of the invention as set forth in the claims below.

As a specific illustrative example of possible variations, in some embodiments, the NIR analysis station 320 can include one or more illumination sources 322 positioned to illuminate two or more surfaces of a full veneer sheet, veneer strip, and/or a partial veneer sheet and one or more NIR cameras 324 positioned to capture one or more NIR images of the two or more illuminated surfaces of the full veneer sheet, veneer strip, and/or a partial veneer sheet.

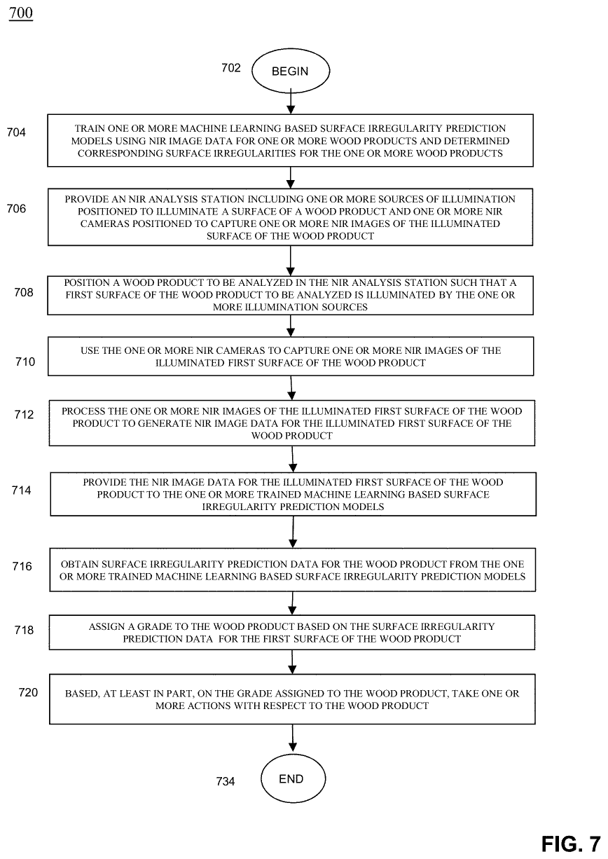

FIG. 7 is flow chart of a process 700 for detecting surface irregularity levels in wood product such as a full veneer sheet, veneer strip, and/or a partial veneer sheet using NIR technology and machine learning methods in accordance with one embodiment.

As seen in FIG. 7, process 700 begins at BEGIN operation 702 and then process proceeds to operation 704. In one embodiment, at operation 704 one or more machine learning based surface irregularity prediction models are trained using NIR image data for one or more full veneer sheet, veneer strip, and/or partial veneer sheets and determined corresponding irregularity levels and/or failures for the one or more full veneer sheets, veneer strips, and/or partial veneer sheets by any of the systems or methods discussed above with respect to FIG. 6.

In one embodiment, once one or more machine learning based surface irregularity prediction models are trained using NIR image data for one or more full veneer sheet, veneer strip, and/or partial veneer sheets and determined corresponding irregularity levels for the one or more full veneer sheet, veneer strip, and/or partial veneer sheets at operation 704, process flow proceeds to operation 706.

At operation 706, an NIR analysis station is provided. In one embodiment, the NIR analysis station is substantially similar to any NIR analysis station discussed above with respect to FIGS. 3A, 3B, and 6, FIGS. 2A through 2F, and corresponding FIGS. 4A through 4F. As discussed above, in one embodiment, the NIR analysis station includes one or more sources of illumination positioned to illuminate a surface of a full veneer sheet, veneer strip, and/or a partial veneer sheet and one or more NIR cameras positioned to capture one or more NIR images of the illuminated surface of the full veneer sheet, veneer strip, and/or a partial veneer sheet.

Once an NIR analysis station is provided at operation 706, process flow proceeds to operation 708. In one embodiment, at operation 708, a full veneer sheet, veneer strip, and/or a partial veneer sheet to be analyzed is positioned in the NIR analysis station of operation 706 such that a first surface of the full veneer sheet, veneer strip, and/or a partial veneer sheet to be analyzed is illuminated by the one or more illumination sources using any of the methods and systems discussed above with respect to FIGS. 3A, 3B, and 6, FIGS. 2A through 2F, and corresponding FIGS. 4A through 4F.

Once the full veneer sheet, veneer strip, and/or a partial veneer sheet to be analyzed is positioned in the NIR analysis station at 708, process flow proceeds to operation 710. In one embodiment, at operation 710 the one or more NIR cameras of NIR analysis station take one or more NIR images of the illuminated first surface of the full veneer sheet, veneer strip, and/or a partial veneer sheet using any of the methods and systems discussed above with respect to FIGS. 3A, 3B, and 6, FIGS. 2A through 2F, and corresponding FIGS. 4A through 4F.

Once the one or more NIR cameras of NIR analysis station take one or more NTR images of the illuminated first surface of the full veneer sheet, veneer strip, and/or a partial veneer sheet at operation 710, process flow proceeds to operation 712.

In one embodiment, at operation 712, the one or more NTR images of the illuminated first surface of the full veneer sheet, veneer strip, and/or a partial veneer sheet of operation 710 are processed, using any of the methods and systems discussed above with respect to FIGS. 3A, 3B, and 6, FIGS. 2A through 2F, and corresponding FIGS. 4A through 4F, to generate NTR image data such as any NTR image data discussed above with respect to FIGS. 3A, 3B, and 6, FIGS. 2A through 2F, and corresponding FIGS. 4A through 4F.

Once the one or more NIR images of the illuminated first surface of the full veneer sheet, veneer strip, and/or a partial veneer sheet are processed to generate NIR image data at operation 712, process flow proceeds to operation 714.

In one embodiment, at operation 714 the NR image data for the illuminated first surface of the full veneer sheet, veneer strip, and/or a partial veneer sheet of operation 712 is processed and provided to the one or more trained machine learning based surface irregularity prediction models using any of the methods and systems discussed above with respect to FIGS. 3A, 3B, and 6, FIGS. 2A through 2F, and corresponding FIGS. 4A through 4F.

Once the NIR image data for the illuminated first surface of the full veneer sheet, veneer strip, and/or a partial veneer sheet is processed and provided to the one or more trained machine learning based surface irregularity prediction models at operation 714, process flow proceeds to process 716.

In one embodiment, at operation 716 the one or more trained machine learning based surface irregularity prediction models generate irregularity prediction data for the full veneer sheet, veneer strip, and/or a partial veneer sheet using any of the methods and systems discussed above with respect to FIG. 6.

Once irregularity prediction data for the full veneer sheet, veneer strip, and/or a partial veneer sheet is obtained from the one or more trained machine learning based surface irregularity prediction models at operation 716, process flow proceeds to operation 718.

In one embodiment, at operation 718, a grade is assigned to the full veneer sheet, veneer strip, and/or a partial veneer sheet based on the surface irregularity prediction data for the full veneer sheet, veneer strip, and/or a partial veneer sheet at operation 716 using any of the methods and systems discussed above with respect to FIGS. 3A, 3B, and 6.

Once a grade is assigned to the full veneer sheet, veneer strip, and/or a partial veneer sheet based on the surface irregularity prediction data for the full veneer sheet, veneer strip, and/or a partial veneer sheet at operation 718, process flow proceeds to operation 720. In one embodiment, at operation 720, based, at least in part, on the grade assigned to the full veneer sheet, veneer strip, and/or a partial veneer sheet, one or more actions are taken with respect to the full veneer sheet, veneer strip, and/or a partial veneer sheet including any of the actions discussed above with respect to the methods and systems discussed above with respect to FIGS. 3A, 3B, and 6.

As discussed in more detail below, in some embodiments, the selected action is to add the full veneer sheet, veneer strip, and/or a partial veneer sheet to a specific veneer stack based, at least in part, on the grade assigned to the full veneer sheet, veneer strip, and/or a partial veneer sheet. In these embodiments, grade assignment data is provided to a robot control system, such as robot control systems 1205 (FIG. 12) and/or 1305 (FIG. 13). As discussed in more detail below, in these embodiments, the robot control system then adds the full veneer sheet, veneer strip, and/or a partial veneer sheet veneer to a specific veneer stack based, at least in part, on the grade assigned to the full veneer sheet, veneer strip, and/or a partial veneer sheet.

Once one or more actions with respect to the full veneer sheet, veneer strip, and/or a partial veneer sheet at operation 720, process flow proceeds to END operation 734 where process 700 is exited to await new samples and/or data.

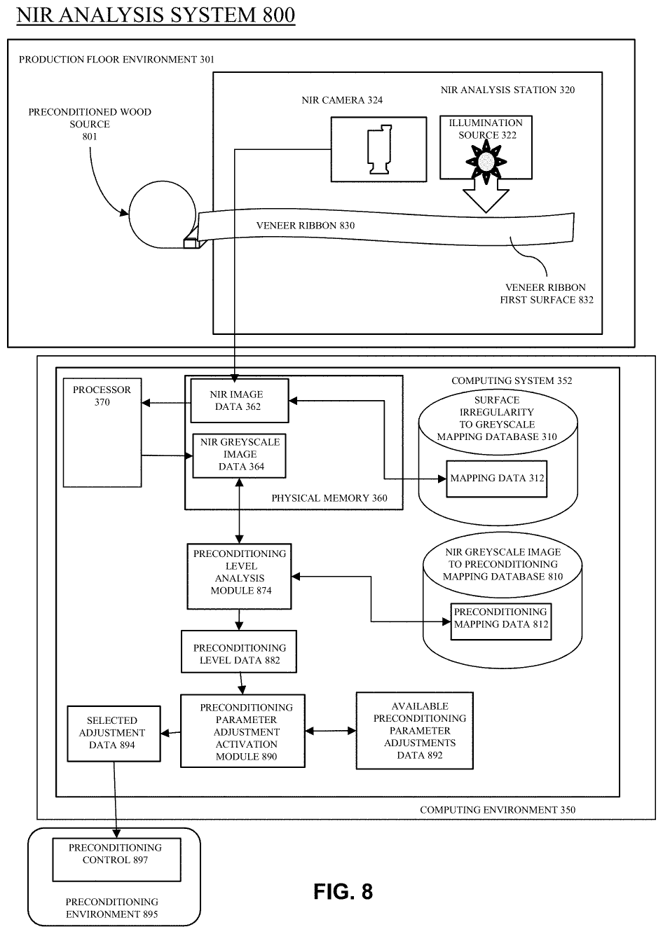

FIG. 8 is simplified block diagram of one embodiment of an NIR analysis system 800 for adjusting a preconditioning process of wood sources used to produce full veneer sheet, veneer strip, and/or partial veneer sheets based on NIR imagery of a first surface of the full veneer sheet, veneer strip, and/or partial veneer sheets in accordance with one embodiment.

As with NIR analysis system 300 discussed above with respect to FIG. 3A, in one embodiment, system 800 includes production floor environment 301 and computing environment 350. As seen in FIG. 8, production floor environment 301 includes NIR analysis station 320. As seen in FIG. 8, NIR analysis station 320 includes one or more illumination sources, such as illumination source 322, positioned to illuminate a surface of a veneer ribbon 830. In various embodiments, the one or more illumination sources, such as illumination source 322, can include one or more LED light sources. In other embodiments, the one or more illumination sources, such as illumination source 322, can include, but are not limited to, halogen, halogen and tungsten light sources, or any other light sources, as discussed herein, and/or as known in the art at the time of filing, and/or as developed after the time of filing.

As with NIR analysis system 300 discussed above with respect to FIG. 3A, in FIG. 8, NIR analysis station 320 also includes one or more NIR cameras, such as NIR camera 324, positioned to capture NIR image data 362 representing one or more NIR images of the illuminated veneer ribbon 830. In one embodiment, the one or more NIR cameras, such as NIR camera 324, are adjustably positioned and adjustably focused to capture any desired one or more NIR images of the illuminated surface of the veneer ribbon 830.

As seen in FIG. 8, and as discussed below the veneer ribbon 830 to be analyzed in the NIR analysis station 320 is positioned in NIR analysis station 320. In the specific illustrative example of FIG. 8, the veneer ribbon 830 is a veneer ribbon 830 rotary cut from preconditioned wood source 801, such as a preconditioned peeler log.

In one embodiment, the veneer ribbon 830 to be analyzed is positioned such that a veneer ribbon first surface 832 of the veneer ribbon 830 to be analyzed is illuminated by the illumination source 322 and the sample portion or entire veneer ribbon first surface 832 is within view and focus of NIR camera 324. In one embodiment, the veneer ribbon 830 is positioned in the NIR analysis station 320 by passing the veneer ribbon 830 through the NIR analysis station 320 on a conveyor system.

In various embodiments, the one or more NIR cameras, such as NIR camera 324, can be of any resolution desired. As noted above, when the one or more NIR cameras, such as NIR camera 324, are used to scan the veneer ribbon first surface 832 of a veneer ribbon 830 for irregularities and create an NIR image data 362 of the veneer ribbon first surface 832, essentially each pixel generated by NIR camera 324 is a sample point. Consequently, the resolution and accuracy of the surface irregularity detection process is only limited by the number of pixels the NIR camera 324 has covering the field of view, e.g., the entire veneer ribbon first surface 832 of veneer ribbon 830. Consequently, in the case where NIR camera 324 is a 1.3 mega pixel camera, there are essentially 1,300,000 individual measurement points on the veneer ribbon first surface 832. In addition, NIR wavelengths are in the range of 750 nanometers (nm) to 3500 nm which are much smaller that the visible wavelengths of 380 to 740 nm. Consequently, using NIR cameras, such as NIR camera 324, results in resolutions and accuracy that simply cannot be achieved using traditional surface magnified visual image methods.

Therefore, using NIR cameras, such as NIR camera 324, system 800 is capable of detecting irregularities in a wide range of samples sizes ranging from of a traditional 2″×2″ square, to a full 4′×8′ sheet or panel surface, and, by using a series of NIR images spliced together, up to an 80′-120′ ribbon of material. This, in turn, allows the disclosed embodiments to be implemented without significantly slowing down the production process or increasing the cost of the finished full veneer sheet, veneer strip, and/or a partial veneer sheet.

As seen in FIG. 8, computing environment 350 includes computing system 352. As seen in FIG. 8, in one embodiment, computing system 352 includes surface irregularity to greyscale mapping database 310 containing mapping data 312 that maps surface irregularities to Near InfraRed (NIR) image greyscale values for veneer.

As discussed in some detail above with respect to FIG. 3A, using NIR images, extremely granular differences in irregularity levels can be detected. In general, locations with different levels of irregularities absorb/reflect different amounts of NIR radiation at specific frequencies. In operation, when NIR radiation of a given frequency is applied to a veneer ribbon first surface 832 of veneer ribbon 830, more NIR energy is reflected from surfaces that are perpendicular the NIR camera lens. Consequently, at locations having irregularities such that the surfaces are not perpendicular the NIR camera lens will appear darker, i.e., have a greater greyscale value.

When the NIR camera 324 takes an image of the veneer ribbon first surface 832, the NIR camera 324 picks up the NIR energy reflected off veneer ribbon first surface 832 at approximately 90 degrees. Consequently, when the NIR camera 324 takes an image of the veneer ribbon first surface 832, the areas of irregularities, which scatter more NIR energy at angles other than 90 degrees and therefore reflect less NIR energy, appear darker than dry areas. In addition, the higher or more significant the irregularities that are present, the darker the area appears because less NIR energy is reflected to be captured by the NIR camera 324.

Using this fact, NIR image data 362 captured by the NIR camera 324 can be processed into NIR greyscale image data 364. Greyscale images can be of varying resolution, or bit, types. A 16-bit integer grayscale image provides 65535 available tonal steps from 0 (black) to 65535 (white). A 32-bit integer grayscale image theoretically will provide 4,294,967,295 tonal steps from 0 (black) to 4294967295 (white). Converting an NIR image based on these number of greyscale tonal steps results in a margin of error of significantly less than 0.1%.

In some embodiments, two or more NIR cameras are utilized, such as NIR camera 324, that are operated at different NTR frequencies and/or that are positioned a different angles with respect to veneer ribbon first surface 832. This allows different types and levels of irregularities to be detected. In addition, using two or more NIR cameras, such as NIR camera 324, that are positioned at different angles means that different irregularities will have surfaces perpendicular to the camera lens and therefore will yield a 3-D effect when a composite NTR image is constructed. A more detailed discussion of a one example of a multi-NIR camera system is discussed above with respect to FIG. 3B.

Returning to FIG. 8, and using the concepts discussed above, the mapping data 312 of surface irregularity to greyscale mapping database 310 is obtained through one or more empirical and/or manual processes, as discussed above with respect to FIG. 3A.

As discussed above, FIGS. 4A to 4F are illustrative examples of NR images of surfaces of veneer produced under various optimal and non-optimal production parameters. In the specific examples of FIGS. 4A to 4F the NIR image illustrations of 4A, 4B, 4C, 4D, 4E and 4F, correlate to the magnified visual image illustrations of FIGS. 2A, 2B, 2C, 2D, 2E and 2F, respectively.

Returning the FIG. 8, computing system 352 also includes NIR greyscale image to preconditioning mapping database. In one embodiment, NIR greyscale image to preconditioning mapping database 810 include preconditioning mapping data 812 that maps NIR greyscale images to particular preconditioning parameters and issues based on known data obtained from known condition greyscale images, such as images 4A, 4B, and 4C.

Computing system 352 also includes physical memory 360. In one embodiment, the physical memory 360 includes NIR image data 362 representing one or more NIR images of the illuminated veneer ribbon first surface 832 of the veneer ribbon 830 captured using NIR camera 324. Physical memory 360 also includes NIR greyscale image data 364. In one embodiment, computing system 352 includes one or more processors 370 for processing the NIR image data representing one or more NIR images of the illuminated veneer ribbon first surface 832 of the veneer ribbon 830 to generate NIR greyscale image data 364 indicating different irregularity levels in the illuminated veneer ribbon first surface 832 of the veneer ribbon 830.

In one embodiment, processor 370 processes the NIR greyscale image data 364 using the mapping data 312 from surface irregularity to greyscale mapping database 310 to identify irregularity levels for the veneer ribbon first surface 832 of the veneer ribbon 830.

As seen in FIG. 8, in one embodiment, computing system 352 includes a preconditioning level analysis module 874 which analyzes preconditioning mapping data 812 and NIR greyscale image data 364 to determine a preconditioning parameter level represented by preconditioning level data 882. In various embodiments, preconditioning level data 882 determines which, if any, preconditioning parameters must be readjusted to adjust the preconditioning levels of subsequent wood sources.

Available preconditioning parameter adjustments data 892 includes data representing the available precondition adjustments such as, adjusting of chemical composition of the caustic water mix by adding or subtracting chemical or changing chemical; adjusting the temperature of the caustic water mix; or adjusting the soak time for preconditioned wood source 801, such as logs, in the vats of caustic water mix. The determined preconditioning parameter adjustment is then represented by preconditioning level data 882.

In some embodiments, preconditioning level analysis module 874 includes one or more machine learning based models such as any machine learning based models discussed herein, and/or as known in the art at the time of filing, and/or as become known/available after the time of filing.

For instance, based on the analysis of NIR greyscale image data 364 and preconditioning mapping data 812, preconditioning level analysis module 874 may determine a probability that the chemical used, or amount of chemical used in the preconditioning vat soak needs to be adjusted. Likewise, based on the analysis of NIR greyscale image data 364 and preconditioning mapping data 812, preconditioning level analysis module 874 may determine that the preconditioning vat soak time needs to be adjusted. Similarly, based on the analysis of NIR greyscale image data 364 and preconditioning mapping data 812, preconditioning level analysis module 874 may determine that the preconditioning temperature needs to be adjusted. In some cases, based on the analysis of NIR greyscale image data 364 and preconditioning mapping data 812, preconditioning level analysis module 874 may determine any combination, or all, of these preconditioning parameters, or other preconditioning parameters, need to be adjusted.

In various embodiments, the adjustments determined to be necessary by preconditioning level analysis module 874 are then represented by preconditioning level data 882 which is used to adjust the preconditioning parameters for subsequent wood sources. Once generated by preconditioning level analysis module 874, preconditioning level data 882 is provided to preconditioning parameter adjustment activation module 890 which generates selected adjustment data 894.

In various embodiments, selected adjustment data is then transferred to preconditioning control 897 in preconditioning environment 895 where the adjustments determined to be necessary by preconditioning level analysis module 874 are implemented. These can include one or more of: adjusting of chemical composition of the caustic water mix by adding or subtracting chemical or changing chemical; adjusting the temperature of the caustic water mix; or adjusting the soak time for preconditioned wood source 801, such as logs, in the vats of caustic water mix.

Using system 800 the preconditioning process so critical to veneer ribbon 830 production is adjusted dynamically using feedback based on actual veneer ribbon, full veneer sheet, veneer strip, and/or a partial veneer sheet NIR surface image analysis. Consequently, using system 800, finding the best combination of chemical composition of the caustic water mix, temperature of the caustic water mix, and soak time for the logs in the vats of caustic water mix is more accurately determined based on empirical and relative real-time data. As a result, accurate adjustments can be made to minimize wasted product and maximize product value.

Those of skill in the art will ready recognize that the specific illustrative examples of one embodiment of a production floor environment 301 and components shown in FIG. 8 are but specific examples of numerous possible production environments and arrangement of physical components. Consequently, the specific illustrative example of an embodiment of a production floor environment 301 and components shown in FIG. 8 is not intended to limit the scope of the invention as set forth in the claims below.

As a specific illustrative example of potential variations, in various embodiments, the NIR analysis station 320 can include one or more illumination sources 322 positioned to illuminate two or more surfaces of a full veneer sheet, veneer strip, and/or a partial veneer sheet and one or more NIR cameras 324 positioned to capture one or more NIR images of the two or more illuminated surfaces of the veneer ribbon 830.

As a further specific illustrative example of variations possible, additional input data can be considered such as current ambient temperature and humidity. The combination of these parameters can be analyzed by an AI/ML algorithm to further refine the production parameters for overall process efficiency.

These and numerous other variations are possible and contemplated by the inventors to be within the scope of the invention as set forth in the claims below.

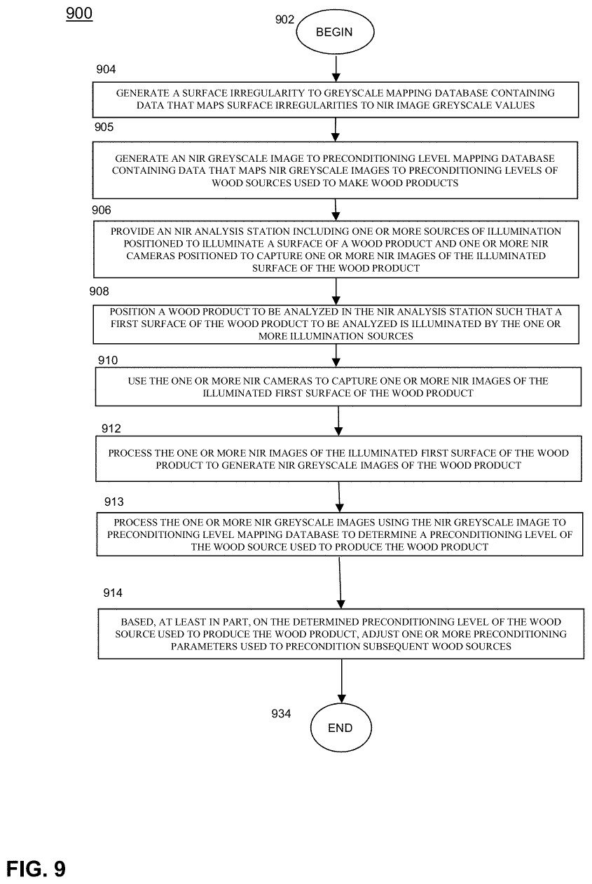

FIG. 9 is flow chart of a process 900 for adjusting a preconditioning process of wood sources used to produce veneer based on a level of irregularity of a first surface of the veneer in accordance with one embodiment.

As seen in FIG. 9, process 900 begins at BEGIN operation 902 and then process proceeds to operation 904. In one embodiment, at operation 904 a surface irregularity level to greyscale mapping database is generated such as any database discussed above with respect to FIG. 3A, FIG. 8, FIGS. 2A through 2C, and corresponding FIGS. 4A through 4C. In one embodiment, the surface irregularity level to greyscale mapping database contains mapping data that maps surface irregularities to Near InfraRed (NIR) image greyscale values for one or more veneer.

Once a surface irregularity level to greyscale mapping database is generated at operation 904, process flow proceeds to operation 905. In one embodiment, at operation 905 an NIR greyscale image to preconditioning level mapping database is generated using any of the methods and systems discussed above with respect to FIG. 8.

Once an NIR greyscale image to preconditioning level mapping database is generated at operation 905, process flow proceeds to operation 906. At operation 906, an NIR analysis station is provided. In one embodiment, the NIR analysis station is substantially similar to any NIR analysis station discussed above with respect to FIGS. 3A, 3B, and 8. As discussed above, in one embodiment, the NIR analysis station includes one or more sources of illumination positioned to illuminate a surface of the veneer and one or more NIR cameras positioned to capture one or more NIR images of the illuminated surface of the veneer.

Once an NIR analysis station is provided at operation 906, process flow proceeds to operation 908. In one embodiment, at operation 908, the veneer to be analyzed is positioned in the NIR analysis station of operation 906 such that a first surface of the veneer to be analyzed is illuminated by the one or more illumination sources using any of the methods and systems discussed above with respect to FIG. 3A, FIG. 8, FIGS. 2A through 2C, and corresponding FIGS. 4A through 4C.

Once the veneer to be analyzed is positioned in the NIR analysis station at 908, process flow proceeds to operation 910. In one embodiment, at operation 910 the one or more NIR cameras of NIR analysis station take one or more NIR images of the illuminated first surface of the veneer using any of the methods and systems discussed above with respect to FIGS. 3A, 3B and 8.

Once the one or more NIR cameras of NIR analysis station take one or more NIR images of the illuminated first surface of the veneer at operation 910, process flow proceeds to operation 912.

In one embodiment, at operation 912, the one or more NIR images of the illuminated first surface of the veneer of operation 910 are processed using any of the methods and systems discussed above with respect to FIGS. 3A, 3B, FIG. 8, FIGS. 2A through 2C, and corresponding FIGS. 4A through 4C, to generate NIR greyscale images indicating different irregularity levels in the illuminated first surface of the veneer.

Once the one or more NIR images of the illuminated first surface of the full veneer sheet, veneer strip, and/or a partial veneer sheet are processed to generate NIR greyscale images indicating different irregularity levels in the illuminated first surface of the veneer at operation 912, process flow proceeds to operation 913.

In one embodiment, at operation 913, the NIR greyscale images are processed using NIR greyscale image to preconditioning level mapping database to determine a preconditioning level and preconditioning parameter adjustments using any of the methods and systems discussed above with respect to FIGS. 3A and 3B, FIG. 8, FIGS. 2A through 2C, and corresponding FIGS. 4A through 4C.

Once the NIR greyscale images are processed using NIR greyscale image to preconditioning level mapping database to determine a preconditioning level and preconditioning parameter adjustments at operation 913, process flow proceeds to operation 914.

In one embodiment, at operation 914 any preconditioning parameters that it is determined must be adjusted are adjusted via one or more actions such as any actions discussed above with respect to FIG. 8.

Once any preconditioning parameters that it is determined must be adjusted are adjusted at operation 914, process flow proceeds to END operation 934 where process 900 is exited to await new samples and/or data.

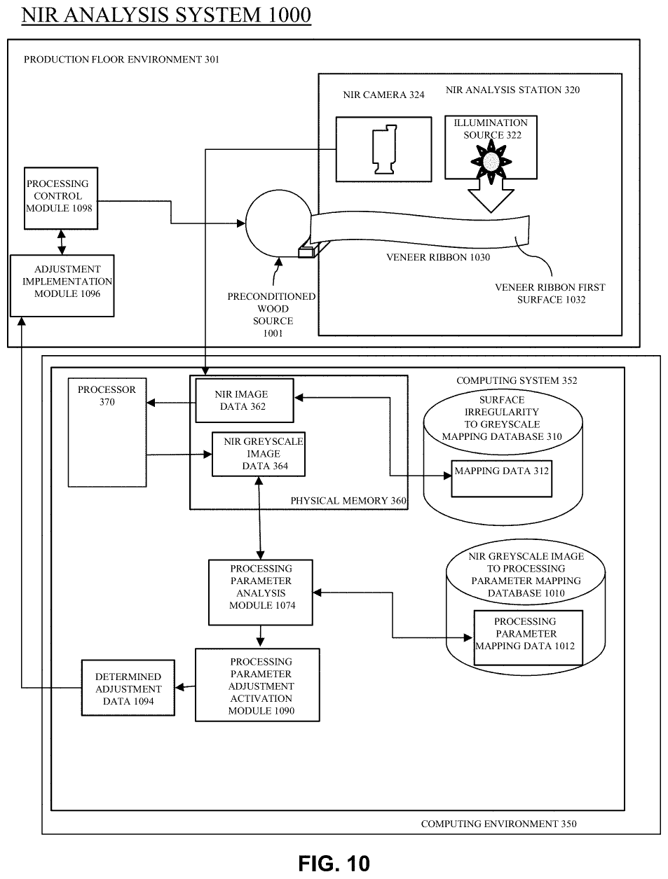

FIG. 10 is simplified block diagram of a system 1000 for adjusting processing parameters used to produce a veneer ribbon 1030 from a wood source based on a NIR images of a surface of the veneer ribbon 1030 in accordance with one embodiment.

As with NIR analysis system 300 discussed above with respect to FIG. 3A, in one embodiment, NIR analysis system 1000 includes production floor environment 301 and computing environment 350. As seen in FIG. 10, production floor environment 301 includes NIR analysis station 320. As seen in FIG. 10, NIR analysis station 320 includes one or more illumination sources, such as illumination source 322, positioned to illuminate a surface of veneer ribbon 1030. In various embodiments, the one or more illumination sources, such as illumination source 322, can include one or more LED light sources. In other embodiments, the one or more illumination sources, such as illumination source 322, can include, but are not limited to, halogen, halogen and tungsten light sources, or any other light sources, as discussed herein, and/or as known in the art at the time of filing, and/or as developed after the time of filing.

As with NIR analysis system 300 discussed above with respect to FIG. 3A, in FIG. 10, NIR analysis station 320 also includes one or more NIR cameras, such as NIR camera 324, positioned to capture NIR image data 362 representing one or more NIR images of the illuminated surface of the veneer ribbon 1030. In one embodiment, the one or more NIR cameras, such as NIR camera 324, are adjustably positioned and adjustably focused to capture any desired one or more NIR images of the illuminated surface of the veneer ribbon 1030.

As seen in FIG. 10, and as discussed below, the veneer to be analyzed in the NIR analysis station 320 is positioned in NIR analysis station 320. In the specific illustrative example of FIG. 10, veneer ribbon 1030 is rotary cut from preconditioned wood source 1001, such as a preconditioned peeler log.

In one embodiment, the veneer ribbon 1030 to be analyzed is positioned such that a veneer ribbon first surface 1032 of the veneer ribbon 1030 to be analyzed is illuminated by the illumination source 322 and a sample portion of veneer ribbon first surface 1032 is within view and focus of NIR camera 324. In one embodiment, the veneer ribbon 1030 is positioned in the NIR analysis station 320 by passing the veneer ribbon 1030 through the NIR analysis station 320 on a conveyor system.

In various embodiments, the one or more NIR cameras, such as NIR camera 324, can be of any resolution desired. As noted above, when the one or more NIR cameras, such as NIR camera 324, are used to scan the veneer ribbon first surface 1032 of a veneer ribbon 1030 for irregularities and create an NIR image data 362 of the veneer ribbon first surface 1032, essentially each pixel generated by NIR camera 324 is a sample point. Consequently, the resolution and accuracy of the surface irregularity detection process is only limited by the number of pixels the NIR camera 324 has covering the field of view, e.g., the entire veneer ribbon first surface 1032 of veneer ribbon 1030. Consequently, in the case where NIR camera 324 is a 1.3 mega pixel camera, there are essentially 1,300,000 individual measurement points on the veneer ribbon first surface 1032. In addition, NIR wavelengths are in the range of 750 nanometers (nm) to 3500 nm which are much smaller that the visible wavelengths of 380 to 740 nm. Consequently, using NIR cameras, such as NIR camera 324, results in resolutions and accuracy that simply cannot be achieved using traditional surface magnified visual image methods.

Therefore, using NIR cameras, such as NIR camera 324, system 1000 is capable of detecting irregularities in a wide range of samples sizes ranging from of a traditional 2″×2″ square, to a full 4′×10′ sheet or panel surface, and, by using a series of NIR images spliced together, up to a 100′-120′ ribbon of material. This, in turn, allows the disclosed embodiments to be implemented without significantly slowing down the production process or increasing the cost of the finished full veneer sheet, veneer strip, and/or a partial veneer sheet.

As seen in FIG. 10, in this specific illustrative example, production floor environment 301 also includes adjustment implementation module 1096 for making relative real time adjustment to processing parameters for preconditioned wood source 1001 to generate veneer ribbon 1030 and processing control module 1098 which controls the processing of preconditioned wood source 1001 to generate veneer ribbon 1030.

As seen in FIG. 10, computing environment 350 includes computing system 352. As seen in FIG. 10, in one embodiment, computing system 352 includes surface irregularity to greyscale mapping database 310 containing mapping data 312 that maps surface irregularities to Near InfraRed (NIR) image greyscale values for one or more full veneer sheet, veneer strip, and/or partial veneer sheets.

As noted above with respect to FIG. 3A, using NIR images, extremely granular differences in irregularity levels can be detected. In general, locations with different levels of irregularities absorb/reflect different amounts of NIR radiation at specific frequencies. In operation, when NIR radiation of a given frequency is applied to a veneer ribbon first surface 1032 of veneer ribbon 1030, more NIR energy is reflected from surfaces that are perpendicular the NIR camera lens. Consequently, at locations having irregularities such that the surfaces are not perpendicular the NIR camera lens will appear darker, i.e., have a greater greyscale value.

When the NIR camera 324 takes an image of the veneer ribbon first surface 1032, the NIR camera 324 picks up the NIR energy reflected off veneer ribbon first surface 1032 at approximately 90 degrees. Consequently, when the NIR camera 324 takes an image of the veneer ribbon first surface 1032, the areas of irregularities, which scatter more NIR energy at angles other than 90 degrees and therefore reflect less NIR energy, appear darker than dry areas. In addition, the higher or more significant the irregularities that are present, the darker the area appears because less NIR energy is reflected to be captured by the NIR camera 324.

Using this fact, NIR image data 362 captured by the NIR camera 324 can be processed into NIR greyscale image data 364. Greyscale images can be of varying resolution, or bit, types. A 16-bit integer grayscale image provides 65535 available tonal steps from 0 (black) to 65535 (white). A 32-bit integer grayscale image theoretically will provide 4,2114,1167,2115 tonal steps from 0 (black) to 4211411672115 (white). Converting an NIR image based on these number of greyscale tonal steps results in a margin of error of significantly less than 0.1%.

In some embodiments, two or more NIR cameras are utilized, such as NIR camera 324, that are operated at different NIR frequencies and/or that are positioned a different angles with respect to veneer ribbon first surface 1032. This allows different types and levels of irregularities to be detected. In addition, using two or more NIR cameras, such as NIR camera 324, that are positioned at different angles means that different irregularities will have surfaces perpendicular to the camera lens and therefore will yield a 3-D effect when a composite NIR image is constructed. A more detailed discussion of a one example of a multi-NIR camera system is discussed above with respect to FIG. 3B.

Returning to FIG. 10, using the concepts discussed above, the mapping data 312 of surface irregularity to greyscale mapping database 310 is obtained through one or more empirical and/or manual processes, as discussed above with respect to FIG. 3A.

As discussed above, FIGS. 4A to 4F are illustrative examples of NR images of surfaces of veneer produced various optimal and non-optimal production parameters. In the specific examples of FIGS. 4A to 4F the NIR image illustrations of 4A, 4B, 4C, 4D, 4E and 4F, correlate to the magnified visual image illustrations of FIGS. 2A, 2B, 2C, 2D, 2E and 2F, respectively.

Returning the FIG. 10, computing system 352 also includes NIR greyscale image to processing parameter mapping database 1010. In one embodiment, NIR greyscale image to processing parameter mapping database 1010 includes processing parameter mapping data 1012 that maps NIR greyscale images to particular processing parameters and issues based on known data obtained from known processing greyscale images, such as images 4D, 4E, and 4F.

Computing system 352 also includes physical memory 360. In one embodiment, the physical memory 360 includes NIR image data 362 representing one or more NTR images of the illuminated veneer ribbon first surface 1032 of the veneer ribbon 1030 captured using NIR camera 324. Physical memory 360 also includes NIR greyscale image data 364. In one embodiment, computing system 352 includes one or more processors 370 for processing the NTR image data representing one or more NIR images of the illuminated veneer ribbon first surface 1032 of the veneer ribbon 1030 to generate NIR greyscale image data 364 indicating different irregularity levels and types in the illuminated veneer ribbon first surface 1032 of the veneer ribbon 1030.

In one embodiment, processor 370 processes the NIR greyscale image data 364 using the mapping data 312 from surface irregularity to greyscale mapping database 310 to identify irregularity levels and types for the veneer ribbon first surface 1032 of the veneer ribbon 1030.

As seen in FIG. 10, in one embodiment, computing system 352 includes a processing parameter analysis module 1074 which analyzes processing parameter mapping data 1012 and NIR greyscale image data 364 to determine a processing parameter maladjustment or issue represented by processing parameter mapping data 1012. In various embodiments, processing parameter analysis module 1074 determines which, if any, processing parameters must be changed to adjust the processing of subsequent veneer ribbon 1030 from the same wood source 1001.

In some embodiments, processing parameter analysis module 1074 includes one or more machine learning based models such as any machine learning based models discussed herein, and/or as known in the art at the time of filing, and/or as become known/available after the time of filing.

For instance, based on the analysis of NIR greyscale image data 364 and processing parameter mapping data 1012, processing parameter analysis module 1074 may determine: a knife or other processing component needs replacement; a probability that a rotation speed of a lath turning the wood source 1001 needs adjusting; an angle of a knife used to cut the veneer ribbon 1030 from the wood source 1001 needs adjusting; and a pressure used to keep a knife used to cut veneer ribbon 1030 from the wood source 1001 in contact with a surface of the wood source 1001 needs adjustment or a repair.

Processing parameter analysis module 1074 may determine any combination, or all, of these processing parameters, or other processing parameters, need to be adjusted. In various embodiments, the adjustments determined to be necessary by processing parameter analysis module 1074 are then provided to processing parameter adjustment activation module 1090 which is used to generate determined adjustment data 1094.

In various embodiments, determined adjustment data 1094 is then transferred to adjustment implementation module 1096 in production floor environment 301. Adjustment implementation module 1096 then causes processing control module 1098 to make the desired adjustments to the processing of preconditioned wood source 1001 into veneer ribbon 1030. As noted, these adjustments can include replacing a knife or other processing component; adjusting a rotation speed of a lath turning the wood source 1001; adjusting an angle of a knife used to cut the veneer ribbon 1030 from the wood source 1001; and adjusting or making repairs so that a pressure used to keep a knife used to cut veneer ribbon 1030 from the wood source 1001 in contact with a surface of the wood source 1001.

Using system 1000 the processing parameters so critical to veneer ribbon 1030 production can be adjusted dynamically using feedback based on actual full veneer sheet, veneer strip, and/or a partial veneer sheet NIR surface image analysis. In one embodiment, these adjustments are made as veneer ribbon 1030 is being created from a single wood source 1001, such as a single preconditioned log. Consequently, using system 1000, provides a technical solution to the long-standing technical problem of adjusting processing parameters for optimal results from a single wood source before significant amounts of defective full veneer sheet, veneer strip, and/or a partial veneer sheet have been produced to minimize wasted product and maximize product value in relative real time.

Those of skill in the art will ready recognize that the specific illustrative examples of one embodiment of a production floor environment 301 and components shown in FIG. 10 are but specific examples of numerous possible production environments and arrangement of physical components. Consequently, the specific illustrative example of an embodiment of a production floor environment 301 and components shown in FIG. 10 is not intended to limit the scope of the invention as set forth in the claims below.

As a specific illustrative example of potential variations, in various embodiments, the NIR analysis station 320 can include one or more illumination sources 322 positioned to illuminate two or more surfaces of veneer ribbon 1030 and one or more NIR cameras 324 positioned to capture one or more NIR images of the two or more illuminated surfaces of veneer ribbon 1030.

As a further specific illustrative example of variations possible, additional input data can be considered such as current ambient temperature and humidity. The combination of these parameters can be analyzed by an AI/ML algorithm to further refine the production parameters for overall process efficiency.

These and numerous other variations are possible and contemplated by the inventors to be within the scope of the invention as set forth in the claims below.

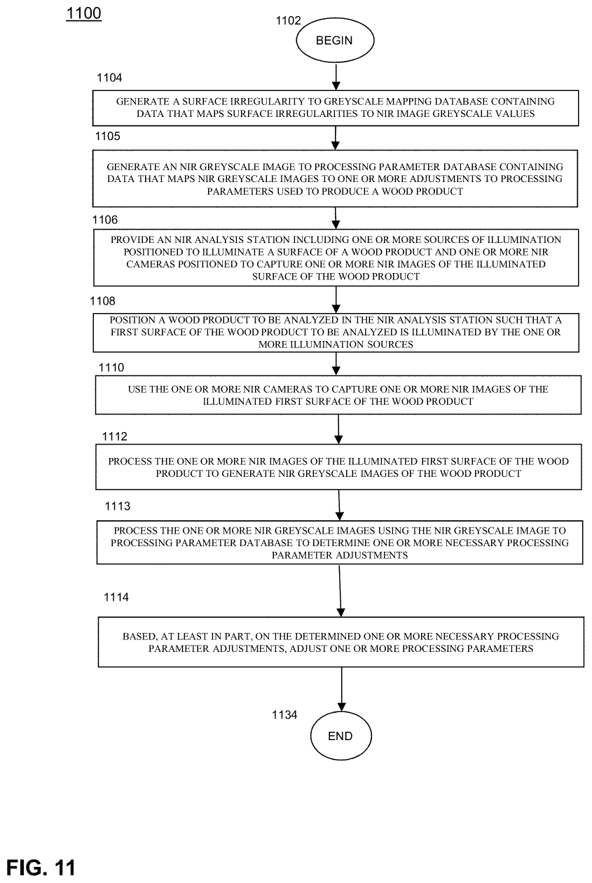

FIG. 11 is a flow chart of a process 1100 for adjusting processing parameters used to produce a veneer ribbon, full veneer sheet, veneer strip, and/or partial veneer sheets from a wood source based on a level of irregularity of a first surface of the veneer ribbon, full veneer sheet, veneer strip, and/or partial veneer sheets in accordance with one embodiment.

As seen in FIG. 11, process 1100 begins at BEGIN operation 1102 and then process proceeds to operation 1104. In one embodiment, at operation 1104 a surface irregularity level to greyscale mapping database is generated such as any database discussed above with respect to FIG. 3A, FIG. 10, FIGS. 2A through 2C, and corresponding FIGS. 4D through 4F. In one embodiment, the surface irregularity level to greyscale mapping database contains mapping data that maps surface irregularities to Near InfraRed (NIR) image greyscale values for veneer.

Once a surface irregularity level to greyscale mapping database is generated at operation 1104, process flow proceeds to operation 1105. In one embodiment, at operation 1105 an NIR greyscale image to processing parameter mapping database is generated using any of the methods and systems discussed above with respect to FIG. 10.

Once an NIR greyscale image to processing parameter mapping database is generated at operation 1105, process flow proceeds to operation 1106. At operation 1106, an NIR analysis station is provided. In one embodiment, the NIR analysis station is substantially similar to any NIR analysis station discussed above with respect to FIGS. 3A, 3B, and 10. As discussed above, in one embodiment, the NIR analysis station includes one or more sources of illumination positioned to illuminate a surface of the veneer and one or more NIR cameras positioned to capture one or more NIR images of the illuminated surface of the veneer.

Once an NIR analysis station is provided at operation 1106, process flow proceeds to operation 1108. In one embodiment, at operation 1108, the veneer to be analyzed is positioned in the NIR analysis station of operation 1106 such that a first surface of the veneer to be analyzed is illuminated by the one or more illumination sources using any of the methods and systems discussed above with respect to FIG. 3A, FIG. 10, FIGS. 2A through 2C, and corresponding FIGS. 4D through 4F.

Once the veneer to be analyzed is positioned in the NIR analysis station at 1108, process flow proceeds to operation 1110. In one embodiment, at operation 1110 the one or more NIR cameras of NIR analysis station take one or more NIR images of the illuminated first surface of the veneer using any of the methods and systems discussed above with respect to FIG. 3A, FIG. 10, FIGS. 2A through 2C, and corresponding FIGS. 4D through 4F.

Once the one or more NIR cameras of NIR analysis station take one or more NIR images of the illuminated first surface of the veneer at operation 1110, process flow proceeds to operation 1112.

In one embodiment, at operation 1112, the one or more NIR images of the illuminated first surface of the veneer of operation 1110 are processed using any of the methods and systems discussed above with respect to FIGS. 3A, 3B, FIG. 10, FIGS. 2D through 2F, and corresponding FIGS. 4D through 4F, to generate NIR greyscale images indicating different irregularities in the illuminated first surface of the veneer.

Once the one or more NIR images of the illuminated first surface of the veneer are processed to generate NIR greyscale images indicating different irregularities in the illuminated first surface of the veneer at operation 1112, process flow proceeds to operation 1113.

In one embodiment, at operation 1113, the NTR greyscale images are processed using the NIR greyscale image to processing parameter mapping database to determine processing parameter adjustments required using any of the methods and systems discussed above with respect to FIGS. 3A and 3B, FIG. 10, FIGS. 2D through 2F, and corresponding FIGS. 4D through 4F.

Once the NIR greyscale images are processed using NIR greyscale image to processing parameter mapping database to determine processing parameter adjustments at operation 1113, process flow proceeds to operation 1114.

In one embodiment, at operation 1114 any processing parameters that it is determined must be adjusted are adjusted via one or more actions such as any actions discussed above with respect to FIG. 10.

Once any processing parameters that it is determined must be adjusted are adjusted at operation 1114, process flow proceeds to END operation 1134 where process 1100 is exited to await new samples and/or data.

The disclosed embodiments utilize NIR cameras to scan the surface of veneer for irregularities and create an NIR image of the surface of the veneer. Since essentially each pixel of camera image data is a sample point, the resolution and accuracy of the surface irregularity detection process is only limited by the number of pixels the camera has covering the field of view, e.g., the entire first surface of a full veneer sheet, veneer strip, and/or a partial veneer sheet. Consequently, in the case where a 1.3 mega pixel camera is used there are essentially 1,300,000 individual measurement points on the surface of the veneer. In addition, NIR wavelengths are in the range of 750 nanometers (nm) to 3500 nm which are much smaller that the visible wavelengths of 380 to 740 nm. Consequently, the use of NR cameras as disclosed herein results in resolutions and accuracy that simply cannot be achieved using traditional visual irregularity detection systems.

In addition, when, as disclosed herein, NIR cameras are used as the surface irregularity detection mechanism, if greater or less resolution is deemed necessary, a higher or lower mega-pixel camera can be selected to achieve the desired resolution for the process. This can be accomplished in a relatively simple and quick camera switch out procedure. In addition, NIR camera placement with respect to the sample under analysis can be adjusted such that a quality image can be obtained as long as there is a clear field of view between the veneer surface and NIR camera. Horizontal, vertical, or angled placements have no impact on the functionality of the NIR camera.

Therefore, the disclosed technical solution is capable of detecting irregularities in a wide range of samples sizes ranging from of a traditional 2″×2″ square, to a full 4′×8′ sheet or panel surface, and, by using a series of NIR images spliced together, up to an 80′-120′ ribbon of material. This, in turn, allows the disclosed embodiments to be implemented without significantly slowing down the production process or increasing the cost of the finished full veneer sheet, veneer strip, and/or a partial veneer sheet.

The use of NIR cameras, as disclosed herein, eliminates the need for any offline magnification of the veneer or the need for the surface irregularity detection device, i.e., the NIR camera, to be close to the surface of the veneer. This allows for more flexible placement of the sample taking device, i.e., the NIR camera.

In addition, unlike visual based detection methods NIR cameras are virtually immune to ambient visible light and interference. Consequently, use of NIR cameras as disclosed herein is far more suitable for a physical production line environment.

Further, NIR technology has been determined to be safe, i.e., representing no hazards to workers or other devices, by several testing and safety agencies. Consequently, the use of the disclosed NIR based surface irregularity detection systems results in a safe, comfortable, and efficient workplace and production floor.

Using the disclosed embodiments, surface irregularities on the surface of full veneer sheet, veneer strip, and/or partial veneer sheets can be identified efficiently, effectively, and quickly, while the production line continues operation at normal speeds, consequently, implementation of the disclosed embodiments, does not slow down production speed or change product processing time.

As noted above, embodiments of the present disclosure provide an effective and efficient technical solution to the technical problem of accurately and efficiently grading and stacking full veneer sheets, veneer strips, and/or partial veneer sheets. To this end, in one embodiment, irregularities on the surfaces of full veneer sheets, veneer strips, and/or partial veneer sheets are detected using the disclosed NIR analysis system such as any of the NIR analysis systems of FIG. 3A. 3B, 5, 6, 7, 8, 9, 10, or 11. In one embodiment, the disclosed NIR analysis system is used to assign a grade to full veneer sheets, veneer strips, and/or partial veneer sheets based at least in part on the detected irregularities. In one embodiment, the full veneer sheets, veneer strips, and/or partial veneer sheets are then provided to an improved veneer stacking system that produces more consistently graded veneer stacks and safer veneer stacks, is less expensive to operate, and is far safer than currently available methods and systems for full veneer sheet, veneer strip, and partial veneer sheet stacking.

FIG. 12 is a block diagram of a full veneer sheet grading and stacking system 1230 in accordance with one embodiment. Full veneer sheet grading and stacking system 1230 includes dryer outfeed 1231 where individual full veneer sheets 1232 are dropped onto dryer outfeed conveyor 1233. Full veneer sheets 1232 can be created to almost any size desired. However, as one illustrative example, full veneer sheets can have an average length (Lf) of approximately 102 inches and a width (Wf) of approximately 54 inches. As discussed, for safety reasons and for production efficiency, the dimensions of the stacks of full veneer sheets 1232 to be created should ideally be as close to the dimensions of the individual full veneer sheets 1232 as possible. As discussed below, unlike currently available systems, full veneer sheet grading and stacking system 1230 is well suited by design to accomplish this task.

From dryer outfeed conveyor 1233 the individual full veneer sheets 1232 pass through moisture meter 1234 where the moisture content of the individual full veneer sheets 1232 is determined. In some cases, if the moisture content of an individual full veneer sheet 1232 is determined to be unacceptable, that specific individual full veneer sheet 1232 is so marked by moisture meter 1234 and that individual full veneer sheet 1232 is processed, or removed from processing, accordingly. In some cases, the moisture level of individual full veneer sheets 1232 can be used in part to determine a grade of the individual full veneer sheet 1232.

From moisture meter 1234, the individual full veneer sheets 1232 are passed to veneer analysis and selection conveyor 1235. In one embodiment, the individual full veneer sheets 1232 are conveyed by veneer analysis and selection conveyor 1235 to veneer analysis system 1200. Veneer analysis system 1200 is representative of one or more veneer analysis systems at one or more veneer analysis system locations/positions along veneer analysis and selection conveyor 1235 and therefore the inclusion of the single veneer analysis system 1200 in FIG. 12 is not limiting.

As discussed in more detail below, in one embodiment, veneer analysis system 1200 is used to generate image data associated with each of the individual full veneer sheets 1232. As also discussed in more detail below, this image data is then processed to generate dimensions data 1201 for each individual full veneer sheet 1232. In one embodiment, the dimensions data 1201 for each individual full veneer sheet 1232 includes data representing the relative location, center of mass, orientation, and physical dimensions, i.e., length and width, of each individual full veneer sheet 1232.

In addition, in one embodiment, veneer analysis system 1200 includes the disclosed NIR analysis system 300 of FIGS. 3A, 3B, 5, and/or NIR analysis system 600 of FIGS. 6 and 7, to analyze the surface of each individual full veneer sheet quickly, consistently, and automatically to generate grade assignment data 382 which is included in grading data 1203 for each individual full veneer sheet 1232. Grading data 1203 represents a grade assigned to each individual full veneer sheet 1232.

In accordance with the disclosed embodiments, the dimensions data 1201 and grading data 1203 for each individual full veneer sheet 1232 is provided to robot control system 1205. Robot control system 1205 is representative one or more veneer selection and stacking robot control systems associated with one or more local robotic veneer stacking cells 1242. Therefore, the number of robot control systems is not limited to the single robot control system 1205 shown. In one embodiment, robot control system 1205 generates veneer selection and stacking robot control signal data 1206 representing veneer selection and stacking robot control signals based on analysis of the dimensions data 1201 and grading data 1203 for each individual full veneer sheet 1232.

The generated veneer selection and stacking robot control signals represented by veneer selection and stacking robot control signal data 1206 are then provided to local robotic veneer stacking cells 1242 where they are used to control the operation of one or more veneer selection and stacking robots 1240A and 1240B included in the one or more local robotic veneer stacking cells 1242. In various embodiments, the number of local robotic veneer stacking cells and veneer selection and stacking robots can be any number desired. Consequently, the two local robotic veneer stacking cells 1242 and veneer selection and stacking robots 1240A and 1240B shown in FIG. 12 is not limiting.

In one embodiment, in response to the veneer selection and stacking robot control signals represented by veneer selection and stacking robot control signal data 1206, veneer selection and stacking robots 1240A and 1240B use robotic arms to select specific full veneer sheets 1232 from veneer analysis and selection conveyor 1235 and move the selected full veneer sheets 1232 from veneer analysis and selection conveyor 1235 to the appropriate veneer stacks 1237. In this way, veneer stacks 1237 of individual full veneer sheets 1232 are created that are veneer stacks 1237 of the respectively consistent grade of individual full veneer sheets 1232. In some embodiments, the height of the veneer stacks 1237 is typically 38 inches and each stack contains approximately 185 individual sheets or layers.

As discussed above, veneer is a type of wood product that is manufactured into full veneer sheets, veneer strips, and partial veneer sheets. As they are manufactured, various defects may exist in the full veneer sheets, veneer strips, and partial veneer sheets. Consequently, depending on the number and type of defects on a particular full veneer sheet 1232, that full veneer sheet 1232 may be unsatisfactory for use in particular applications.

Accordingly, is important that full veneer sheets 1232 are accurately and consistently graded following manufacture because this grade determines the value and the possible uses for which a full veneer sheet 1232 is suitable. The grade assigned to a full veneer sheet 1232 can also be used to determine its best use; for example, whether it is suitable as a face sheet for plywood, whether it is suitable for clipping and edge gluing to form a sheet, whether it is suitable for use in laminated wood beams, should be discarded, or is suitable for other uses.

As also discussed above, prior art full veneer sheet, veneer strip, and/or partial veneer sheet stacking methods and systems suffer from several serious drawbacks. For instance, using prior art methods and systems for producing layered wood products, the quality of veneer fed into process is often not efficiently and effectively inspected and graded during the veneer stacking operation. Therefore, undetected defects can cause products created using the full veneer sheets in prior art veneer stacks to be rejected downstream after significant time and energy has already been devoted to the panels, e.g., pressing is complete and panel quality is analyzed.

Indeed, as pointed out above, using typical prior art full veneer sheet stacking methods and systems human workers are assigned an unrealistic set of tasks to be performed in an unrealistic amount of time. These include performing visual grading of full veneer sheets as they move along the hand sort conveyor, manually moving full veneer sheets from hand sort conveyor to the veneer stack associated with the visual and manual grading of the full veneer sheets, without damaging the relatively fragile full veneer sheets, and then adding full veneer sheets to the appropriate veneer stack in such a way that the dimensions of the veneer stacks are consistent and that the edges of each veneer stack are as even as possible.

This is not realistic, and the result is that full veneer sheets were inconsistently and/or inaccurately graded, many full veneer sheets were damaged, and the resulting veneer stacks, more often than not, did include numerous full veneer sheets that were not aligned so the veneer stacks did not have even sides and did have jagged edges.

To address this issue, and in contrast to prior art full veneer sheet stacking methods and systems, full veneer sheet grading and stacking system 1230 utilizes robot control systems, such as robot control system 1205, to control veneer selection and stacking robots, such as veneer selection and stacking robots 1240A and 1240B, to create veneer stacks 1237 such that each of veneer stacks 1237, e.g., veneer stack 1 through veneer stack 5, is associated with a different grade of full veneer sheets 1232. In addition, in one embodiment, veneer selection and stacking robots 1240A and 1240B are directed by the veneer selection and stacking robot control signals represented by veneer selection and stacking robot control signal data 1206 to select different full veneer sheets 1232, to remove the full veneer sheets 1232 from veneer analysis and selection conveyor 1235, and to place the full veneer sheets 1232 in a specific veneer stack 1237, e.g., veneer stack 1 through veneer stack 5, using robotic arms based, at least in part on the grade indicated by the grading data 1203 associated with the individual full veneer sheets 1232. Consequently, veneer stacks 1237, e.g., veneer stack 1 through veneer stack 5, are made up of full veneer sheets 1232 accurately and consistently determined to be of the specific grade associated with that veneer stack 1237, e.g., veneer stack 1 through veneer stack 5.

Dimensions data 1201 includes data indicating the length and width of the full veneer sheets 1232. In this way, it is assured that each full veneer sheet 1232 has the desired length (Lf) and width (Wf) to within defined tolerances. In addition, as discussed below, the dimensions data 1201 for each individual full veneer sheet 1232 is used to generate veneer selection and stacking robot control signals represented by veneer selection and stacking robot control signal data 1206 that direct robotic arms of veneer selection and stacking robots 1240A and 1240B to add each individual full veneer sheet 1232 to its appropriate specific veneer stack 1237, e.g., veneer stack 1 through veneer stack 5, so that all four edges of the individual full veneer sheets 1232 are aligned. Consequently, the resulting veneer stacks 1237 are aligned to have the desired dimensions and have even edges/sides and do not have jagged edges. The result is that veneer stacks 1237 are not only made up of sheets of veneer 1232 accurately determined to be of the correct grade and correct dimensions, but that the sheets of veneer 1232 are stacked such that veneer stacks 1237 resemble ideal veneer stack 267A of FIG. 2G rather than typical prior art veneer stack 267B of FIG. 2G.

This is in contrast to prior art full veneer sheet stacking methods and systems, where, in addition to being given the virtually impossible task of grading and manually moving each full veneer sheet from the conveyor to the appropriate grade veneer stack without damaging the full veneer sheets, human workers were further tasked with adding full veneer sheets to the appropriate veneer stack in such a way that the dimensions of the veneer stacks were consistent and that the edges of each veneer stack are as even as possible. As noted, this prior art requirement of human workers was not realistic and resulted in full veneer sheets that were not only inconsistently and/or inaccurately graded, but that were often damaged and stacked such that numerous full veneer sheets that were not aligned so the veneer stacks did not have even sides and included jagged edges.

Returning to FIG. 12, full veneer sheet grading and stacking system 1230 includes overflow bin 1238. In operation, any full veneer sheets 1232 that are of unacceptable dimensions, grade, or moisture content, are passed from full veneer sheets 1232 to overflow bin 1238 for recycling and/or repurposing. However, unlike prior art full veneer sheet stacking systems, using full veneer sheet grading and stacking system 1230 overflow bin 1238 does not typically contain significant amounts of veneer that has been damaged, or simply not processed fast enough. This is because full veneer sheet grading and stacking system 1230 uses veneer selection and stacking robots 1240A and 1240B and robotic arms rather than human workers so that there is minimal damage to full veneer sheets 1232 and processing time is not an issue.

As discussed in more detail below, one way the use of veneer selection and stacking robots 1240A and 1240B avoids damaging full veneer sheets 1232 is by utilizing robotic arms with selectively activated vacuum heads to move the full veneer sheets 1232 from veneer analysis and selection conveyor 1235 and to place the full veneer sheets 1232 in a specific veneer stack 1237.

In addition, as seen in FIG. 12, by employing veneer selection and stacking robots 1240A and 1240B rather than human workers, full veneer sheet grading and stacking system 1230 requires the use of as few as two human workers 1236; one to position full veneer sheets 1232 onto dryer outfeed conveyor 1233 and one to control the use of overflow bin 1238.

As also seen in FIG. 12, in one embodiment, once veneer stacks 1237, e.g., veneer stack 1, veneer stack, 2, veneer stack 3, veneer stack 4, and veneer stack 5 in FIG. 12, are created, veneer stack 1, veneer stack, 2, veneer stack 3, veneer stack 4, and veneer stack 5 are relayed to output conveyor 1245 via relay conveyors/rollers 1251, 1252, 1253, 1254, and 1255, respectively. At the end of output conveyor 1245, veneer stacks 1237 are picked up by forklift 1247 which moves veneer stacks 1237 to the location in the processing plant where they are needed.

As shown above, in contrast to prior art full veneer sheet stacking methods and systems, full veneer sheet grading and stacking system 1230 uses a veneer analysis system 1200, including a disclosed NIR analysis system 300 of FIGS. 3A, 3B, 5, and/or NIR analysis system 600 of FIGS. 6 and 7, to accurately identify the dimensions of the full veneer sheets 1232 and accurately and consistently assign a grade to the full veneer sheets 1232 before the full veneer sheets 1232 are placed in any veneer stack 1237 for further processing. Consequently, using full veneer sheet grading and stacking system 1230, the quality of veneer fed into process is efficiently and effectively determined during the veneer stacking operation. In this way defects that can cause products created using the veneer to be rejected downstream are detected before significant time and energy has been devoted to the processing of the veneer. In addition, by using the disclosed NIR analysis system 300 of FIGS. 3A, 3B, 5, and/or NIR analysis system 600 of FIGS. 6 and 7, to consistently and accurately assign a grade to the full veneer sheets 1232 before the full veneer sheets 1232 are placed in any veneer stack 1237 for further processing, individual full veneer sheets 1232 can be used in the most effective and valuable way.

In addition, as noted above, and discussed in more detail below, even if prior art inspection and grading systems were employed, prior art inspection and grading systems can be error prone and lead to inaccurate images of veneer sheets being taken, which can result in the system improperly grading veneer sheets. In contrast, in various embodiments, full veneer sheet grading and stacking system 1230 uses a veneer analysis system 1200, including disclosed NIR analysis system 300 of FIGS. 3A, 3B, 5, and/or NIR analysis system 600 of FIGS. 6 and 7, that can capture images of entire surfaces of full veneer sheets 1232 and therefore are far less error prone, are faster, and can require less processing power.

In addition, in contrast to prior art full veneer sheet stacking methods and systems, using full veneer sheet grading and stacking system 1230, human workers are no longer assigned an unrealistic set of tasks to be performed in an unrealistic amount of time. This is because using full veneer sheet grading and stacking system 1230 veneer selection and stacking robots 1240A and 1240B perform the grading of full veneer sheets and/or veneer strips and/or partial veneer sheets 1232 automatically and use robotic arms to move the full veneer sheets 1232 from veneer analysis and selection conveyor 1235 to the appropriate veneer stack 1237. As discussed in more detail below, in one embodiment, veneer selection and stacking robots 1240A and 1240B use selectively activated vacuum heads that are faster than humans and are far less likely to damage the relatively fragile full veneer sheets 1232.

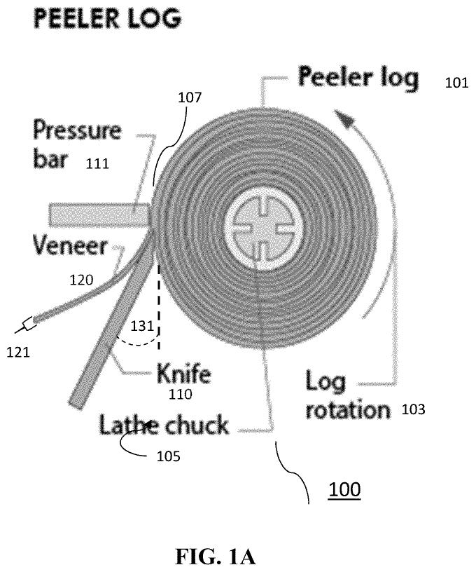

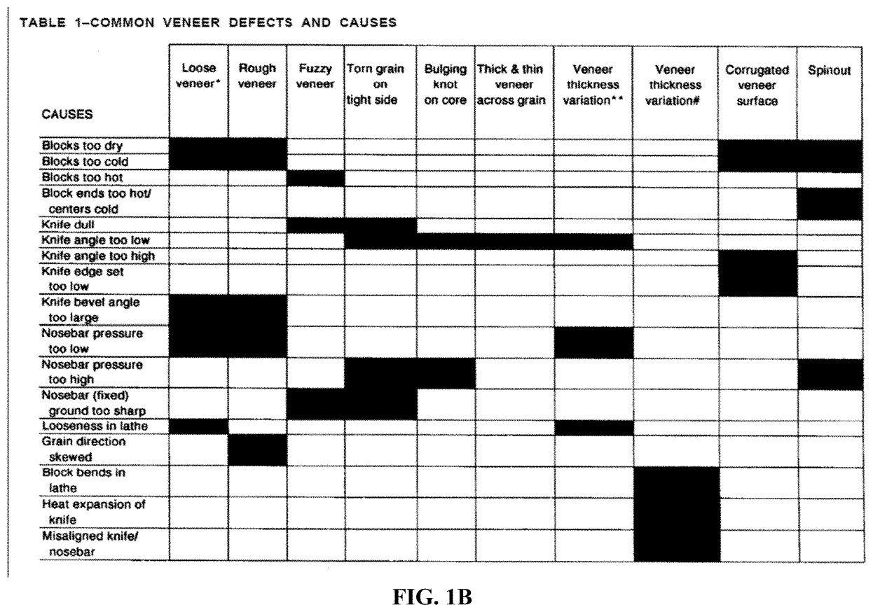

In addition, in contrast to prior art full veneer sheet stacking methods and systems, full veneer sheet grading and stacking system 1230 performs analysis of the dimensions data 1201 of each full veneer sheet 1232 and uses this analysis to ensure the full veneer sheets 1232 are of the correct and consistent defined dimensions, e.g., length Lf and width Wf of FIG. 1A, and are added to the appropriate veneer stack 1237 in such a way that the dimensions of the veneer stacks 1237 are consistent, e.g., length Lf and width Wf of FIG. 1A, that the edges of each veneer stack 1237 are as even as possible, and that the veneer stacks 1237 are relatively bulge free.

In addition, in contrast to prior art full veneer sheet stacking methods and systems, full veneer sheet grading and stacking system 1230 does not require significant human interaction with complicated machines and significant human manual manipulation of veneer. Consequently, the numerous injuries associated with prior art full veneer sheet, veneer strip, and/or partial veneer sheet stacking methods and systems, including significant splinter injuries, machine injuries, repetitive motion injuries, fatigue, and worker burnout, are minimized and/or avoided completely using full veneer sheet grading and stacking system 1230.

Consequently, full veneer sheet grading and stacking system 1230 provides an effective and efficient technical solution to the long-standing technical problem of providing a method and system for full veneer sheet stacking that includes improved wood product scanning and grading methods, produces more consistently graded veneer stacks and safer veneer stacks, is less expensive to operate, and is far safer than currently available methods and systems for full veneer sheet stacking.

FIG. 13 is a block diagram of a veneer strip grading and stacking system 1330 in accordance with one embodiment. Veneer strip grading and stacking system 1330 includes dryer outfeed 1331 where individual veneer strips 1341 are dropped onto dryer outfeed conveyor 1333. Veneer strips 1341, being partial portions of full veneer sheets, can be almost any width (Ws). However, veneer strips 1341 typically have approximately the same length dimension as full veneer sheets, e.g., length Lf. As noted above, in one illustrative example, the average length Lf of each of veneer strips 1341 is approximately 102 inches.

As will be discussed below, for safety reasons and for production efficiency, the dimensions of the veneer stacks 1343 of veneer strips 1341 to be created would ideally be consistent in both length and width dimensions. In one illustrative embodiment, the length of a veneer stacks 1343 is approximately length Lf of a full veneer sheet and the width of veneer stacks 1343 is approximately width Wf of a full veneer sheet. In addition, as discussed above, it is desirable to have as few bulges in the layers of the veneer stacks 1343. As discussed below, unlike currently available systems, veneer strip grading and stacking system 1330 is well suited by design to accomplish this task.

In one embodiment, from dryer outfeed conveyor 1333 the individual veneer strips 1341 pass through moisture meter 1334 where the moisture content of the individual veneer strips 1341 is determined. In some cases, if the moisture content of an individual veneer strip 1341 is determined to be unacceptable, that specific individual veneer strip 1341 is so marked by moisture meter 1334 and that individual veneer strip 1341 is processed, or removed from processing, accordingly. In some cases, the moisture level of individual veneer strips 1341 can be used in part to determine a grade of the individual veneer strip 1341.

From moisture meter 1334, the individual veneer strips 1341 are passed to veneer analysis and selection conveyor 1335. In one embodiment, the individual veneer strips 1341 are conveyed by veneer analysis and selection conveyor 1335 to veneer analysis system 1200. Veneer analysis system 1200 is representative of one or more veneer analysis systems at one or more veneer analysis system locations/positions along veneer analysis and selection conveyor 1335 and therefore the inclusion of the single veneer analysis system 1200 in FIG. 13 is not limiting.

As discussed in more detail below, in one embodiment, veneer analysis system 1200 is used to generate image data associated with each of the individual veneer strips 1341. As also discussed in more detail below, this image data is then processed to generate dimensions data 1301 for each individual veneer strip 1341. In one embodiment, the dimensions data 1301 for each individual veneer strip 1341 includes length data that can be processed to ensure each individual veneer strip 1341 is of the desired length (Lf) to within defined tolerances. In dimensions data 1301 for each individual veneer strip 1341 includes width data indicating the precise width (Ws) of each individual veneer strip 1341. In one embodiment, the dimensions data 1301 for each individual veneer strip 1341 also includes data representing the relative location, center of mass, orientation, and physical dimensions of each individual veneer strip 1341.

In addition, in one embodiment, veneer analysis system 1200 includes the disclosed NIR analysis system 300 of FIGS. 3A, 3B, 5, and/or NIR analysis system 600 of FIGS. 6 and 7, to analyze the surface of each individual full veneer sheet quickly, consistently, and automatically to generate grade assignment data 382 which is included in grading data 1203 for each individual full veneer sheet 1232. Grading data 1203 represents a grade assigned to each individual full veneer sheet 1232.

In accordance with the disclosed embodiments, the dimensions data 1301 and grading data 1303 for each individual veneer strip 1341 is provided to robot control system 1305. Robot control system 1305 is representative one or more veneer selection and stacking robot control systems, associated with one or more local robotic veneer stacking cells 1342. Therefore, the number of robot control systems is not limited to the single robot control system 1305 shown. In one embodiment, robot control system 1305 generates veneer selection and stacking robot control signal data 1306 representing veneer selection and stacking robot control signals based on analysis of the dimensions data 1301 and grading data 1303 for each individual veneer strip 1341.

The generated veneer selection and stacking robot control signals represented by veneer selection and stacking robot control signal data 1306 are then provided to local robotic veneer stacking cells 1342 where they are used to control the operation of one or more veneer selection and stacking robots 1340A and 1340B included in the one or more local robotic veneer stacking cells 1342. In various embodiments, the number of local robotic veneer stacking cells and veneer selection and stacking robots can be any number desired. Consequently, the two local robotic veneer stacking cells 1342 and veneer selection and stacking robots 1340A and 1340B shown in FIG. 13 is not limiting.

In one embodiment, in response to the veneer selection and stacking robot control signals represented by veneer selection and stacking robot control signal data 1306, veneer selection and stacking robots 1340A and 1340B use robotic arms to select specific veneer strips 1341 from veneer analysis and selection conveyor 1335 and move the selected veneer strips 1341 from veneer analysis and selection conveyor 1335 to the appropriate veneer stacks 1343 to create layers of selected veneer strips 1341 making up veneer stacks 1343. In this way, veneer stacks 1343 of layers of individual veneer strips 1341 are created that are veneer stacks of the same grade of individual veneer strips 1341. In some embodiments, the height of the veneer stacks 1343 is typically 38 inches and each stack contains approximately 185 individual sheets or layers.

As discussed above, veneer is a type of wood product that is manufactured into full veneer sheet, veneer strip, and partial veneer sheets. As they are manufactured, various defects may exist in the full or partial veneer sheets. Consequently, depending on the number and type of defects on a particular veneer strip 1341, that veneer strip 1341 may be unsatisfactory for use in particular applications.

Accordingly, is important that veneer strips 1341 are accurately and consistently graded following manufacture because this grade determines the value and the possible uses for which a veneer strip 1341 is suitable. A grade assigned to a veneer strip 1341 can also be used to determine its best use.

As also discussed above, prior art veneer strip stacking methods and systems suffer from several serious drawbacks. For instance, using prior art methods and systems for producing layered wood products, the quality of veneer fed into process is often not efficiently and effectively inspected and graded during the veneer stacking operation. Therefore, undetected defects can cause products created using the veneer stacks to be rejected downstream after significant time and energy has already been devoted to the panels, e.g., pressing is complete and panel quality is analyzed.

Indeed, as pointed out above, using typical prior art veneer strip stacking methods and systems human workers are assigned an unrealistic set of tasks to be performed in an unrealistic amount of time. These include performing visual grading of veneer strips and/or partial veneer sheets as they move along the hand sort conveyor, manually moving veneer strips and/or partial veneer sheets from hand sort conveyor to the veneer stack associated with the visual and manual grading of the veneer strips and/or partial veneer sheets, without damaging the relatively fragile veneer strips and/or partial veneer sheets, and then adding veneer strips and/or partial veneer sheets to the appropriate veneer stack in such a way that the dimensions of the veneer stacks are consistent and that the edges of each veneer stack are as even as possible.

It is also desirable to stack the layers of individual veneer strips 1341 such that any gaps between individual veneer strips 1341 in the layers of individual veneer strips 1341 are staggered so that no bulges of low and high points are created in veneer stacks 1343. If layers with bulges of high and low points are created in veneer stacks 1343 due to repeatedly stacking veneer strips 1341 in the same pattern, then the resultant veneer stack 1343 will be unbalanced and potentially dangerous and difficult to process.

This is not realistic, and the result was that veneer strips and/or partial veneer sheets were inconsistently and/or inaccurately graded, many veneer strips and/or partial veneer sheets were damaged, the resulting veneer stacks, more often than not, did include numerous veneer strips and/or partial veneer sheets that were not aligned so the veneer stacks did not have even sides and did have jagged edges, and the resulting veneer stacks 1343 did have bulges of high and low points.

To address this issue, and in contrast to prior art veneer strip stacking methods and systems, veneer strip grading and stacking system 1330 utilizes robot control systems, such as robot control system 1305, to control veneer selection and stacking robots, such as veneer selection and stacking robots 1340A and 1340B to create veneer stacks 1343 such that each of veneer stacks 1343, e.g., veneer stack 1 through veneer stack 5, is associated with a different grade of veneer strips 1341. In addition, in one embodiment, veneer selection and stacking robots 1340A and 1340B are directed by the veneer selection and stacking robot control signals represented by veneer selection and stacking robot control signal data 1306 to use robotic arms to select different veneer strips 1341, to remove the veneer strips 1341 from veneer analysis and selection conveyor 1335, and to place the veneer strips 1341 in a specific veneer stack 1343, e.g., veneer stack 1 through veneer stack 5, based, at least in part on the grade indicated by the grading data 1303 associated with that individual veneer strip 1341. Consequently, veneer stacks 1343, e.g., veneer stack 1 through veneer stack 5, are made up of layers of veneer strips 1341 accurately and consistently determined to be of the specific grade associated with that veneer stack 1343, e.g., veneer stack 1 through veneer stack 5.

In addition, as discussed below, the dimensions data 1301 for each individual veneer strip 1341 is used to generate veneer selection and stacking robot control signals represented by veneer selection and stacking robot control signal data 1306 that direct robotic arms of veneer selection and stacking robots 1340A and 1340B to add each individual veneer strip 1341 in layers to its appropriate specific veneer stack 1343, e.g., veneer stack 1 through veneer stack 5, so that the edges of the individual layers of veneer strips 1341 are aligned and the resulting veneer stacks 1343 have both the desired length, e.g., length Lf, and the desired width, e.g., width Wf. Consequently, the resulting veneer stacks 1343 are made up of layers of veneer strips 1341 that are of the desired length and width, e.g., length Lf and width WF, and are aligned to have even edges/sides with no jagged edges. The result is that veneer stacks 1343 are not only made up of veneer strips 1341 accurately determined to be of the correct dimension and grade, but that the layers of veneer strips 1341 are stacked such that veneer stacks 1343 resemble ideal veneer stack 273A of FIG. 2H rather than typical prior art veneer stack 273B of FIG. 2H.

This is in contrast to prior art veneer strip stacking methods and systems, where, in addition to being given the virtually impossible task of grading and manually moving each veneer strip and/or partial veneer sheet from the conveyor to the appropriate grade veneer stack without damaging the veneer strips and/or partial veneer sheets, human workers were further tasked with adding layers of veneer strips and/or partial veneer sheets to the appropriate veneer stack in such a way that the dimensions of the veneer stacks were consistent and that the edges of each veneer stack are as even as possible. In addition, using prior art veneer strip stacking methods and systems, the human workers were also required to stack the layers of individual veneer strips and/or partial veneer sheets such that any gaps between individual veneer strips and/or partial veneer sheets in the layers of individual veneer strips and/or partial veneer sheets are staggered so that no bulges of low and high points are created in veneer stacks.

As noted, this prior art requirement of human workers was not realistic and resulted in veneer strips and/or partial veneer sheets that were not only inconsistently and/or inaccurately graded, but that were often damaged and stacked such that numerous veneer strips and/or partial veneer sheets that were not aligned so the veneer stacks did not have even sides and included jagged edges.

Returning to FIG. 13, veneer strip grading and stacking system 1330 includes overflow bin 1348. Like overflow bin 1238 of FIG. 12, in operation, any veneer strips 1341 that are of unacceptable dimensions, grade, or moisture content, are passed from veneer analysis and selection conveyor 1335 to overflow bin 1348 for recycling and/or repurposing. However, unlike prior art veneer strip stacking systems, using veneer strip grading and stacking system 1330 overflow bin 1348 does not typically contain significant amounts of veneer that has been damaged, or simply not processed fast enough. This is because veneer strip grading and stacking system 1330 uses robotic arms of veneer selection and stacking robots 1340A and 1340B rather than human workers so that there is minimal damage to partial veneer sheets 1341 and processing time is not an issue.

As discussed in more detail below, one way the use of veneer selection and stacking robots 1340A and 1340B avoids damaging veneer strips 1341 is by utilizing robotic arms with selectively activated vacuum heads to move the veneer strips 1341 from veneer analysis and selection conveyor 1335 and to place the layers of veneer strips 1341 in a specific veneer stack 1343.

In addition, as seen in FIG. 13, by employing veneer selection and stacking robots 1340A and 1340B rather than human workers, veneer strip grading and stacking system 1330 requires the use of as few as two human workers 1336; one to position veneer strips 1341 onto dryer outfeed conveyor 1333 and one to control the use of overflow bin 1348.

As also seen in FIG. 13, once veneer stacks 1343, e.g., veneer stack 1, veneer stack, 2, veneer stack 3, veneer stack 4, and veneer stack 5 in FIG. 13, are created, veneer stack 1, veneer stack, 2, veneer stack 3, veneer stack 4, and veneer stack 5 are relayed to output conveyor 1345 via relay conveyors/rollers 1351, 1352, 1353, 1354, and 1355, respectively. At the end of output conveyor 1345, veneer stacks 1343 are picked up by forklift 1247 which moves veneer stacks 1343 to the location in the processing plant where they are needed.

As shown above, in contrast to prior art veneer strip stacking methods and systems, veneer strip grading and stacking system 1330 uses a veneer analysis system 1200, including the disclosed NIR analysis system 300 of FIGS. 3A, 3B, 5, and/or NIR analysis system 600 of FIGS. 6 and 7, to accurately identify the dimensions of the veneer strips 1341 and accurately and consistently assign a grade to the veneer strips 1341 before the veneer strips 1341 are placed in any veneer stack 1343 for further processing. Consequently, using veneer strip grading and stacking system 1330, including the disclosed NIR analysis system 300 of FIGS. 3A, 3B, 5, and/or NIR analysis system 600 of FIGS. 6 and 7, the quality of veneer fed into process is efficiently and effectively determined during the veneer stacking operation. In this way defects that can cause products created using the veneer to be rejected downstream are detected before significant time and energy has been devoted to the processing of the veneer. In addition, by consistently and accurately assigning a grade to the veneer strips 1341 before the veneer strips 1341 are placed in any veneer stack 1343 for further processing, individual veneer strips 1341 can be used in the most effective and valuable way.

In addition, as noted above and discussed in more detail below, even if prior art inspection and grading systems were employed, prior art inspection and grading systems can be error prone and lead to inaccurate images of veneer sheets being taken, which can result in the system improperly grading veneer sheets. In contrast, veneer strip grading and stacking system 1330 uses a veneer analysis system, including the disclosed NIR analysis system 300 of FIGS. 3A, 3B, 5, and/or NIR analysis system 600 of FIGS. 6 and 7, that can capture images of entire surfaces of veneer strips 1341 and therefore is far less error prone, is faster, and can require less processing power.

In addition, in contrast to prior art veneer strip stacking methods and systems, using veneer strip grading and stacking system 1330, human workers are no longer assigned an unrealistic set of tasks to be performed in an unrealistic amount of time. This is because using veneer strip grading and stacking system 1330 robotic arms of veneer selection and stacking robots 1340A and 1340B perform the grading of veneer strips and/or partial veneer sheets automatically and move the veneer strips 1341 from veneer analysis and selection conveyor 1335 to the appropriate veneer stack 1343 in layers. In one embodiment, veneer selection and stacking robots 1340A and 1340B use robotic arms with selectively activated vacuum heads that are faster than humans and are far less likely to damage the relatively fragile veneer strips 1341.

In addition, in contrast to prior art veneer strip stacking methods and systems, veneer strip grading and stacking system 1330 performs analysis of the dimensions data 1301 of each veneer strip 1341 and uses this analysis to ensure the veneer strips 1341 are added to the appropriate veneer stack 1343 in layers such that the dimensions of the veneer stacks 1343 are consistent, that the edges of each veneer stack 1343 are as even as possible, and that the veneer stacks 1343 are relatively bulge free.

In addition, in contrast to prior art veneer strip stacking methods and systems, veneer strip grading and stacking system 1330 does not require significant human interaction with complicated machines and significant human manual manipulation of veneer. Consequently, the numerous injuries associated with prior art full veneer sheet, veneer strip, and/or partial veneer sheet stacking methods and systems, including significant splinter injuries, machine injuries, repetitive motion injuries, worker fatigue, and worker burnout, are minimized and/or avoided completely using veneer strip grading and stacking system 1330.

Consequently, veneer strip grading and stacking system 1330 provides an effective and efficient technical solution to the long-standing technical problem of providing a method and system for veneer strip stacking that includes improved wood product scanning and grading methods, produces more consistently graded veneer stacks and safer veneer stacks, is less expensive to operate, and is far safer than currently available methods and systems for full veneer sheet, veneer strip, and/or partial veneer sheet stacking.

As seen in the discussion above, both full veneer sheet grading and stacking system 1230 and veneer strip grading and stacking system 1330 use dimensions data and grading data generated by the veneer analysis systems 1200 for each individual full veneer sheet, veneer strip, and partial veneer sheet. This dimensions data and grading data is then provided to one or more veneer selection and stacking robot control systems associated with one or more local robotic veneer stacking cells. In one embodiment, the one or more veneer selection and stacking robot control systems generate veneer selection and stacking robot control signals based on analysis of the dimensions data and grading data for each individual full veneer sheet, veneer strip, and partial veneer sheet. The generated veneer selection and stacking robot control signals are then used to control the operation of one or more veneer selection and stacking robots included in the one or more local robotic veneer stacking cells.

In response to the received veneer selection and stacking robot control signals, the one or more veneer selection and stacking robots are then used to move each individual full veneer sheet, veneer strip, and partial veneer sheet locally and independently from the veneer analysis and selection conveyor system to an appropriate veneer stack based on the grade assigned to the individual full veneer sheet, veneer strip, and partial veneer sheet by the one or more veneer analysis systems.

In one embodiment, the dimensions data is used to generate veneer selection and stacking robot control signals that direct robotic arms of the one or more veneer selection and stacking robots to place the individual full veneer sheet, veneer strip, and partial veneer sheet on the appropriate veneer stack such that the resulting veneer stacks have relatively uniform edges, top surfaces, and are virtually free of jagged edges and/or bulges of low and/or high areas.

In various embodiments, the dimensions data and grading data for each individual full veneer sheet, veneer strip, and partial veneer sheet is generated by the disclosed NIR analysis system 300 of FIGS. 3A, 3B, 5, and/or NIR analysis system 600 of FIGS. 6 and 7 of one or more veneer analysis systems 1200.

In various embodiments, the one or more veneer analysis systems 1200 can, in addition to the disclosed NIR analysis system 300 of FIGS. 3A, 3B, 5, and/or NIR analysis system 600 of FIGS. 6 and 7, include all or part of the veneer analysis systems 1200 described in Bolton et al., U.S. patent application Ser. No. 16/205,027 (attorney docket number BCC-005), filed Nov. 29, 2018, now issued as U.S. Pat. No. 10,825,164 on Nov. 3, 2020, entitled “IMAGING SYSTEM FOR ANALYSIS OF WOOD PRODUCTS,” which claims the benefit of David Bolton, U.S. Provisional Patent Application No. 62/595,489, filed on Dec. 6, 2017, entitled “IMAGING SYSTEM FOR ANALYSIS OF WOOD PRODUCTS,” which is hereby incorporated by reference in its entirety as if it were fully set forth herein.

In various embodiments, the one or more veneer analysis systems 1200 can, in addition to the disclosed NIR analysis system 300 of FIGS. 3A, 3B, 5, and/or NIR analysis system 600 of FIGS. 6 and 7, include all or part of the veneer analysis systems 1200 described in Bolton et al., U.S. patent application Ser. No. 16/687,311 (attorney docket number BCC-003), filed Nov. 18, 2019, entitled “METHOD AND SYSTEM FOR DETECTING MOISTURE LEVELS IN WOOD PRODUCTS USING NEAR INFRARED IMAGING,” which claims the benefit of David Bolton, U.S. Provisional Patent Application No. 62/774,029, filed on Nov. 30, 2018, entitled “NEAR-INFRARED MOISTURE DETECTION IN WOOD PRODUCTS,” which is hereby incorporated by reference in its entirety as if it were fully set forth herein.

In various embodiments, the one or more veneer analysis systems 1200 can, in addition to the disclosed NIR analysis system 300 of FIGS. 3A, 3B, 5, and/or NIR analysis system 600 of FIGS. 6 and 7, include all or part of the veneer analysis systems 1200 described in Bolton et al., U.S. patent application Ser. No. 16/687,1242 (attorney docket number BCC-006), filed on Nov. 18, 2019, entitled “METHOD AND SYSTEM FOR DETECTING MOISTURE LEVELS IN WOOD PRODUCTS USING NEAR INFRARED IMAGING AND MACHINE LEARNING,” which claims the benefit of David Bolton, U.S. Provisional Patent Application No. 62/774,029, filed on Nov. 30, 2018, entitled “NEAR-INFRARED MOISTURE DETECTION IN WOOD PRODUCTS,” which is hereby incorporated by reference in its entirety as if it were fully set forth herein.

In various embodiments, the one or more veneer analysis systems 1200 can, in addition to the disclosed NIR analysis system 300 of FIGS. 3A, 3B, 5, and/or NIR analysis system 600 of FIGS. 6 and 7, include all or part of the veneer analysis systems 1200 described in Bolton et al., U.S. patent application Ser. No. 16/687,369 (attorney docket number BCC-007), filed on Nov. 18, 2019, entitled “METHOD AND SYSTEM FOR MOISTURE GRADING WOOD PRODUCTS USING SUPERIMPOSED NEAR INFRARED AND VISUAL IMAGES,” which claims the benefit of David Bolton, U.S. Provisional Patent Application No. 62/774,029, filed on Nov. 30, 2018, entitled “NEAR-INFRARED MOISTURE DETECTION IN WOOD PRODUCTS,” which is hereby incorporated by reference in its entirety as if it were fully set forth herein.

In various embodiments, the one or more veneer analysis systems 1200 can, in addition to the disclosed NIR analysis system 300 of FIGS. 3A, 3B, 5, and/or NIR analysis system 600 of FIGS. 6 and 7, include all or part of the veneer analysis systems 1200 described in Bolton et al., U.S. patent application Ser. No. 16/697,458 (attorney docket number BCC-004), filed Nov. 27, 2019, now allowed, entitled “METHOD AND SYSTEM FOR ENSURING THE QUALITY OF A WOOD PRODUCT BASED ON SURFACE IRREGULARITIES USING NEAR INFRARED IMAGING,” which claims the benefit of David Bolton, U.S. Provisional Patent Application No. 62/773,992, filed on Nov. 30, 2018, entitled “NEAR-INFRARED SURFACE TEXTURE DETECTION IN WOOD PRODUCTS,” which is hereby incorporated by reference in its entirety as if it were fully set forth herein.

In various embodiments, the one or more veneer analysis systems 1200 can, in addition to the disclosed NIR analysis system 300 of FIGS. 3A, 3B, 5, and/or NIR analysis system 600 of FIGS. 6 and 7, include all or part of the veneer analysis systems 1200 described in Bolton et al., U.S. patent application Ser. No. 16/697,461 (attorney docket number BCC-008), filed on Nov. 27, 2019, now issued as U.S. Pat. No. 10,933,556 on Mar. 2, 2021, entitled “METHOD AND SYSTEM FOR ENSURING THE QUALITY OF A WOOD PRODUCT BASED ON SURFACE IRREGULARITIES USING NEAR INFRARED IMAGING AND MACHINE LEARNING,” which claims the benefit of David Bolton, U.S. Provisional Patent Application No. 62/773,992, filed on Nov. 30, 2018, entitled “NEAR-INFRARED SURFACE TEXTURE DETECTION IN WOOD PRODUCTS,” which is hereby incorporated by reference in its entirety as if it were fully set forth herein.

In various embodiments, the one or more veneer analysis systems 1200 can, in addition to the disclosed NIR analysis system 300 of FIGS. 3A, 3B, 5, and/or NIR analysis system 600 of FIGS. 6 and 7, include all or part of the veneer analysis systems 1200 described in Bolton et al., U.S. patent application Ser. No. 16/697,466 (attorney docket number BCC-009), filed on Nov. 27, 2019, now issued as U.S. Pat. No. 10,933,557 on Mar. 2, 2021, entitled “METHOD AND SYSTEM FOR ADJUSTING THE PRODUCTION PROCESS OF A WOOD PRODUCT BASED ON A LEVEL OF IRREGULARITY OF A SURFACE OF THE WOOD PRODUCT USING NEAR INFRARED IMAGING,” which claims the benefit of David Bolton, U.S. Provisional Patent Application No. 62/773,992, filed on Nov. 30, 2018, entitled “NEAR-INFRARED SURFACE TEXTURE DETECTION IN WOOD PRODUCTS,” which is hereby incorporated by reference in its entirety as if it were fully set forth herein.

In various embodiments, the one or more veneer analysis systems 1200 can, in addition to the disclosed NIR analysis system 300 of FIGS. 3A, 3B, 5, and/or NIR analysis system 600 of FIGS. 6 and 7, include all or part of the two or more or the veneer analysis systems 1200 described in the related applications set forth above which are hereby incorporated by reference in their entirety as if it were fully set forth herein.

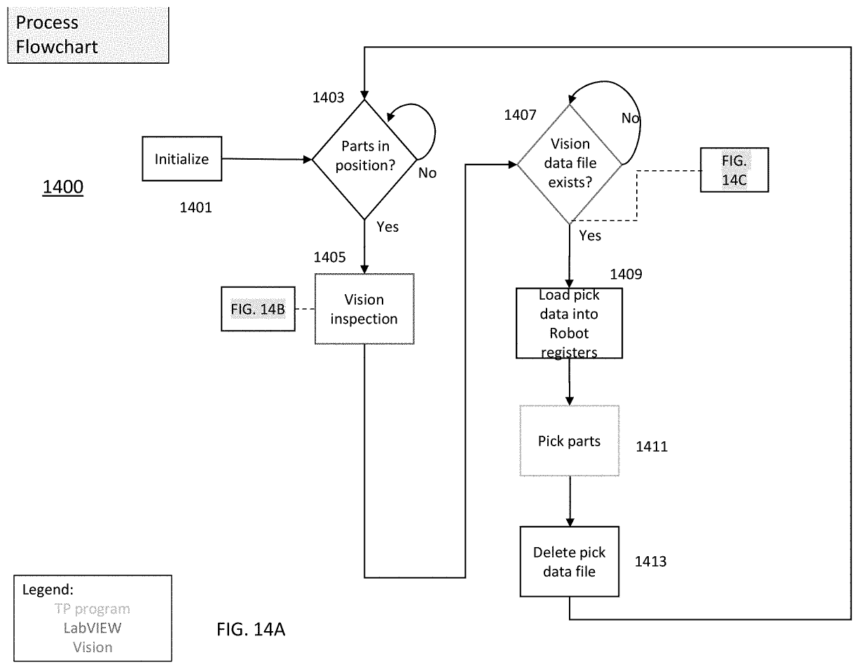

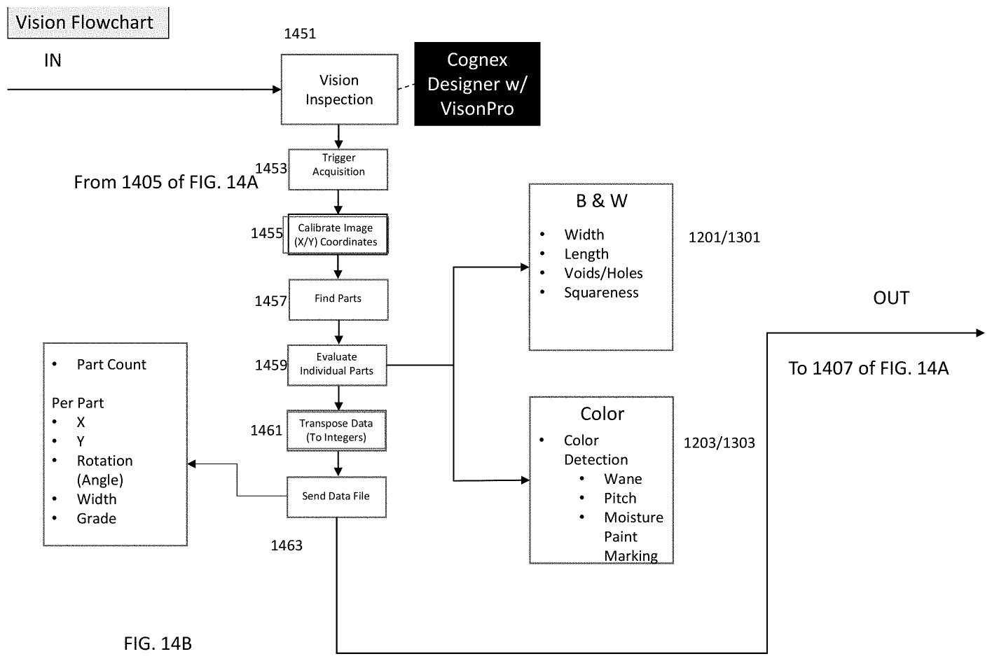

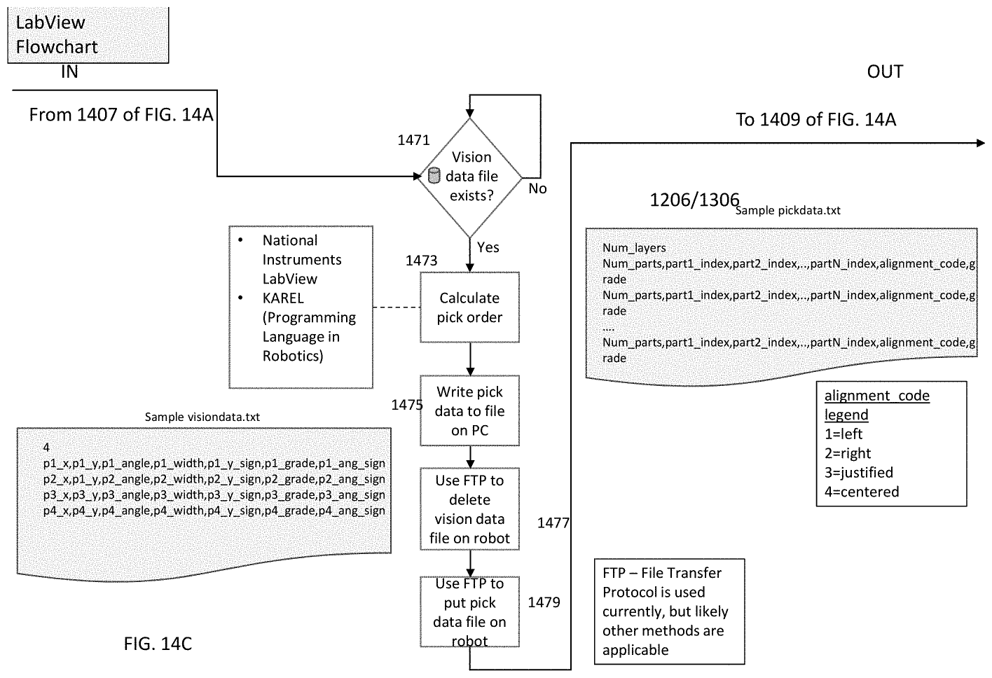

FIGS. 14A, 14B, and 14C together are a flow chart of a process 1400 for full veneer sheet, veneer strip, and partial veneer sheet grading and stacking in accordance with one embodiment. Referring to FIGS. 12,13, 14A, 14B, and 14C, process 1400 begins at initialize 1401 and proceeds to 1403. At 1403, a determination is made as to whether the parts, e.g., the full veneer sheets and/or veneer strips and/or partial veneer sheets 1232 or 1341, are in the correct position on the veneer analysis and selection conveyor 1245 or 1345. As noted above, in one embodiment, the veneer analysis station location(s) along conveyor 1235 or 1345 of FIGS. 12 and 13 are marked with origin markers and predetermined X and Y coordinate makers. Using this system, the locations, center of mass, orientation, and dimensions data for each full veneer sheet, veneer strip, and partial veneer sheet 1232 or 1341 can be determined with respect to these markers when the full veneer sheets and/or veneer strips and/or partial veneer sheets 1232 or 1341 are properly positioned on the veneer analysis and selection conveyor 1245 or 1345. If the full veneer sheets and/or veneer strips and/or partial veneer sheets 1232 or 1341 are not in the correct position process flow proceeds back to 1403 until the full veneer sheets and/or veneer strips and/or partial veneer sheets 1232 or 1341 are determined to be in the correct position. Process flow then proceeds to 1405.

At 1405, process flow proceeds to FIG. 14B and vision inspection is performed by the veneer analysis system 1200. Referring to FIG. 14B, at 1451 the vision inspection of the full veneer sheets and/or veneer strips and/or partial veneer sheets 1232 or 1341 is performed. At 1453 a trigger is provided to capture black and white and/or color and/or NIR images of the sheets of veneer 1232 or 1341. Then at 1455 calibration of the images is performed using defined origin and X and Y coordinates/markers at the veneer analysis system location of the veneer analysis and selection conveyor 1245 or 1345.

At 1457 individual parts, e.g., full veneer sheets and/or veneer strips and/or partial veneer sheets 1232 or 1341, are identified and at 1459 the individual parts, e.g., full veneer sheets and/or veneer strips and/or partial veneer sheets 1232 or 1341, are evaluated as described above, using black and white images to determine dimensions data 1201 or 1301. In addition, the disclosed NIR analysis system 300 of FIGS. 3A, 3B, 5, and/or NIR analysis system 600 of FIGS. 6 and 7, and color images are evaluated to generate grading data 1203 or 1303. At 1461, the dimensions data 1201 or 1301 and grading data 1203 or 1303 is transposed into integers.

At 1463, the integer-based dimensions data 1201 or 1301 and grading data 1203 or 1303 for each full veneer sheet, veneer strip, and partial veneer sheet is sent to a dimensions data and grading data file for each full veneer sheets and/or veneer strips and/or partial veneer sheets 1232 or 1341. The dimensions data and grading data file for each full veneer sheets and/or veneer strips and/or partial veneer sheets 1232 or 1341 is then sent to 1407 of FIG. 14A.

At 1407 of FIG. 14A, a determination is made as to whether the dimensions data and grading data file for each full veneer sheet, veneer strip, and partial veneer sheet 1232 or 1341 exists. If not, the process returns to 1405 and FIG. 14B to generate or find the dimensions data and grading data file for the full veneer sheet, veneer strip, and partial veneer sheet 1232 or 1341. If it is determined at 1407 that the dimensions data and grading data file for the full veneer sheet, veneer strip, and partial veneer sheet 1232 or 1341 exists, process flow proceeds to FIG. 14C and 1471.

At 1471, a determination is again made as to whether the dimensions data and grading data file for the full veneer sheet, veneer strip, and partial veneer sheet 1232 or 1341 exists.

If the dimensions data and grading data file for the full veneer sheet, veneer strip, and partial veneer sheet 1232 or 1341 does not exist, process flow proceeds back to 1407 and/or to 1405 and FIG. 14B to generate or find the dimensions data and grading data file for the full veneer sheet, veneer strip, and partial veneer sheet 1232 or 1341. If the dimensions data and grading data file for the full veneer sheet, veneer strip, and partial veneer sheet 1232 or 1341 exists, process flow proceeds to 1473. At 1473, the order in which the full veneer sheets and/or veneer strips and/or partial veneer sheets 1232 or 1341 are to be selected is determined based on the dimensions data 1201 or 1301 and grading data 1203 or 1303 for the full veneer sheet, veneer strip, and partial veneer sheet 1232 or 1341.

In the case of full veneer sheets 1232, the order in which the full veneer sheets 1232 are selected is determined primarily based on the grading data 1203 for the full veneer sheets 1232 and which veneer stack 1237 is to receive the full veneer sheets 1232.

However, in the case of veneer strips 1341, not only is the grading data 1303 for the veneer strips 1341 used, but also the dimensions data 1301 is of particular use. This is because, as discussed above, the dimensions data 1301 for each individual veneer strip 1341 is used to generate veneer selection and stacking robot control signals represented by veneer selection and stacking robot control signal data 1306 that direct veneer selection and stacking robots 1340A and 1340B to add one or more individual veneer strips 1341 in layers of veneer strips 1341 to appropriate specific veneer stacks 1343, e.g., veneer stack 1 through veneer stack 5, so that the layers of veneer strips 1341 have the desired length, e.g., length Lf and desired width, e.g., width Wf. As a result, the edges of the individual layers of veneer strips 1341 are of the desired dimensions and aligned. Consequently, the resulting veneer stacks 1343 are made up of layers of veneer strips 1341 that are of the desired dimensions, e.g., length Lf and width Wf, are aligned and have even edges/sides with no jagged edges. The result is that veneer stacks 1343 are not only made up of sheets of veneer 1232 accurately determined to be of the desired dimensions and correct grade, but that the layers of sheets of veneer 1232 are stacked such that veneer stacks 1343 resemble ideal veneer stack 273A of FIG. 2H rather than typical prior art veneer stack 273B of FIG. 2H.

To achieve this goal, veneer strips 1341 must be selected in sets of one or more veneer strips 1341 to create layers of veneer strips 1341 having the desired dimensions, e.g., length Lf and width Wf. In this process, the sometimes-multiple veneer strips 1341 making up the in layers are aligned and have even edges/sides and do not have jagged edges. In addition, the veneer strips 1341 must be selected so that any gaps between the veneer strips 1341 occurring in a given layer, are staggered to avoid creating bulges in the resulting veneer stacks 1343. Consequently, when veneer strips 1341 are being processed, the order in which the veneer strips and/or partial veneer sheets 1232 or 1341 are selected at 1473 is determined based on both dimensions data 1301 and grading data 1303 for the veneer strip 1341.

From 1473, process proceeds to 1475 where pick data indicating the order in which the full veneer sheets and/or veneer strips and/or partial veneer sheets 1232 or 1341 are to be selected is transferred to a file and sent to the robot control system 1205 or 1305. At 1477 robot control system 1205 or 1305 converts the pick data into veneer selection and stacking robot control signal data 1206 or 1306. Then any previous veneer selection and stacking robot control signal data 1206/1306 is deleted from the veneer selection and stacking robots 1240A and 1240B or 1340A and 1340B. At 1479 the current veneer selection and stacking robot control signal data 1206 or 1306 is then transferred to the veneer selection and stacking robots 1240A and 1240B or 1340A and 1340B. Process then returns to FIG. 14A and 1409.

At 1409, the veneer selection and stacking robot control signal data 1206 or 1306 is loaded into memory registers on veneer selection and stacking robots 1240A and 1240B or 1340A and 1340B. At 1411, in response to the veneer selection and stacking robot control signal data 1206 or 1306, veneer selection and stacking robots 1240A and 1240B or 1340A and 1340B use robotic arms to select the correct parts and move them onto the appropriate veneer stacks 1237 or 1343.

At 1413, the veneer selection and stacking robot control signal data 1206 or 1306 is then deleted and the process reverts to 1403 to await new data for the next pick.

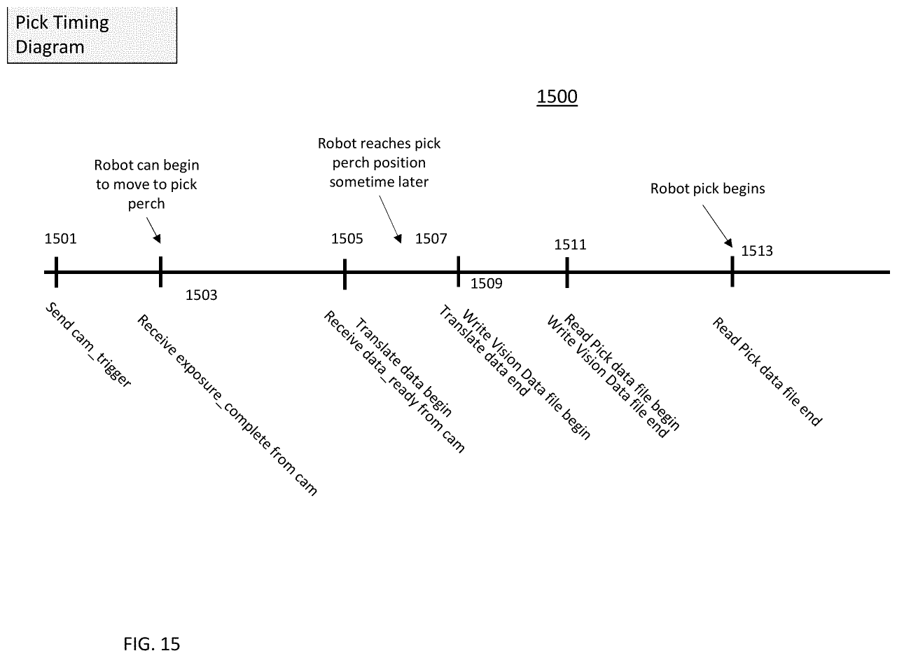

FIG. 15 is a timing diagram 1500 of a process for a full veneer sheet, veneer strip, and/or partial veneer sheet grading and stacking system in accordance with one embodiment. Referring to FIGS. 12, 13, and 15, at 1501 the cameras of the veneer analysis system 1200 are triggered along with the disclosed NIR analysis system 300 of FIGS. 3A, 3B, 5, and/or NIR analysis system 600 of FIGS. 6 and 7. At 1503 the image data from the cameras is received and the veneer selection and stacking robots 1240A and 1240B or 1340A and 1340B can begin move into their pre-position stance.

At 1505, the transmission of the image data is begun and at 1507 the veneer selection and stacking robots 1240A and 1240B or 1340A and 1340B robotic arms reach their pre-positions, also referred to herein as “perch positions.”

At 1509, the image data is processed, the dimensions data 1201/1301 and grading data 1203/1303 is generated, and at 1511 veneer selection and stacking robot control signal data 1206/1306 is generated.

At 1513, the veneer selection and stacking robot control signal data 1206/1306 is received by the veneer selection and stacking robots 1240A and 1240B or 1340A and 1340B and the veneer selection and stacking robots 1240A and 1240B or 1340A and 1340B move to select the correct parts and move them onto the appropriate veneer stacks 1237 or 1343.

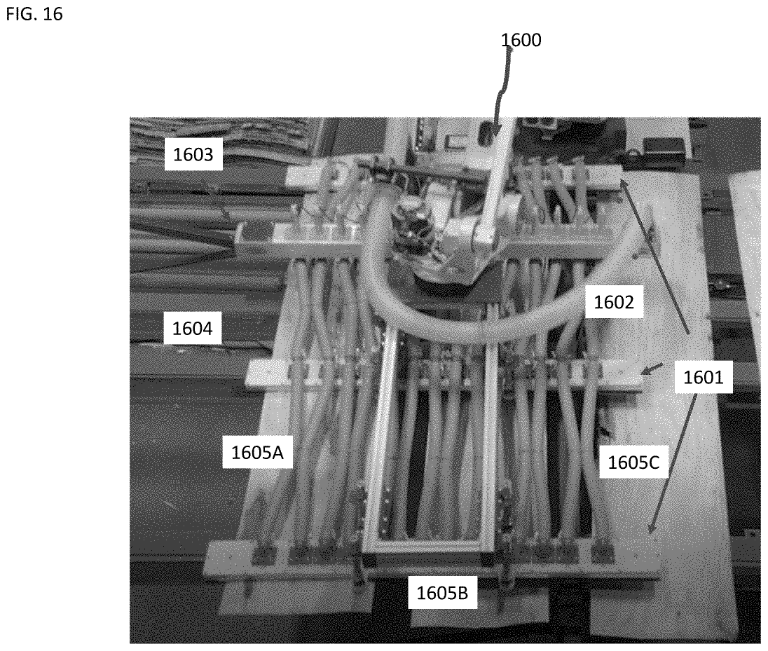

As noted above, in some embodiments, the veneer selection and stacking robots use robotic arms having selectively activated vacuum heads that are faster than humans and are far less likely to damage the relatively fragile full veneer sheets and/or veneer strips and/or partial veneer sheets. FIG. 16 is an illustration of a robotic arm 1600 with selectively activated vacuum head 1604 in accordance with one embodiment.

As seen in FIG. 16, selectively activated vacuum head 1604 includes main vacuum hose 1602, vacuum hose sets 1605A, 1605B, and 1605C, vacuum port bars 1601, and vacuum actuator bar 1603.

Referring to FIGS. 12, 13, and 16, in operation, main vacuum hose 1602 provides suction to vacuum actuator bar 1603. Then, in response to the veneer selection and stacking robot control signal data 1206 or 1306, vacuum actuator bar 1603 selectively provides suction to vacuum ports (not shown) on the underside of vacuum port bars 1601 via vacuum hose sets 1605A, 1605B, and 1605C. In this way, selectively activated vacuum head 1604 can pick up selected full veneer sheets and/or veneer strips and/or partial veneer sheets 1232 or 1341 using vacuum suction and move selected full veneer sheets and/or veneer strips and/or partial veneer sheets 1232 or 1341 to the appropriate veneer stack 1237 or 1343. Since only vacuum suction is used to select and move full veneer sheets and/or veneer strips and/or partial veneer sheets 1232 or 1341, there is minimal chance of damage to full veneer sheets and/or veneer strips and/or partial veneer sheets 1232 or 1341.

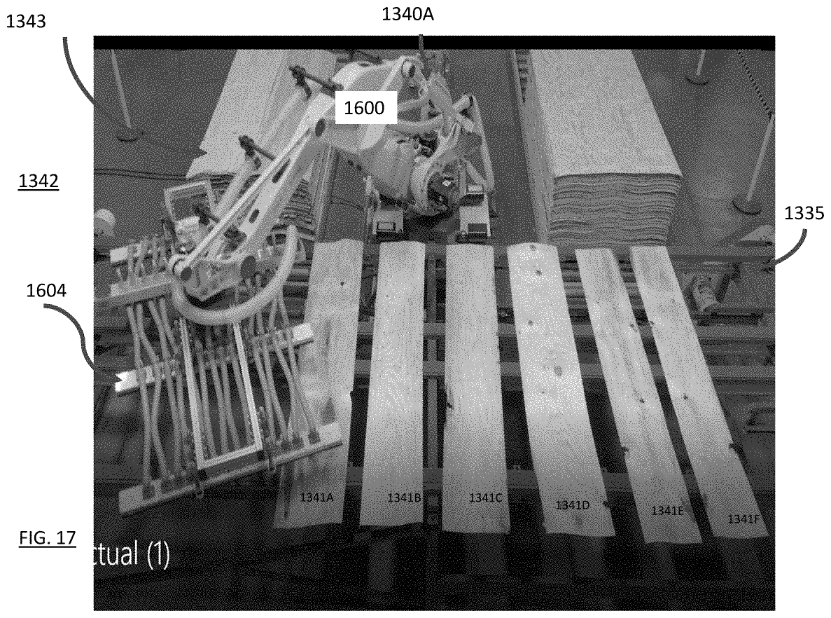

FIG. 17 is local robotic veneer strip stacking cell 1342 in accordance with one embodiment. Referring to FIGS. 12, 13, and 17, as seen in FIG. 17, in this specific embodiment, local robotic veneer strip stacking cell 1342 includes: veneer selection and stacking robot 1340A, robotic arm 1600 including selectively activated vacuum head 1604; veneer analysis and selection conveyor 1335; veneer stack 1343, and veneer strips and/or partial veneer sheets 1341A, 1341B, 1341C, 1341D, 1341E, and 1341F.

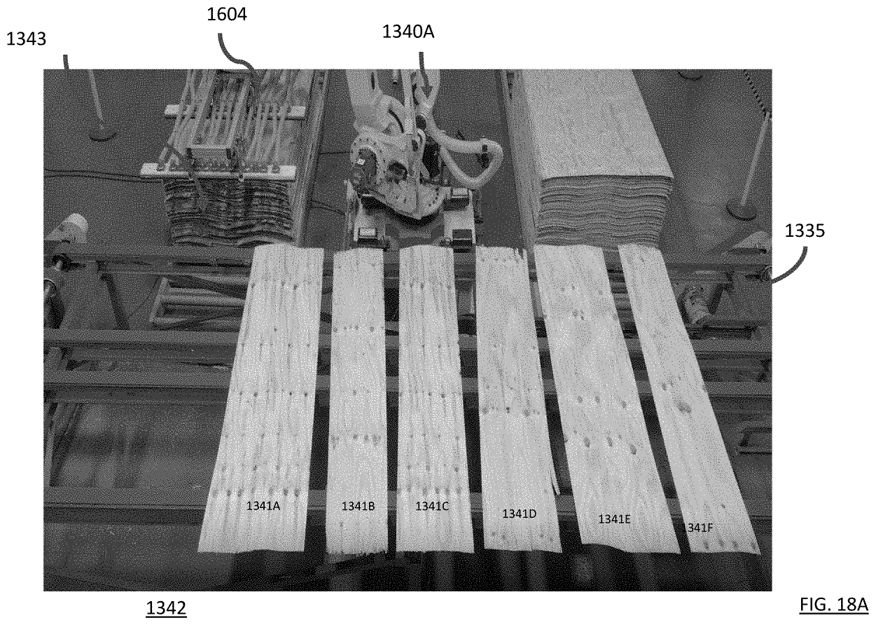

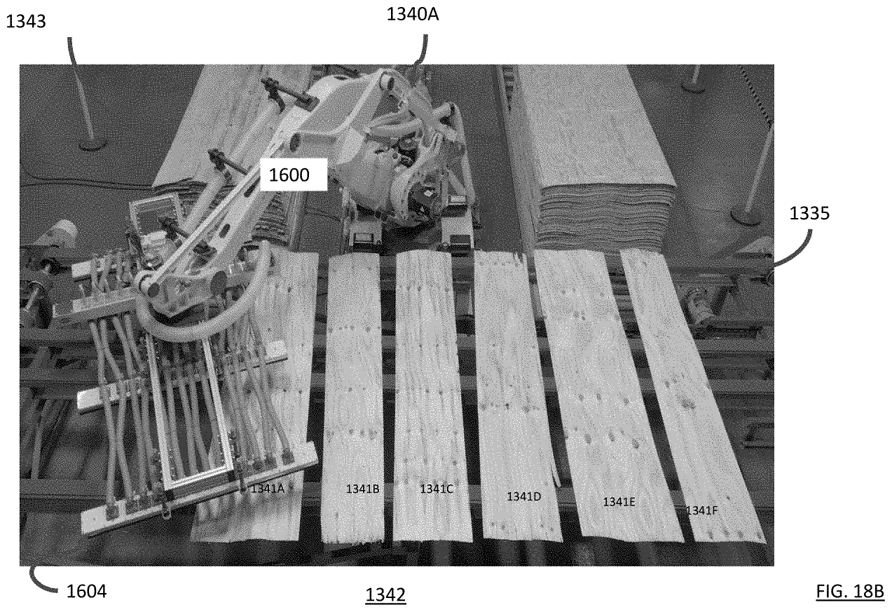

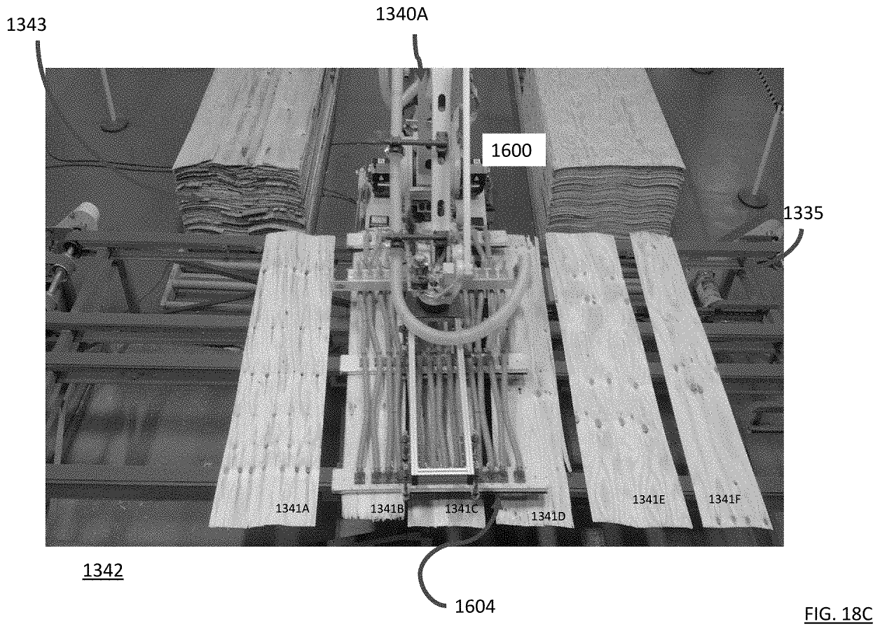

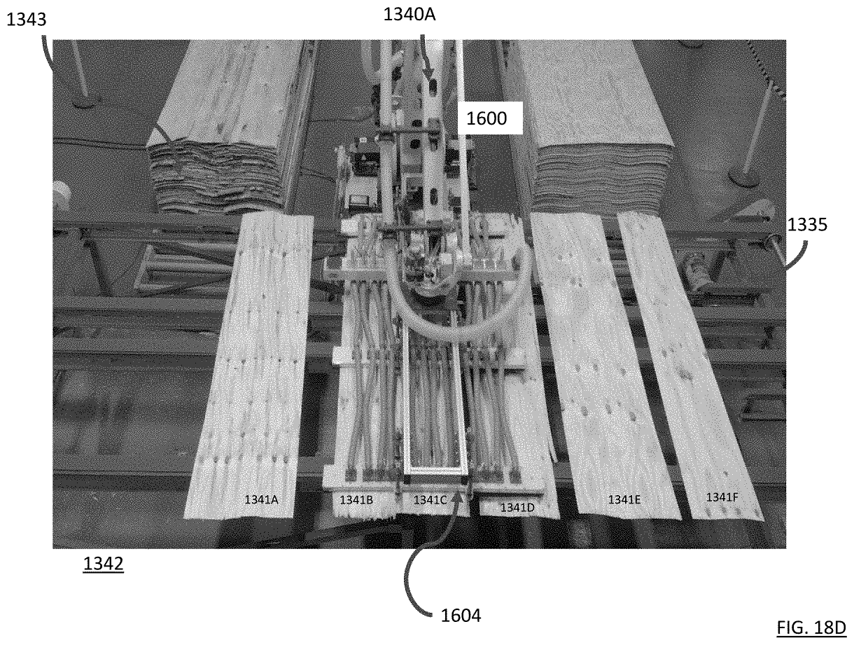

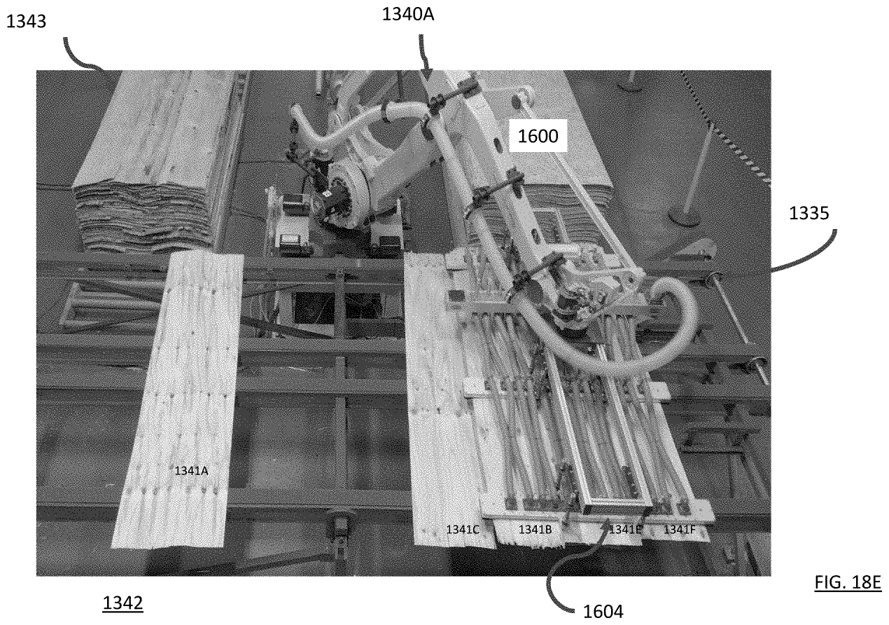

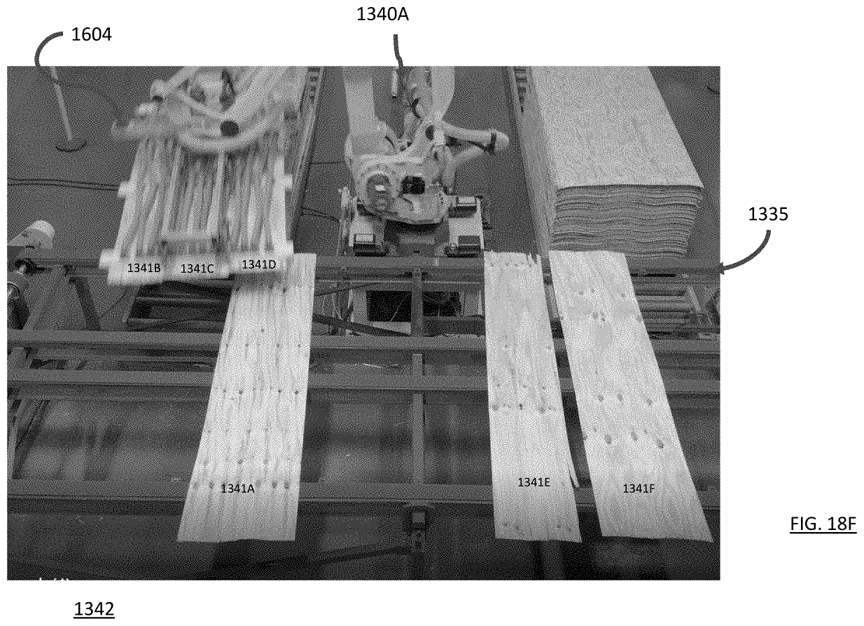

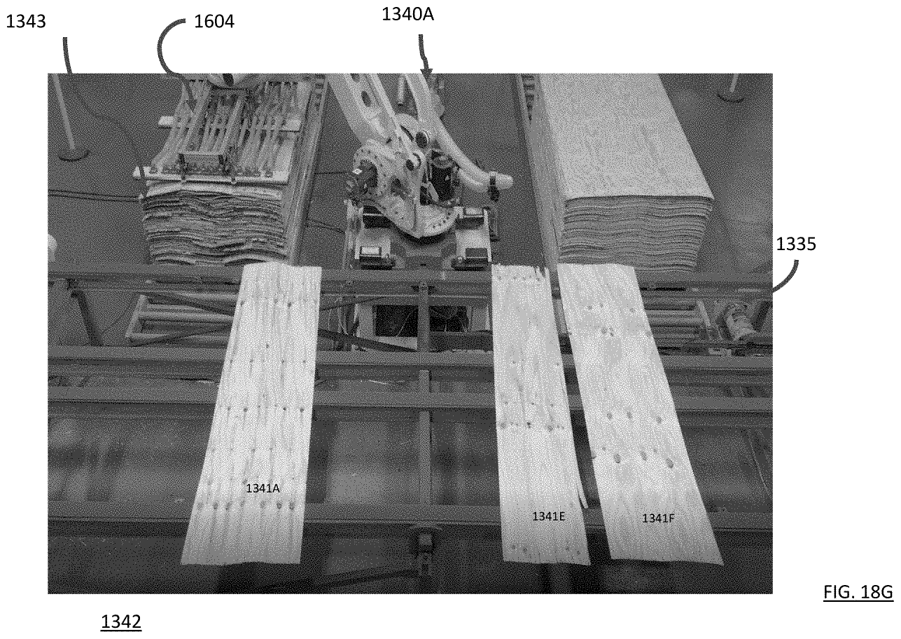

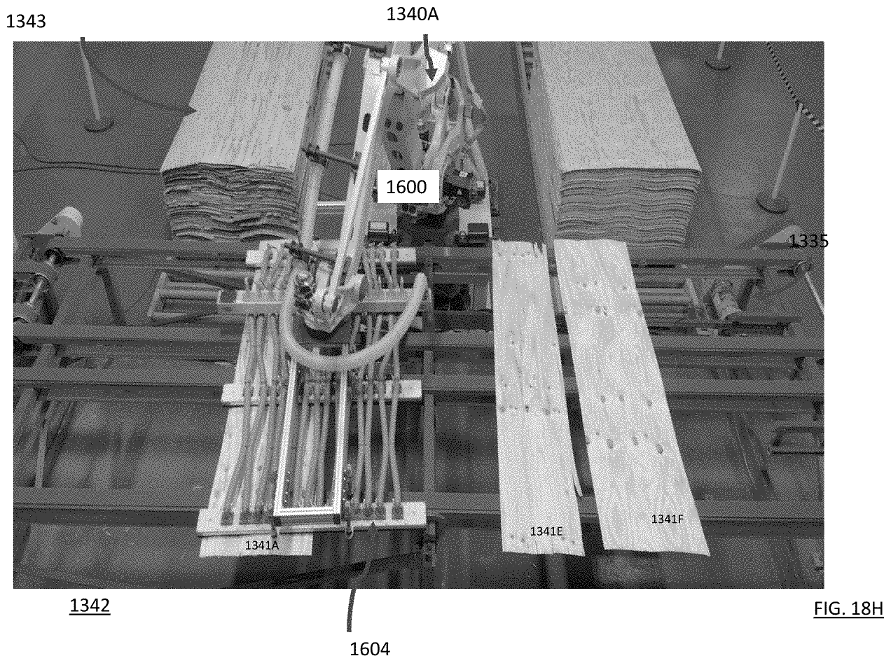

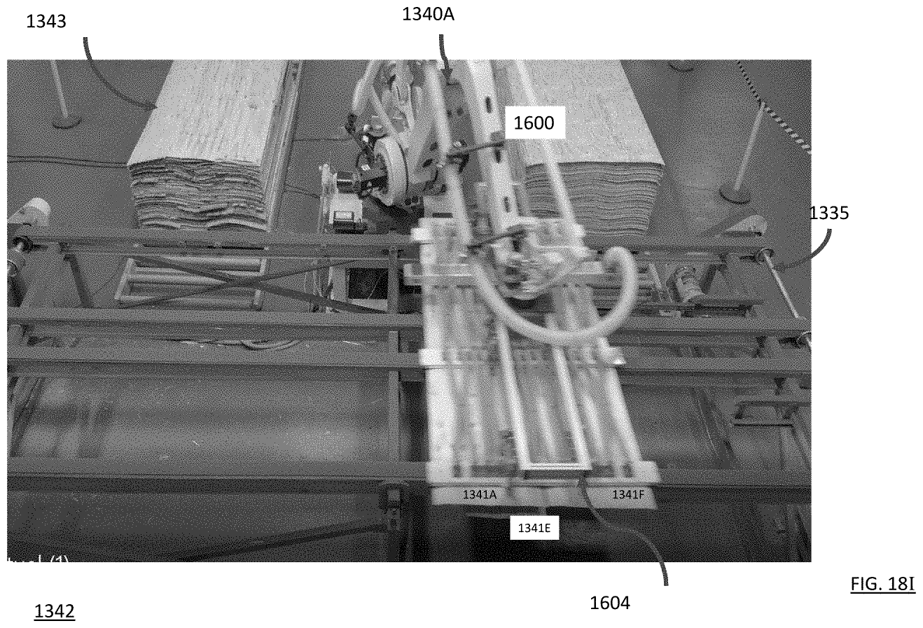

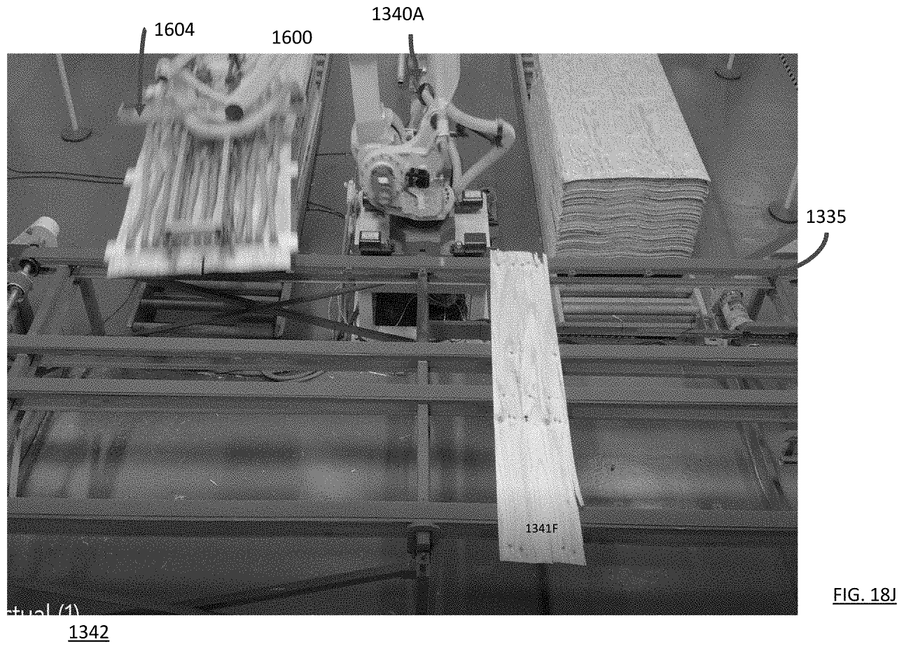

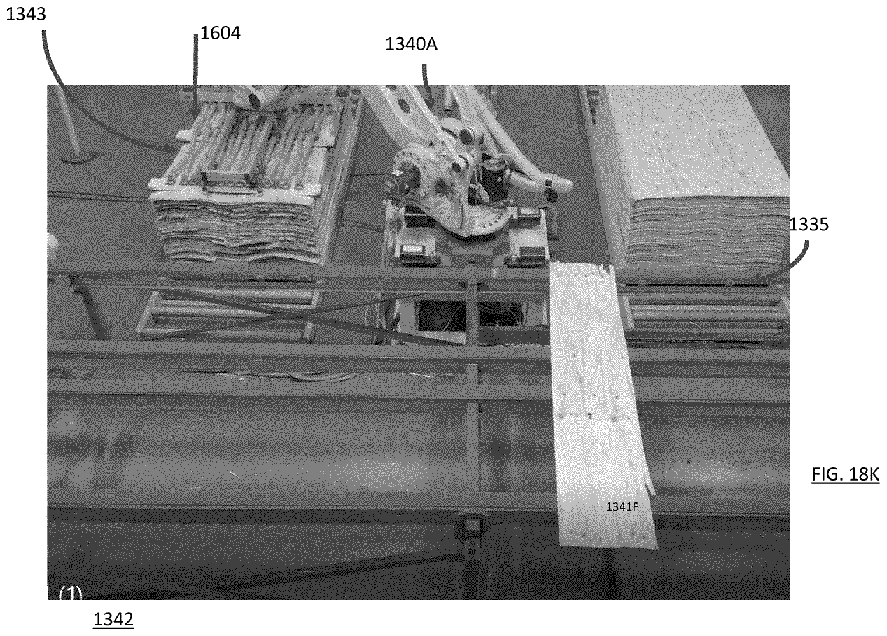

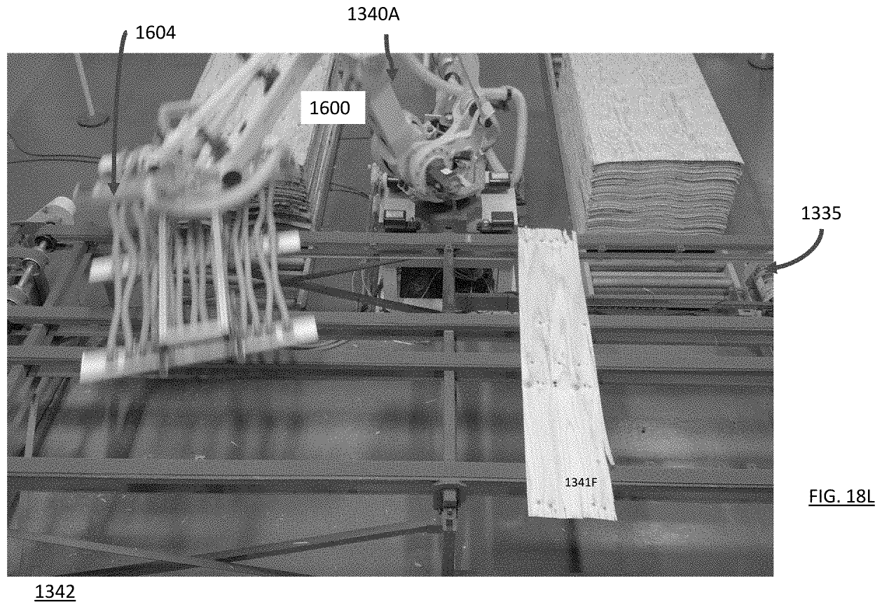

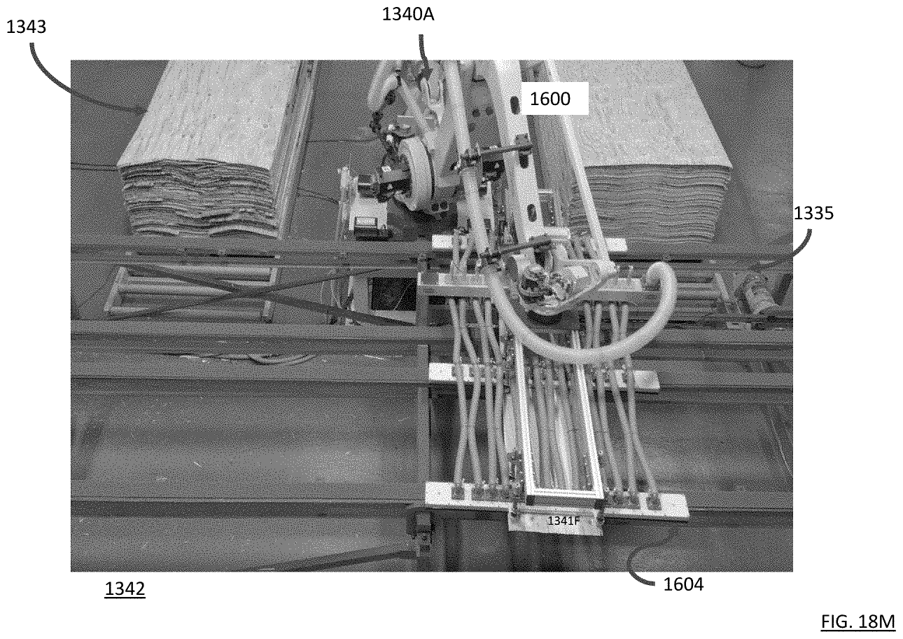

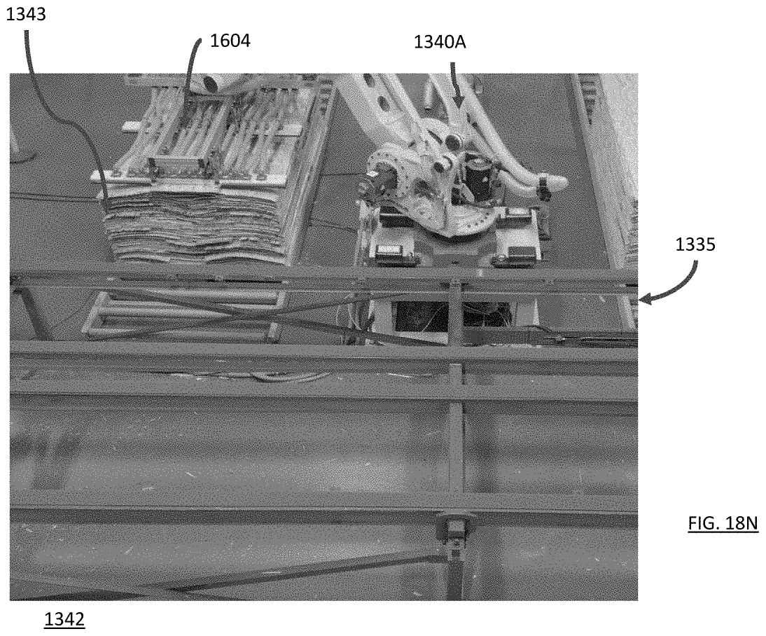

FIGS. 18A through 18N show the use of the local robotic veneer strip stacking cell 1342 of FIG. 17 to create a layer of veneer strips in veneer stack 1343 in accordance with one embodiment

Referring to FIGS. 13 and 18A through 18N, as discussed above, in the case of veneer strips 1341, not only is the grading data 1303 for the veneer strips 1341 used, but also the dimensions data 1301. This is because, as discussed above, the dimensions data 1301 for each individual veneer strip 1341 is used to generate veneer selection and stacking robot control signals represented by veneer selection and stacking robot control signal data 1306 that direct veneer selection and stacking robots 1340A and 1340B to add individual veneer strips 1341 in layers of veneer strips 1341 to the appropriate specific veneer stack 1343, e.g., veneer stack 1 through veneer stack 5, so that the edges of the individual layers of veneer strips 1341 are aligned. Consequently, the resulting veneer stacks 1343 are made up of layers of veneer strips 1341 that have the desired dimensions, e.g., length Lf and width Wf, are aligned and have even edges/sides and do not have jagged edges. The result is that veneer stacks 1343 are not only made up of sheets of veneer 1232 accurately determined to be of the desired dimensions and correct grade, but that the layers of sheets of veneer 1232 are stacked such that veneer stacks 1343 resemble ideal veneer stack 273A of FIG. 2H rather than typical prior art veneer stack 273B of FIG. 2H.

To achieve this goal, veneer strips 1341 must be selected in sets or layers so that the sometimes-multiple veneer strips 1341 selected in layers have the desired dimensions, e.g., length Lf and width Wf, are aligned and have even edges/sides, and that do not have jagged edges. In addition, the veneer strips 1341 must be selected so that any gaps between the veneer strips 1341, and therefore in the layers of veneer strips 1341, are staggered to avoid creating bulges in the resulting veneer stacks 1343. Consequently, when veneer strips 1341 are being processed, the order in which the veneer strips 1341 are selected is determined based on the dimensions data 1301 and grading data 1303 for the veneer strips 1341.

Referring to FIGS. 12, 13, and 18A through 18N, as seen in FIG. 18A, veneer strips 1341A, 1341B, 1341C, 1341D, 1341E, and 1341F are brought into position beside veneer selection and stacking robot 1340A by veneer analysis and selection conveyor 1335. As seen in FIG. 18B, in response to veneer selection and stacking robot control signal data 1306, robotic arm 1600 of veneer selection and stacking robot 1340A then begins to position selectively activated vacuum head 1604 over veneer strips 1341A, 1341B, 1341C, 1341D, 1341E, and 1341F.

As seen in FIG. 18C, in response to veneer selection and stacking robot control signal data 1306, veneer selection and stacking robot 1340A positions robotic arm 1600 and selectively activated vacuum head 1604 over veneer strips 1341B, 1341C, and 1341D and as seen in FIGS. 18D and 18E, in response to veneer selection and stacking robot control signal data 1306, selectively activated vacuum head 1604 of veneer selection and stacking robot 1340A selects veneer strips 1341B, 1341C and 1341D as a layer of veneer strips.

As seen in FIGS. 18F and 18G, in response to veneer selection and stacking robot control signal data 1306, robotic arm 1600 and selectively activated vacuum head 1604 of veneer selection and stacking robot 1340A adds veneer strips 1341B, 1341C and 1341D as a layer of veneer strips to veneer stack 1343.

As seen in FIG. 18H, in response to veneer selection and stacking robot control signal data 1306, robotic arm 1600 of veneer selection and stacking robot 1340A then returns selectively activated vacuum head 1604 to a position over veneer strip 1341A and selects veneer strip 1341A. Then, as seen in FIG. 18I, in response to veneer selection and stacking robot control signal data 1306, robotic arm 1600 and selectively activated vacuum head 1604 of veneer selection and stacking robot 1340A also selects veneer strip 1341E. Then, as seen in FIGS. 18J and 18K, in response to veneer selection and stacking robot control signal data 1306, robotic arm 1600 and selectively activated vacuum head 1604 of veneer selection and stacking robot 1340A adds veneer strips 1341A and 1341E as a layer of veneer strips to veneer stack 1343.

As seen in FIGS. 18K and 18L, after creating two layers of veneer strips in veneer stack 1343, only veneer strip 1341F remains on veneer analysis and selection conveyor 1335. As seen in FIG. 18L in response to veneer selection and stacking robot control signal data 1306, robotic arm 1600 of veneer selection and stacking robot 1340A then returns selectively activated vacuum head 1604 to a position over veneer strip 1341F. As seen in FIG. 18M, in response to veneer selection and stacking robot control signal data 1306, robotic arm 1600 and selectively activated vacuum head 1604 of veneer selection and stacking robot 1340A selects veneer strip 1341F and, as seen in FIG. 18N, in response to veneer selection and stacking robot control signal data 1306, robotic arm 1600 and selectively activated vacuum head 1604 of veneer selection and stacking robot 1340A adds veneer strip 1341F to veneer stack 1343 as a third layer of veneer strips.

Of note is the fact that, in one embodiment, in response to veneer selection and stacking robot control signal data 1306, robotic arm 1600 and selectively activated vacuum head 1604 of veneer selection and stacking robot 1340A adds layers of veneer strips veneer stack 1343, such as veneer strips 1341A and 1341E of FIGS. 18J and 18K, such that any gaps between individual veneer strips 1341 in the layers of individual veneer strips 1341 are staggered so that no bulges of low and high points are created. Likewise, in response to veneer selection and stacking robot control signal data 1306, robotic arm 1600 and selectively activated vacuum head 1604 of veneer selection and stacking robot 1340A adds layers of single veneer strips, such as veneer strip 1341F of FIGS. 18M and 18N, to veneer stack 1343 such that single veneer strip layers rotate from a left of center position of veneer stack 1343 to the center position of veneer stack 1343 to a right of center position of veneer stack 1343 and then back to a left of center position of veneer stack 1343 and so on cycling through the three positions of veneer stack 1343. In this way the formation of bulges in veneer stack 1343 are also avoided.

The innovations disclosed herein are described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

For the sake of presentation, the detailed description uses terms like “determine” and “use” to describe computer operations in a computing system. These terms are high-level abstractions for operations performed by a computer and should not be confused with acts performed by a human being. The actual computer operations corresponding to these terms vary depending on implementation.

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms may be high-level descriptions of the actual operations that are performed. The actual operations that correspond to these terms may vary depending on the particular implementation.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically, or chemically) coupled or linked and does not exclude the presence of intermediate elements between the coupled or associated items absent specific contrary language.

As used herein, operations that occur “simultaneously” or “concurrently” occur generally at the same time as one another, although delays in the occurrence of one operation relative to the other due to, for example, spacing, play or backlash between components in a mechanical linkage such as threads, gears, etc., are expressly within the scope of the above terms, absent specific contrary language.

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosed technology may be applied, it should be recognized that the illustrated embodiments are only preferred examples of the disclosed technology and should not be taken as limiting the scope of the disclosed technology. Rather, the scope of the disclosure is at least as broad as the following claims. We therefore claim all that comes within the scope of these claims.

Therefore, numerous variations, whether explicitly provided for by the specification or implied by the specification or not, may be implemented by one of skill in the art in view of this disclosure.

What is claimed is:

1. A veneer strip grading and stacking system comprising:
a veneer analysis and selection conveyor for conveying veneer strips;
a surface irregularity level to greyscale mapping database, the surface irregularity level to greyscale mapping database containing mapping data that maps surface irregularities to Near InfraRed (NIR) image greyscale values for veneer;
a veneer analysis system, the veneer analysis system including an NIR analysis system, the NIR analysis system including one or more sources of illumination positioned to illuminate a veneer surface, the NIR analysis system including one or more NIR cameras positioned to capture one or more NIR images of the illuminated veneer surface;
a veneer strip to be analyzed by the NIR analysis system, the veneer strip to be analyzed being positioned by the veneer analysis and selection conveyor such that a surface of the veneer strip to be analyzed is illuminated by the one or more illumination sources;
a physical memory, the physical memory including NIR image data representing one or more NIR images of the illuminated veneer strip surface captured using the one or more NIR cameras;
one or more processors for processing the data representing one or more NIR images of the illuminated veneer strip surface to generate NIR greyscale image data indicating irregularities in the illuminated veneer strip surface;
one or more processors for processing the NIR greyscale image data using the surface irregularity level to greyscale mapping database data to identify irregularities for the veneer strip;
a grade assignment module for generating grading data representing a grade assigned to the veneer strip based on the identified irregularities for the veneer strip;
one or more veneer selection and stacking robot control systems to control the operation of one or more veneer selection and stacking robots, the one or more veneer selection and stacking robot control systems generating veneer selection and stacking robot control signals based, at least in part, on the grading data for the veneer strip;
one or more veneer selection and stacking robots, the one or more veneer selection and stacking robots moving the veneer strip from the veneer analysis and selection conveyor system to an appropriate veneer strip stack in response to the veneer selection and stacking robot control signals received from the one or more veneer selection and stacking robot control systems.

2. The veneer grading and stacking system of claim 1 wherein the one or more sources of illumination include one or more LED light sources.

3. The veneer grading and stacking system of claim 1 wherein one or more NIR cameras are adjustably positioned to capture one or more NIR images of the illuminated veneer strip surface.

4. The veneer grading and stacking system of claim 1 further comprising:
an NIR analysis system including one or more sources of illumination positioned to illuminate a veneer surface, the NIR analysis station including at least three NIR cameras positioned to capture one or more NIR images of the illuminated veneer surface, the at least three NIR cameras including:
a first NIR camera positioned to capture one or more NIR images of the illuminated veneer strip surface at a first angle with respect to a line parallel to the illuminated veneer strip surface;
a second NIR camera positioned to capture one or more NIR images of the illuminated veneer strip surface at a second angle with respect to a line parallel to the illuminated veneer strip surface, the second angle being different from the first angle; and
a third NIR camera positioned to capture one or more NIR images of the illuminated veneer strip surface at a third angle with respect to a line parallel to the illuminated veneer strip surface, the third angle being different from the first angle.

5. The veneer grading and stacking system of claim 4 wherein the first angle is approximately 45 degrees, the second angle is approximately 90 degrees, and the third angle is approximately 135 degrees.

6. The veneer grading and stacking system of claim 1 wherein at least one of the one or more veneer selection and stacking robots includes a selectively activated vacuum head for moving individual veneer strips from the veneer analysis and selection conveyor system to an appropriate veneer stack in response to the veneer selection and stacking robot control signals received from the one or more veneer selection and stacking robot control systems.

7. A method for veneer grading and stacking comprising:
providing a veneer analysis and selection conveyor for conveying veneer strips;
generating a surface irregularity to greyscale mapping database, the surface irregularity to greyscale mapping database containing data that maps surface irregularities to Near InfraRed (NIR) image greyscale values for one or more veneer strips;
providing an NIR analysis station, the NIR analysis station including one or more sources of illumination positioned to illuminate a surface of a veneer strip, the NIR analysis station including one or more NIR cameras positioned to capture one or more NIR images of the illuminated veneer strip surface;
positioning a veneer strip to be analyzed in the NIR analysis station such that a veneer strip surface to be analyzed is illuminated by the one or more illumination sources;
capturing, using the one or more NIR cameras, one or more NIR images of the illuminated veneer strip surface;
processing the one or more NIR images of the illuminated veneer strip surface to generate NIR greyscale images indicating one or more surface irregularities in the illuminated veneer strip surface;
processing the NIR greyscale images using the surface irregularity to greyscale mapping database to identify a level of irregularity of the veneer strip;
assigning a grade to the veneer strip based on the identified level of irregularity of the veneer strip surface;
providing one or more veneer selection and stacking robot control systems to control the operation of one or more veneer selection and stacking robots, the one or more veneer selection and stacking robot control systems generating veneer selection and stacking robot control signals based, at least in part, on the grading assigned to the veneer strip; and
providing one or more veneer selection and stacking robots, the one or more veneer selection and stacking robots moving individual veneer strip from the veneer analysis and selection conveyor system to an appropriate veneer strip stack in response to the veneer selection and stacking robot control signals received from the one or more veneer selection and stacking robot control systems.

8. The method for veneer grading and stacking of claim 7 wherein the one or more sources of illumination include one or more LED light sources.

9. The method for veneer grading and stacking of claim 7 wherein one or more NIR cameras are adjustably positioned to capture one or more NIR images of the illuminated veneer strip surface.

10. The method for veneer grading and stacking of claim 7 further comprising:
providing an NIR analysis system including one or more sources of illumination positioned to illuminate a veneer surface, the NIR analysis station including at least three NIR cameras positioned to capture one or more NIR images of the illuminated veneer surface, the at least three NIR cameras including:
a first NIR camera positioned to capture one or more NIR images of the illuminated veneer strip surface at a first angle with respect to a line parallel to the illuminated veneer strip surface;
a second NIR camera positioned to capture one or more NIR images of the illuminated veneer strip surface at a second angle with respect to a line parallel to the illuminated veneer strip surface, the second angle being different from the first angle; and
a third NIR camera positioned to capture one or more NIR images of the illuminated veneer strip surface at a third angle with respect to a line parallel to the illuminated veneer strip surface, the third angle being different from the first angle.

11. The method for veneer grading and stacking of claim 9 wherein the first angle is approximately 45 degrees, the second angle is approximately 90 degrees, and the third angle is approximately 135 degrees.

12. A method for veneer grading and stacking, the method comprising:
passing one or more veneer strips from a dryer outfeed conveyor to a veneer analysis and selection conveyor;
providing the individual veneer strips to one or more veneer analysis systems at one or more veneer analysis system locations along the veneer analysis and selection conveyor, the one or more veneer analysis systems generating images of the individual veneer strips and processing the images of the individual veneer strips to generate dimensions data for each individual veneer strip, the one or more veneer analysis systems including one or more NIR analysis systems, the one or more NIR analysis systems analyzing the surface of each individual veneer strip and generating grading data representing a grade assigned to the veneer strips based on the identified irregularities for the veneer strips;
providing the dimensions data and grading data for each individual veneer strip to one or more veneer selection and stacking robot control systems associated with one or more local robotic veneer stacking cells, the one or more veneer selection and stacking robot control systems generating veneer selection and stacking robot control signals based on analysis of the dimensions data and grading data for each individual veneer strip;
providing the generated veneer selection and stacking robot control signals to one or more veneer selection and stacking robots included in the one or more local robotic veneer stacking cells;
using the received veneer selection and stacking robot control signals to direct the one or more veneer selection and stacking robots to move individual veneer strips from the veneer analysis and selection conveyor system to an appropriate veneer stack based on the grade data assigned to the individual veneer strip by the one or more veneer analysis systems; and
using the dimensions data generated for each individual veneer strip to generate veneer selection and stacking robot control signals that direct the one or more veneer selection and stacking robots to place the individual veneer strip on the appropriate veneer stack such that the resulting veneer stacks have relatively uniform dimensions and edges.

13. The method of claim 12 wherein the veneer analysis system for veneer inspection and grading includes one or more veneer analysis system components selected from the set of veneer analysis systems including:
a vision system including one or more cameras for capturing a black and white image of a veneer strip;
a vision system including one or more cameras for capturing a color image of a veneer strip;
a vision system including two or more cameras for capturing a black and white image and color image of a veneer strip;
an imaging system for analysis of veneer strips;
a system for detecting moisture levels in veneer strips using near infrared imaging;
a system for detecting moisture levels in veneer strips using near infrared imaging and machine learning;
a system for moisture grading veneer strips using superimposed near infrared and visual images;
a system for adjusting the production process of a veneer strip based on a level of irregularity of a surface of the veneer strip using near infrared imaging.

14. The method for veneer grading and stacking of claim 12 further comprising:
providing an NIR analysis system including one or more sources of illumination positioned to illuminate a veneer surface, the NIR analysis station including at least three NIR cameras positioned to capture one or more NIR images of the illuminated veneer surface, the at least three NIR cameras including;
a first NIR camera positioned to capture one or more NIR images of the illuminated veneer strip surface at a first angle with respect to a line parallel to the illuminated veneer strip surface;
a second NIR camera positioned to capture one or more NIR images of the illuminated veneer strip surface at a second angle with respect to a line parallel to the illuminated veneer strip surface, the second angle being different from the first angle; and
a third NIR camera positioned to capture one or more NIR images of the illuminated veneer strip surface at a third angle with respect to a line parallel to the illuminated veneer strip surface, the third angle being different from the first angle.

15. The method for veneer grading and stacking of claim 12 wherein the first angle is approximately 45 degrees, the second angle is approximately 90 degrees, and the third angle is approximately 135 degrees.

16. The method of claim 12 wherein at least one of the one or more veneer selection and stacking robots includes a selectively activated vacuum head for moving individual veneer strips from the veneer analysis and selection conveyor system to an appropriate veneer stack in response to the veneer selection and stacking robot control signals received from the one or more veneer selection and stacking robot control systems.

17. The method of claim 12 wherein the veneer analysis system includes a camera for capturing a black and white image of a veneer surface.

18. The method of claim 17 wherein the veneer analysis system is configured to determine a scaling factor between the veneer strip and the black and white image based at least in part on known dimensions of a reference image.

19. The method of claim 18 wherein the veneer analysis system is configured to auto-rotate the black and white image and the color image such that the black and white image and the color image have the same orientation as a reference image.

20. The method of claim 19 wherein the veneer analysis system is configured to translate the black and white image such that the black and white image is oriented to match the orientation of the reference image.
